(19) United States
(12) Patent Application Publication
(10) Pub. No.: US 2011/0093829 A1
(43) Pub. Date: Apr. 21, 2011

(54) COMPUTER PRODUCT, DESIGN SUPPORT APPARATUS, AND DESIGN SUPPORT METHOD

(75) Inventors: Takahiko Orita, Kawasaki (JP); Kazunori Kumagai, Kawasaki (JP); Yoshitaka Nishio, Kawasaki (JP); Ikuo Ohtsuka, Kawasaki (JP); Motoyuki Tanisho, Kawasaki (JP)

(73) Assignee: FUJITSU LIMITED, Kawasaki-shi (JP)

(21) Appl. No.: 12/904,409

(22) Filed: Oct. 14, 2010

(30) Foreign Application Priority Data
Oct. 19, 2009 (JP) 2009-240904

(51) Int. Cl. G06F 17/50

(52) U.S. Cl. 716/129

(57) ABSTRACT

A non-transitory, computer-readable recording medium stores therein a design support program that causes a computer to execute selecting a wiring path whose line length is greatest among a plurality of wiring paths making up a wiring group leading from a transmission origin to a transmission destination; detecting insufficient line lengths of the wiring paths not selected, insufficiency being determined with respect to the line length of the selected wiring path; calculating the area of insufficiency according to a sum of the detected insufficient line lengths; allocating to a vicinity of the wiring group, a line length adjustment region corresponding to a sum of the areas of insufficiency calculated at calculating; and controlling a display screen to display the wiring group and the allocated line length adjustment region.

### CROSS REFERENCE TO RELATED APPLICATIONS

This application is based upon and claims the benefit of priority of the prior Japanese Patent Application No. 2009-240904, filed on Oct. 19, 2009, the entire contents of which are incorporated herein by reference.

### FIELD

The embodiments discussed herein are related to wiring design support with respect to a printed substrate and a large-scale integrated circuit (LSI).

### BACKGROUND

In recent years, as LSIs operate at a lower voltage and a higher signal transmission rate, specifying a design constraint condition in wiring design on a printed substrate has become widespread. In the design constraint condition, a line length corresponding to signal delay in a wiring path (transmission delay) is specified for the wiring path to match the timing of signals in a wiring pattern interconnecting components. For a wiring group of multiple wiring paths, such as a bus, an instruction is given to match signal delays so that input timing into a receiver in each wiring path becomes equal.

Generally in wiring design, the line length of an existing line is adjusted to satisfy a condition on signal delay after confirming that components can be connected across a wiring section without error. When no wiring region remains for which line length adjustment is possible, a wiring pattern of a wiring group must be shifted or a wiring route must be reconsidered from the start, which leads to a prolonged wiring design period. A design tool has been provided for designing wiring to comply with a line length constraint condition. This design tool displays a noncompliant line length on a window different from a window where a wiring pattern is displayed (e.g., see Japanese Laid-Open Patent Publication No. H11-110434).

The conventional design tool, however, poses a problem in that the correlation between a wiring pattern and a noncompliant line length is difficult to adjust, and in that an actual wiring pattern length corresponding to a noncompliant line length is difficult to image, leading to difficulty in determining whether a wiring region necessary in the adjustment of line length is sufficient.

### SUMMARY

According to an aspect of an embodiment, a non-transitory, computer-readable recording medium storing therein a design support program that causes a computer to execute selecting a wiring path whose line length is greatest among a plurality of wiring paths making up a wiring group leading from a transmission origin to a transmission destination; detecting insufficient line lengths of the wiring paths not selected, insufficiency being determined with respect to the line length of the selected wiring path; calculating the area of insufficiency according to a sum of the detected insufficient line lengths; allocating to a vicinity of the wiring group, a line length adjustment region corresponding to a sum of the areas of insufficiency calculated at calculating; and controlling a display screen to display the wiring group and the allocated line length adjustment region.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an explanatory diagram of a state before display of a line length adjustment region in a first display example.

FIG. 2 is an explanatory diagram of a state after display of the line length adjustment region in the first display example.

FIG. 3 is an explanatory diagram of a state before/after display of the line length adjustment region in a second display example.

FIG. 4 is an explanatory diagram of a state before/after display of the line length adjustment region in a third display example.

FIG. 5 is an explanatory diagram of a state before display of the line length adjustment region in a fourth display example.

FIG. 6 is an explanatory diagram of a state after display of the line length adjustment region in the fourth display example.

FIG. 7 is an explanatory diagram of a state before display of the line length adjustment region in a fifth display example.

FIG. 8 is an explanatory diagram of a state after display of the line length adjustment region in the fifth display example.

FIG. 9 is an explanatory diagram of a state after display of the line length adjustment region in a sixth display example.

FIG. 10 is an explanatory diagram of a state after display of the line length adjustment region in a seventh display example.

FIG. 11 is an explanatory diagram of a state after display of the line length adjustment region in an eighth display example.

FIG. 12 is a block diagram of a hardware configuration of a design support apparatus according to the embodiments.

FIG. 13 is an explanatory diagram of an example of the contents of a design reference table.

FIG. 14 is an explanatory diagram of an example of the contents of a substrate table.

FIG. 15 is an explanatory diagram of an example of the contents of a net table.

FIG. 16 is an explanatory diagram of an example of the contents of a land shape table.

FIG. 17 is an explanatory diagram of an example of the contents of a component pin table.

FIG. 18 is an explanatory diagram of an example of the contents of a via-hole table.

FIG. 19 is an explanatory diagram of an example of the contents of a line table.

FIG. 20 is an explanatory diagram of an example of the contents of a line length constraint condition table.

FIG. 21 is an explanatory diagram of an example of the contents of a wiring path table.

FIG. 22 is an explanatory diagram of an example of the contents of a wiring route table.

FIG. 23 is an explanatory diagram of an example of the contents of a line length adjustment table.

FIG. 24 is an explanatory diagram of an example of the contents of a schematic region table.

FIG. 25 is an explanatory diagram of an example of the contents of a line length region table.

FIG. 26 is an explanatory diagram of an example of the contents of a specified region table.

FIG. 27 is an explanatory diagram of an example of the contents of a temporary wiring table.

FIG. 28 is an explanatory diagram of an example of the contents of a lattice structure.

FIG. 29 is an explanatory diagram of an example of the contents of a lattice management table structure.

FIG. 30 is a block diagram of a functional configuration of the design support apparatus.

FIGS. 31 to 33 are flowcharts of a design support procedure by the design support apparatus.

FIG. 34 is an explanatory diagram of an example of a lattice management table.

FIGS. 35 and 36 are flowcharts detailing a procedure of a lattice management table generating process.

FIG. 37 is an explanatory diagram of an example of the lattice management table that results after completion of obstacle mapping.

FIGS. 38 to 40 are flowcharts detailing a procedure of an obstacle mapping process.

FIG. 41 is an explanatory diagram of a specific example of a pattern occupation rate calculating process.

FIGS. 42 to 44 are flowcharts detailing a procedure of a pattern occupation rate calculating process.

FIG. 45 is an explanatory diagram of a specific example of a wiring route schematic wiring process.

FIG. 46 is a flowchart detailing a procedure of a wiring route schematic wiring process (step S3108).

FIG. 47 is an explanatory diagram of a specific example of a wiring group mapping process.

FIG. 48 is a flowchart detailing a procedure of the wiring group mapping process.

FIGS. 49 and 50 are flowcharts detailing a procedure of an unconnected section schematic wiring process (step S3209).

FIG. 51 is an explanatory diagram of the unconnected section schematic wiring process (step S3209).

FIG. 52 is a flowchart detailing a procedure of a lattice region conversion process.

FIG. 53 is an explanatory diagram of a specific example of the lattice region conversion process.

FIGS. 54 to 56 are flowcharts detailing a procedure of a line length adjustment region schematic determining process (step S3304).

FIG. 57 is an explanatory diagram of a resulting diagrammatic shape intersection of a diagrammatic shape Ra and a user specified region Rz.

FIG. 58 is an explanatory diagram of determination of a substantial position of a line length adjustment region based on a proportional relation of insufficient line lengths.

FIG. 59 is a graph of a correlation.

FIG. 60 is an explanatory diagram of the insufficient line lengths on buses B1 and B2 of FIG. 58 and correlation coefficients.

FIG. 61 is an explanatory diagram of a coordinate array Co[ ] acquired at step S5505.

FIG. 62 is an explanatory diagram of an example of a division at steps S5506 to S5509.

FIG. 63 is an explanatory diagram of a lattice management table Ga that results after schematic region allocation.

FIG. 64 is a flowchart detailing a procedure of a line length adjustment conversion process (steps S5602 and S5606).

FIGS. 65 to 70 are flowcharts detailing a procedure of a schematic region allocating process (steps S5603 and S5606).

FIG. 71 is an explanatory diagram of a first specific example of the schematic region allocating process.

FIG. 72 is an explanatory diagram of a second specific example of the schematic region allocating process.

FIG. 73 is an explanatory diagram of a third specific example of the schematic region allocating process.

FIG. 74 is an explanatory diagram of a lattice management.

FIG. 75 is an explanatory diagram of an example of a result of a lattice region conversion process (step S7014).

FIG. 76 is an explanatory diagram of a specific example of a lattice array detouring region acquiring process.

FIGS. 77 and 78 are flowcharts detailing a procedure of the lattice array detouring region acquiring process.

FIG. 79 is an explanatory diagram of a specific example of a lattice array area calculating process.

FIG. 80 is a flowchart detailing a procedure of the lattice array area calculating process.

FIGS. 81 to 84 are flowcharts detailing a procedure of a line length adjustment region detail determining process (step S3305).

FIG. 85 is an explanatory diagram of a first specific example of the line length adjustment region detail determining process (step S3305).

FIG. 86 is an explanatory diagram of a second specific example of the line length adjustment region detail determining process (step S3305).

FIG. 87 is an explanatory diagram of a third specific example of the line length adjustment region detail determining process (step S3305).

FIG. 88 is an explanatory diagram of a first specific example of a detail region allocating process.

FIGS. 89 and 90 are flowcharts detailing a procedure of the detail region allocating process (step S8207/S8407).

FIG. 91 is an explanatory diagram of a second specific example of the detail region allocating process.

FIG. 92 is a flowchart detailing a procedure of a line length adjustment region mapping process (step S3306) of FIG. 33.

FIG. 93 is a flowchart detailing a procedure of a line length adjustment region substitution layer allocating process (step S3311) of FIG. 33.

FIG. 94 is a flowchart detailing a procedure of a line length adjustment region displaying process (step S3313) of FIG. 33.

### DESCRIPTION OF EMBODIMENTS

Preferred embodiments of the present invention will be described in detail with reference to the accompanying drawings. According to this embodiment, in processing design data, a wiring path not complying with a line length constraint condition is detected automatically, and based on a noncompliant line length, a wiring region necessary in the adjustment of the line length of the wiring path is displayed near a wiring group to which the wiring path belongs. As a result, the presence/absence of a noncompliant wiring group and a wiring region necessary in the adjustment of line length (line length adjustment region) are displayed all together to a designer.

At a stage before wiring path connection, therefore, the designer is allowed to make use of a line length adjustment region, which is used by each wiring group, for determining a wiring route while visually recognizing the line length adjustment region, based on wiring connection relations. Additionally, in the wiring path connection work, the designer is allowed to carry out path connection while leaving a line length adjustment region for an already connected wiring group unused. In this manner, the designer is able to carry out wiring work while considering line length adjustment to be made later and thus, is able to efficiently carry out wiring design without any setback.

In the present specification, “wiring path” means information indicating the connection relation of a wiring subject using component pins, via-holes specifying relay points in wiring, etc. “Wiring pattern” means layout data indicative of a line serving as a conductor that electrically connects components along a wiring path.

A line length under a constraint condition is obtained by extracting a physically connected wiring pattern while checking the wiring pattern against the connection relation of wiring paths and converting each extracted wiring pattern into the line length of a wiring path by a conversion method specified by the line length constraint condition. “Noncompliant line length” represents a line length that is shorter than a reference value range under the line length constraint condition (negative value), and further represents a line length that is longer than the reference value range (positive value). To adjust the timing of a signal in a line between components, signal delay is converted numerically into a line length and is defined as a constraint on line length in the constraint condition so that signal delays are matched by matching line lengths. If signal delay is not converted into a line length but is defined as a constraint on delay in the constraint condition, the resulting difference is merely a difference in units for internal calculation. Directly processing signal delay is, therefore, possible.

In this embodiment, the presence/absence of noncompliance wiring paths and the lengths of noncompliant line lengths are displayed together to the designer in eight types of display examples. Thirteen display examples of this embodiment will be described sequentially hereinafter.

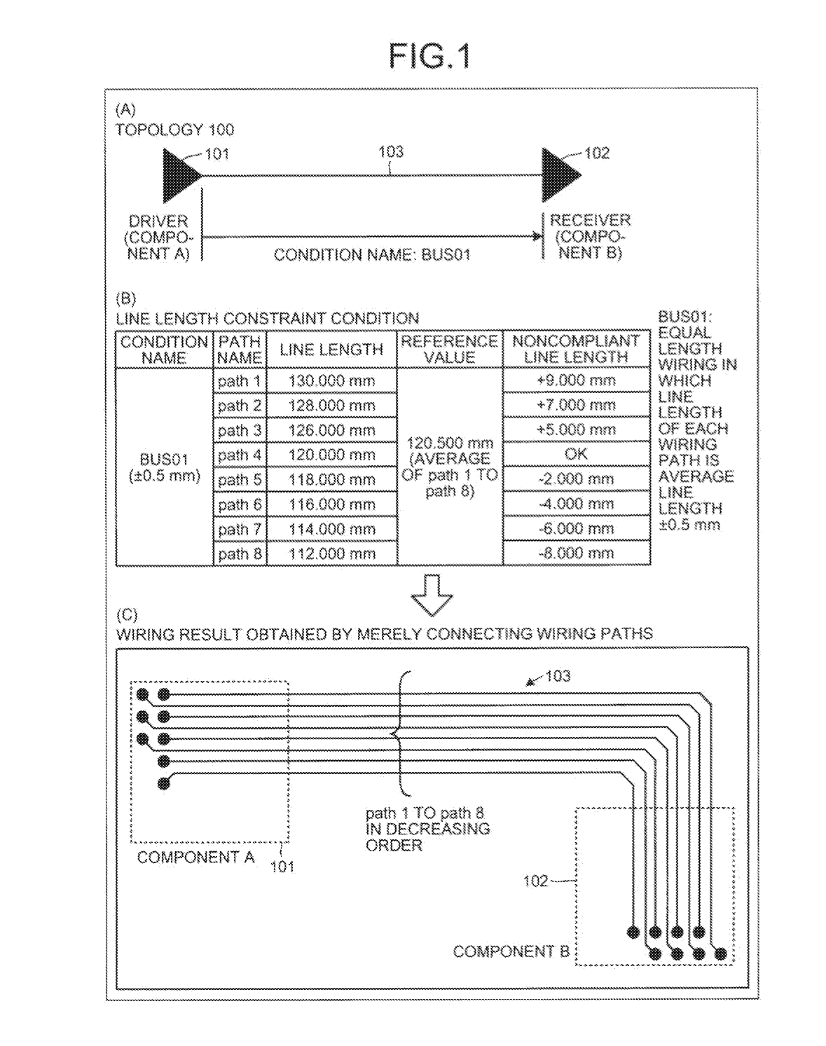

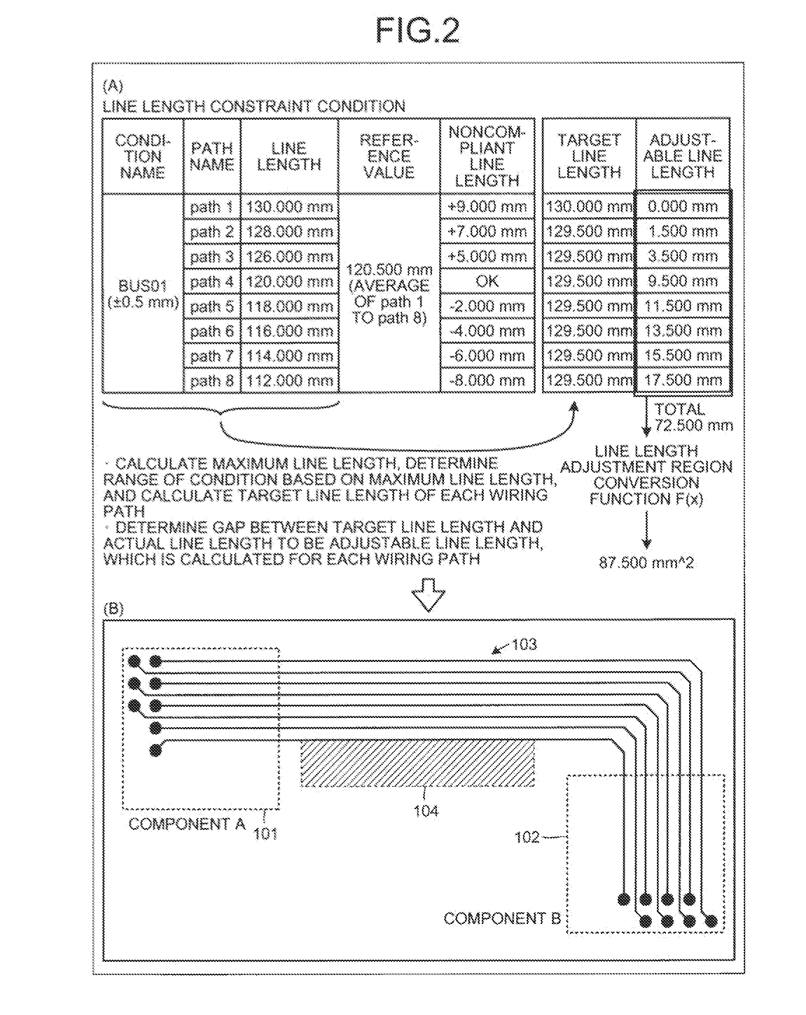

A first display example is an example of displaying a line length adjustment region for wiring paths in the vicinity of a wiring group composed of the wiring paths. The line length adjustment region is an empty area for adjusting the line lengths of the wiring paths. For example, when a given wiring path is of a line length that is too short (noncompliant line length as a negative value), the insufficient portion of the line is extended to the line length adjustment region. The first display example will hereinafter be described with reference to FIGS. 1 and 2.

FIG. 1 is an explanatory diagram of a state before display of the line length adjustment region in the first display example. In the first display example, (A) in FIG. 1 depicts an example of topology 100 to be designed; and (B) depicts a line length constraint condition in the topology; and (C) depicts a layout that results when the topology of (A) is wired in compliance with the line length constraint condition of (B). Connecting wiring paths making up a bus 103 form a wiring pattern.

In the topology 100 of (A), a driver 101 is connected to a receiver 102 via the bus 103 specified by the line length constraint condition BUS01.

The line length constraint condition of (B) provides a condition name, a path name, a line length, a reference value, and a noncompliant line length. The condition name is the name of the line length constraint condition, which is BUS01 in FIG. 1. The line length constraint condition BUS01 provides a line length condition of “±0.5 mm”, which means that the line length of each wiring path is of equal length wiring within ±0.5 mm of a reference value (average line length). “Equal length” means that a line length within a range of compliance of the line length condition satisfies the line length constraint condition.

In the line length constraint condition, the path name is the name of a wiring path specified under the line length constraint condition. In FIG. 1, the names of 8 wiring paths (path 1 to path 8) making up the bus 103 are depicted. A group of wiring paths making up the bus 103 is referred to as a wiring group.

The reference value is information of a reference for the wiring paths (path 1 to path 8) specified under the line length constraint condition. For example, the line length of a specific wiring path selected from the wiring paths specified under the line length constraint condition or the average line length of the wiring paths specified under the line length constraint condition is used as the reference value. In FIG. 1, the average line length is used as the reference value.

The noncompliant value or noncompliant line length represents a line length that is shorter than the reference value range under the line length constraint condition, and further represents a line length that is longer than the reference value range. For an arbitrary wiring path, specifically, when the line length is larger than the reference value, the noncompliant line length is a positive value obtained by subtracting the upper limit line length of the range, i.e., the equal length, from the line length of the wiring path. When the line length is smaller than the reference value, the noncompliant line length is a negative value obtained by subtracting the lower limit line length of the range, i.e., the equal length, from the line length of the wiring path. When the line length of the wiring path is the equal length (length between the upper limit line length and the lower limit line length), the line length is in compliance with the line length constraint condition.

For example, the line length of the path 1 is 130.000 [mm] and the reference value is 120.500 [mm]. Subtracting the upper limit line length 121.000 [mm] (=120.500 [mm]+0.5 [mm]) from the line length 130.000 [mm] of the path 1 gives +9.000 [mm] (>0). Hence, the line length of the path 1 is in excess of 9.00 [mm].

The line length of the path 4 is 120.000 [mm] and the reference value is 120.500 [mm]. Subtracting the lower limit line length 120.000 [mm] (=120.500 [mm]−0.5 [mm]) from the line length 120.000 [mm] of the path 4 gives 0 [mm]. Hence, the line length of the path 4 is in compliance with the line length constraint condition.

The line length of the path 8 is 112.000 [mm] and the reference value is 120.500 [mm]. Subtracting the lower limit line length 120.000 [mm] (=120.500 [mm]−0.5 [mm]) from the line length 112.000 [mm] of the path 8 gives −8.000 [mm] (<0). Hence, the line length of the path 8 is insufficient by 8.000 [mm].

FIG. 2 is an explanatory diagram of a state after display of the line length adjustment region in the first display example. In the first display example, (A) in FIG. 2 depicts an instance of deriving an adjustment region from the line length constraint condition. For example, the wiring path whose line length is the greatest (path 1) among the wiring paths (path 1 to path 8) is determined to be a target line length for the path 1. A target line length for the remaining wiring paths (path 2 to path 8) is determined to be the lower limit line length 129.500 [mm] (130.000 [mm]−0.5 [mm]) of the line length of the longest wiring path (path 1).

For each wiring path, a difference between the target line length and the line length is calculated to determine the difference to be an adjustable line length for each wiring path. Adjustable line lengths are then summed up (72.500 [mm] in FIG. 2), and the sum of the adjustable line lengths is given to a line length adjustment region conversion function to obtain the area of the line length adjustment region (87.500 [mm²] in FIG. 2). (B) depicts a state where the line length adjustment region 104 having the area derived in (A) is drawn in the vicinity of the wiring group consisting of the wiring paths of the path 1 to path 8.

In this manner, by displaying the line length adjustment region necessary for the wiring group in the vicinity of the wiring group, the region necessary for increasing the line lengths of the wiring paths (path 1 to path 8) making up the wiring group into the equal length can be grasped.

A second display example will be described. The second display example is an example of displaying a line length adjustment region for which an obstacle is considered in the vicinity of a wiring group.

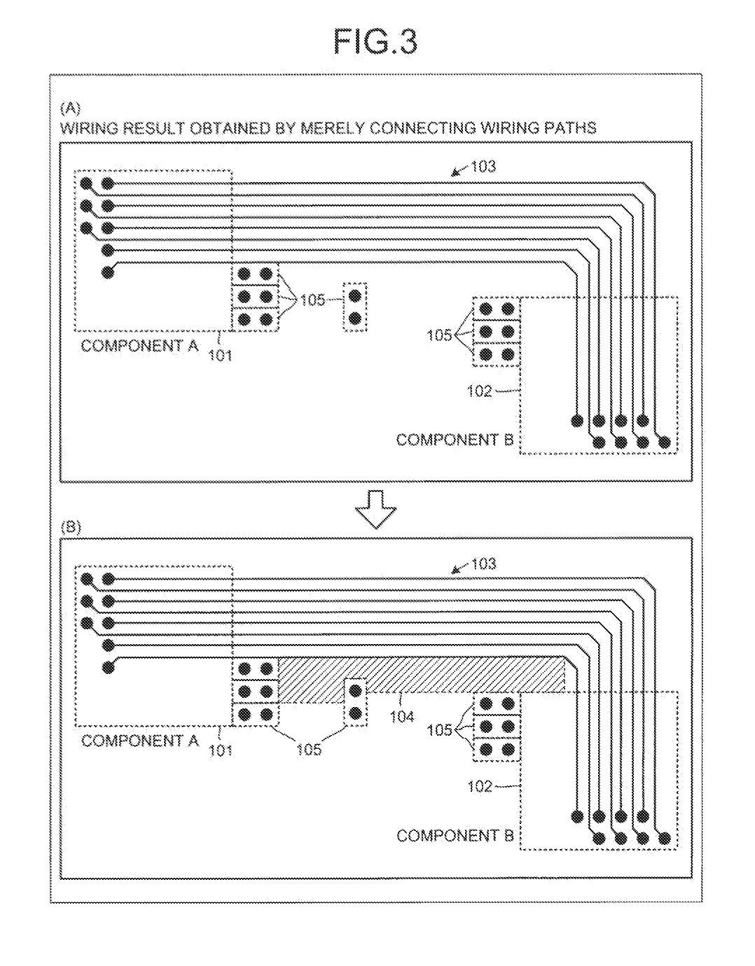

FIG. 3 is an explanatory diagram of a state before/after display of the line length adjustment region in the second display example. In FIG. 3, (A) is an explanatory diagram of a state before display of the line length adjustment region in the second display example. (A) depicts the driver 101, the receiver 102, and (a pattern of) the wiring paths making up the wiring group, and further depicts obstacles 105, such as via-holes. In (B), the line length adjustment region 104 having the area obtained in (A) is displayed in the vicinity of the wiring group where the line length adjustment region 104 does not overlap the obstacles 105.

In this manner, the line length adjustment region 104 is displayed in a location that avoids the obstacles 105. This allows presentation of a highly precise estimation to the designer, thus improves design efficiency.

A third display example will be described. The third display example is an example of displaying the line length adjustment region 104 in the vicinity of the wiring group in a specified region specified by the designer.

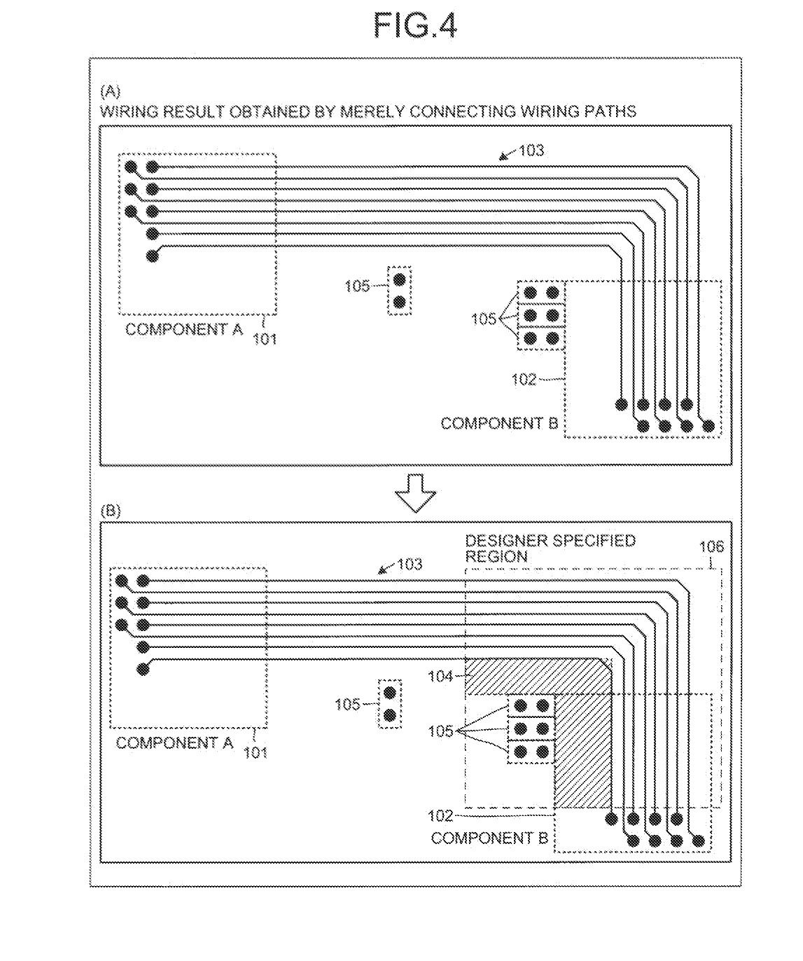

FIG. 4 is an explanatory diagram of a state before/after display of the line length adjustment region 104 in the third display example. In FIG. 4, (A) is an explanatory diagram of a state before display of the line length adjustment region 104 in the third display example. (A) depicts the driver 101, the receiver 102, and (a pattern of) the wiring paths making up the wiring group, and further depicts obstacles 105, such as via-holes. In (B), the line length adjustment region 104 having the area obtained in (A) is displayed in the vicinity of the wiring group where the line length adjustment region 104 does not overlap the obstacles 105 and is within the specified region 106.

In this manner, by displaying the line length adjustment region 104 in the specified region 106, the intention of the designer is reflected on an estimation of a design subject.

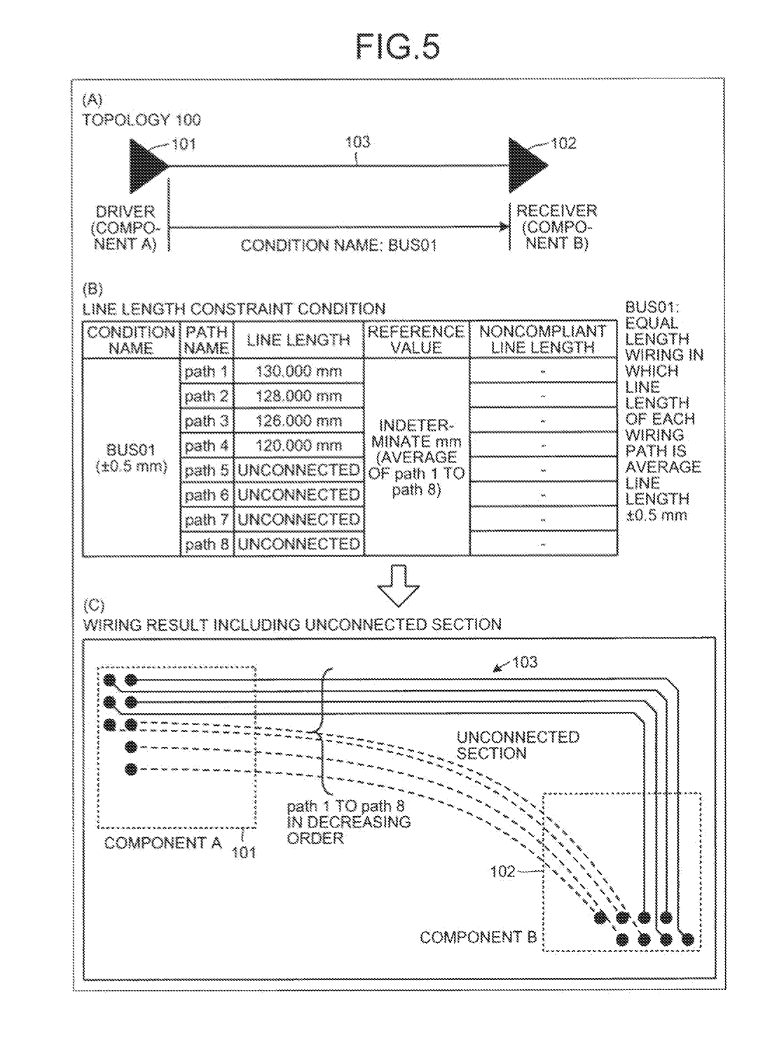

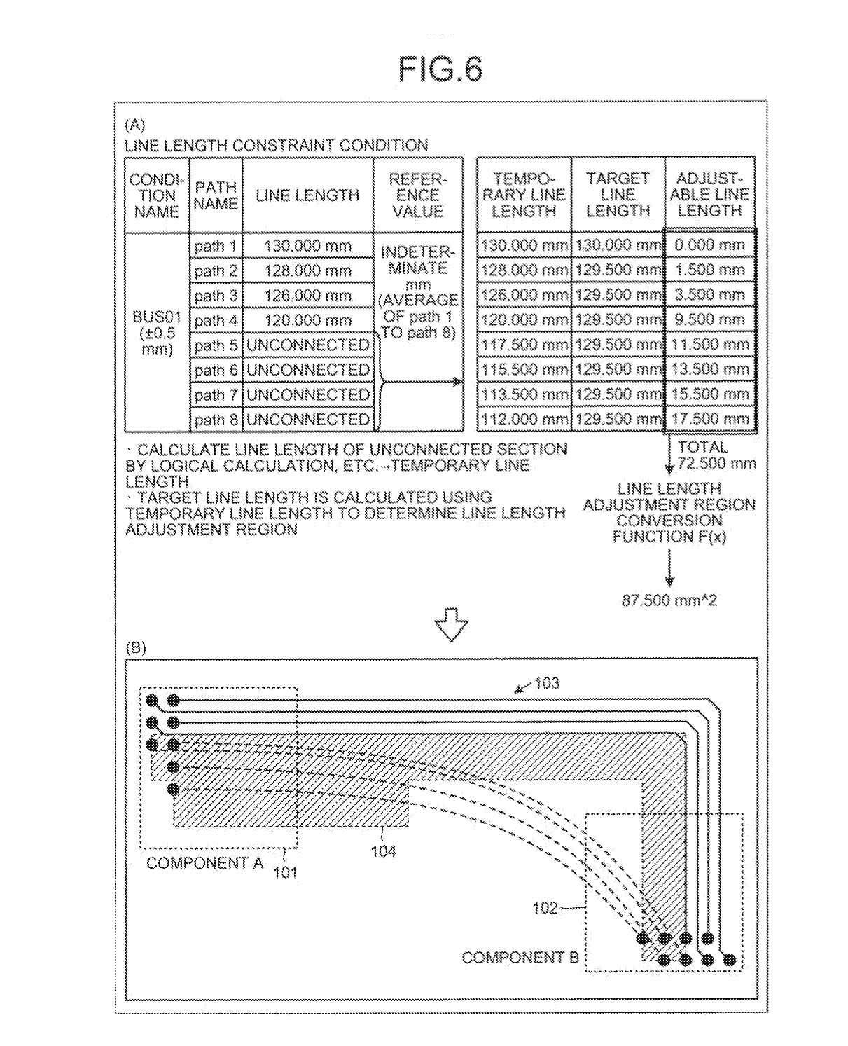

A fourth display example will be described. The fourth display example is an example of displaying a line length adjustment region even if connection of a wiring pattern is incomplete. Specifically, line lengths in an unconnected section are calculated by logical calculation, wiring path compliance/noncompliance with a line length constraint condition is checked based on the line lengths resulting from the logical calculation, and the line length adjustment region is displayed. The fourth display example will be described with reference to FIGS. 5 and 6.

FIG. 5 is an explanatory diagram of a state before display of the line length adjustment region 104 in the fourth display example. In the fourth display example, (A) in FIG. 5 depicts an example of the topology to be designed; and (B) depicts a line length constraint condition in the topology; and (C) depicts a layout that results when the topology of (A) is wired in compliance with the line length constraint condition of (B). Connecting wiring paths making up a bus 103 form a wiring pattern.

In the topology 100 of (A), a driver 101 is connected to a receiver 102 via the bus 103 specified by the line length constraint condition BUS01.

Under the line length constraint condition of FIG. 5B, the path 1 to path 4 are already connected but the path 5 to path 8 are not connected. The reference value that is the average line length of the path 1 to path 8, therefore, cannot be calculated. As a result, the noncompliant line lengths of the path 1 to path 8 cannot be calculated either. Hence, wiring patterns of the path 1 to path 4 out of the path 1 to path 8 are displayed in FIG. 5C.

FIG. 6 is an explanatory diagram of a state after display of the line length adjustment region 104 in the fourth display example. In the fourth display example, (A) depicts an instance of deriving the line length adjustment region 104 from the line length constraint condition. Before derivation of the line length adjustment region 104, temporary line lengths of the unconnected wiring paths (path 5 to path 8) are determined. For example, the Manhattan lengths of the unconnected wiring paths are determined to be the temporary line lengths thereof. For convenience, the line lengths of the connected wiring paths (path 1 to path 4) are also determined to be the temporary line lengths thereof.

The line length of the wiring path whose temporary line length is the greatest (path 1) among the wiring paths (path 1 to path 8) is determined to be a target line length for the path 1. A target line length for the remaining wiring paths (path 2 to path 8) is determined to be the lower limit line length 129.500 [mm](130.000 [mm]−0.5 [mm]) of the temporary line length of the longest wiring path (path 1).

For each wiring path, a difference between the target line length and the temporary line length is calculated to determine an adjustable line length for each wiring path. Adjustable line lengths are then summed up (72.500 [mm] in FIG. 6), and the sum of the adjustable line lengths is given to the line length adjustment region conversion function to acquire the area of the line length adjustment region (87.500 [mm²] in FIG. 6). (B) depicts a state where the line length adjustment region having the area derived in (A) is drawn in the vicinity of the wiring group consisting of the wiring paths of the path 1 to path 4.

In this manner, the line length adjustment region necessary for the wiring group is displayed in the vicinity of the wiring patterns of the connected wiring paths. Because of this, even if unconnected wiring paths (path 5 to path 8) are present, the region necessary for increasing the line lengths of the wiring paths (path 1 to path 8) making up the wiring group into the equal length can be known.

A fifth display example will be described. Similar to the fourth display example, the fifth display example is an example of displaying a line length adjustment region even if connection of a wiring pattern is incomplete. Specifically, the logical line lengths of wiring paths are calculated based not on each wiring path but on schematic route information concerning a wiring group. The wiring path compliance/noncompliance with a line length constraint condition is checked based on the logically calculated line lengths, and the line length adjustment region is displayed.

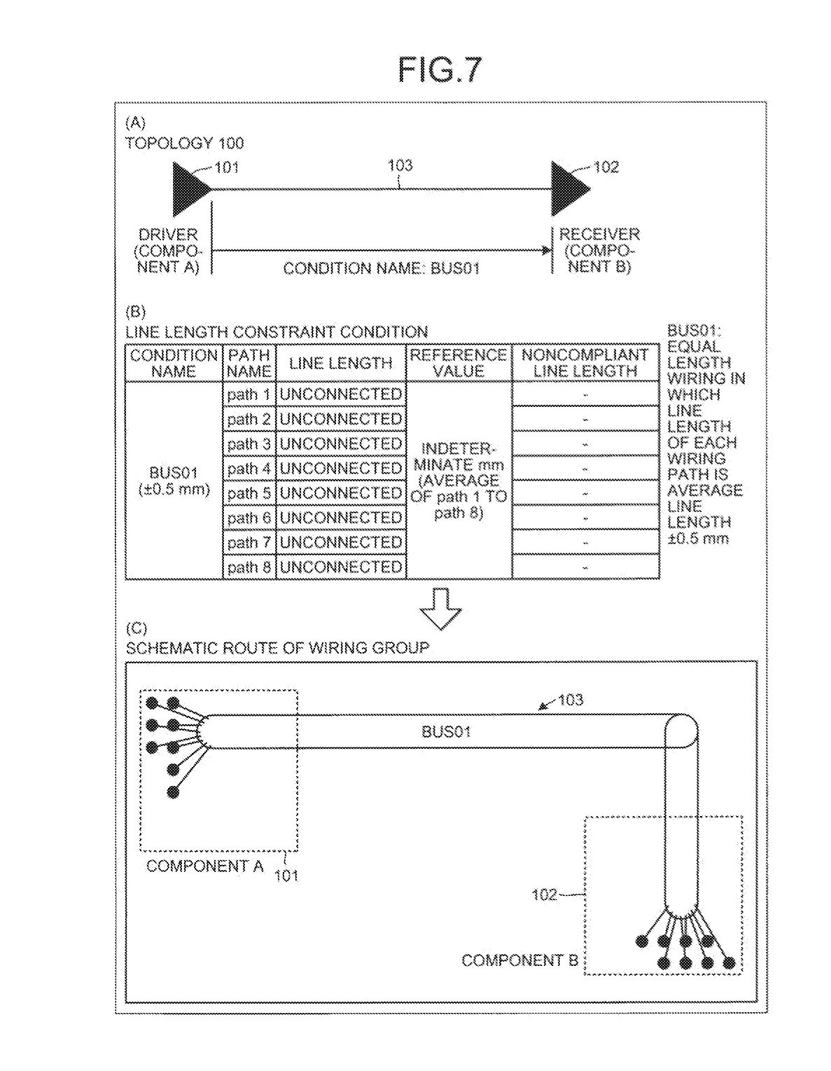

FIG. 7 is an explanatory diagram of a state before display of the line length adjustment region in the fifth display example. In the first display example, (A) in FIG. 1 depicts an example of topology 100 to be designed; and (B) depicts a line length constraint condition in the topology; and (C) depicts a layout that results when the topology of (A) is wired in compliance with the line length constraint condition of (B). Connecting wiring paths making up a bus 103 form a wiring pattern.

In the topology 100 of (A), a driver 101 is connected to a receiver 102 via the bus 103 specified by the line length constraint condition BUS01.

Under the line length constraint condition of (B) in FIG. 7, none of wiring paths (the path 1 to path 8) are connected. The reference value that is the average line length of the path 1 to path 8 and therefore, is not calculated. As a result, the noncompliant line lengths of the path 1 to path 8 are not calculated either. In (C), therefore, none of the wiring paths are displayed and the bus 103 (bus name BUS01) representing the wiring group consisting of the path 1 to path 8 is displayed as a schematic route.

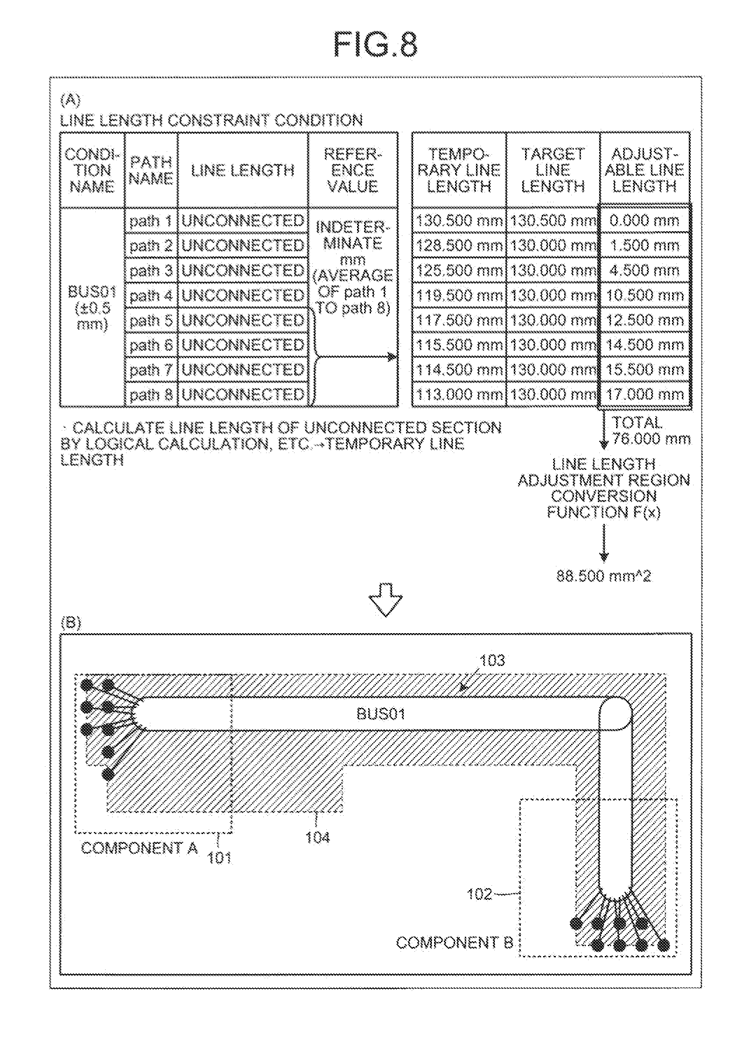

FIG. 8 is an explanatory diagram of a state after display of the line length adjustment region in the fifth display example. In the fourth display example, (A) depicts an instance of deriving the line length adjustment region from the line length constraint condition. Before derivation of the line length adjustment region 104, temporary line lengths of the unconnected wiring paths (path 1 to path 8) are determined. For example, the Manhattan lengths of the unconnected wiring paths are determined to be the temporary line lengths thereof.

The line length of the wiring path whose temporary line length is the greatest (path 1) among the wiring paths (path 1 to path 8) is determined to be a target line length for the path 1. A target line length for the remaining wiring paths (path 2 to path 8) is determined to be the lower limit line length 130.000 [mm] (130.000 [mm]−0.5 [mm]) of the temporary line length of the longest wiring path (path 1).

For each wiring path, a difference between the target line length and the temporary line length is calculated to determine an adjustable line length for each wiring path. Adjustable line lengths are then summed up (76.000 [mm] in FIG. 8), and the sum of the adjustable line lengths is given to the line length adjustment region conversion function to acquire the area of the line length adjustment region (88.500 [mm²] in FIG. 8). (B) in FIG. 8 depicts a state where the line length adjustment region 104 having the area derived as depicted in (A) of FIG. 8 is drawn in the vicinity of the bus 103 representing the wiring group consisting of the path 1 to path 8.

In this manner, by interpolating for a unconnected section by logical calculation, a line length adjustment region for wiring paths can be displayed even in an unconnected condition, based on a schematic route. Even for an unconnected wiring group, therefore, the line length adjustment region can be confirmed through the schematic route.

A sixth display example will be described. The sixth display example is an example of display of a line length adjustment region in the case of multiple wiring groups being present in the fifth display example.

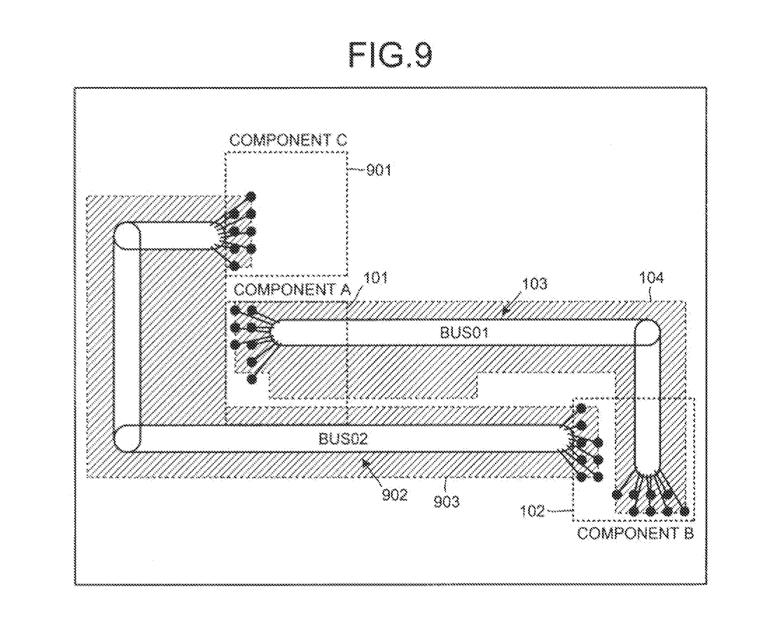

FIG. 9 is an explanatory diagram of a state after display of the line length adjustment region in the sixth display example. Specifically, FIG. 9 depicts the bus 103 serving as a schematic route for one wiring group and a bus 902 serving as a schematic route for a wiring group between a driver 901 and the receiver 102.

The line length adjustment region 104 for the bus 103 is displayed around the bus 103, while a line length adjustment region 903 for the bus 902 is displayed around the bus 902. In the sixth display example, the line length adjustment region 104 and the line length adjustment region 903 are displayed in an adjusted manner so as to not overlap each other.

This enables simultaneous checking of multiple wiring groups for insufficient line length adjustment regions.

A seventh display example will be described. The seventh display example is an example of displaying insufficiencies of the line length adjustment region in the second, third, and sixth display examples. An example of displaying insufficiencies of the line length adjustment region in the sixth display example will be described as a typical example.

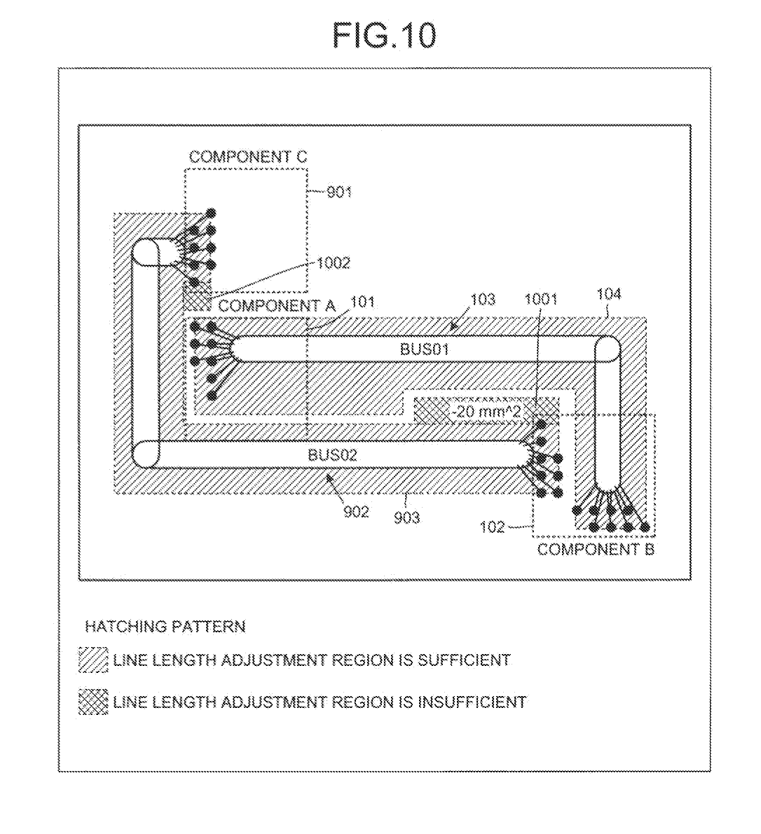

FIG. 10 is an explanatory diagram of a state after display of the line length adjustment region in the seventh display example. FIG. 10 depicts the line length adjustment region 104 for the wiring group with the schematic route as the bus 103 and the line length adjustment region 903 for the wiring group with the schematic route as the bus 902. The line length adjustment region 903 is insufficient in region. As a result, insufficient regions 1001 and 1002 equivalent to the area of the region of insufficiency are displayed in an empty region that is not laid out.

In this manner, an insufficiency of the line length adjustment region, an area of insufficiency, and the location of an region equivalent to the area of insufficiency are known in advance, reducing setbacks in wiring design. While the insufficient regions 1001 and 1002 are displayed in the seventh display example, an area of insufficiency may be displayed in the form of a character string or a numerical value (e.g., 20 [mm²], etc.).

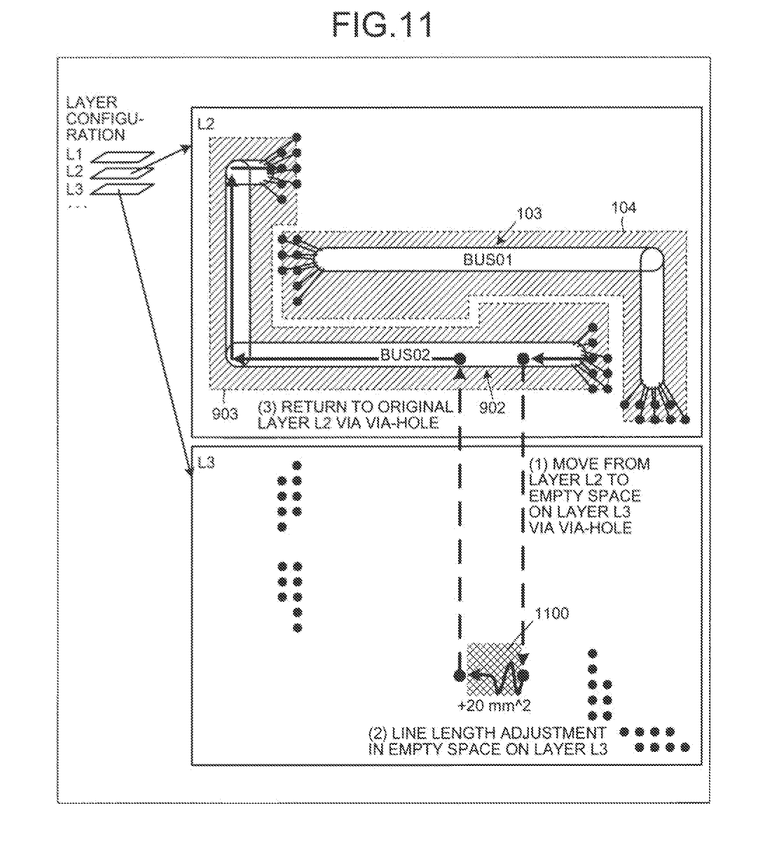

An eighth display example will be described. The eighth display example is an example of displaying insufficiencies of the line length adjustment region in the second, third, and sixth display examples. An example of displaying insufficiencies of the line length adjustment region in the sixth display example will be described as a typical example with reference to FIG. 11.

FIG. 11 is an explanatory diagram of a state after display of the line length adjustment region in the eighth display example. In FIG. 11, layout data is present for each layer L1, L2, and L3. For example, the line length adjustment region 104 for the wiring group with the schematic route as the bus 103 and the line length adjustment region 903 for the wiring group with the schematic route as the bus 902 are displayed on the layer L2.

If, for example, the line length adjustment region 903 is insufficient in an area of 20 [mm²], the insufficient regions 1001 and 1002 are not displayed on the same layer L2 as in the seventh display example, but rather a insufficient region 1100 is displayed on another layer (layer L3 in FIG. 11). The line length adjustment region 903 on the layer L2 is connected to the insufficient region 1100 on the layer L3 via via-holes.

The layer L3 is used as an insufficient region dedicated layer. Hence, the designer is able to intuitively know of insufficiencies by checking the layer L3. Since the insufficient region 1100 is connected to the line length adjustment region 903 via the via-holes, the insufficient region 1100 may be used directly as the line length adjustment region.

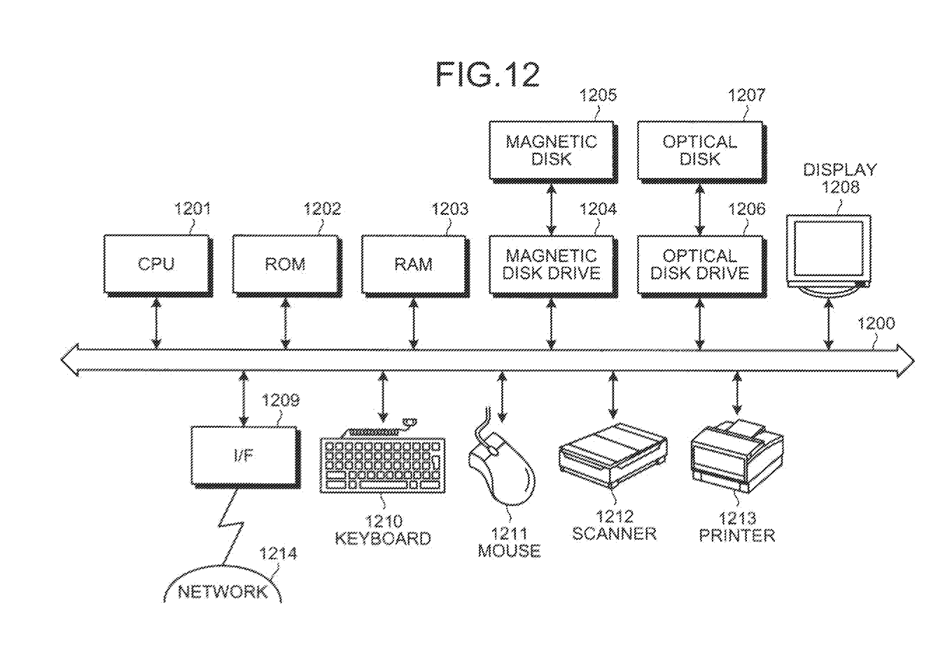

FIG. 12 is a block diagram of a hardware configuration of a design support apparatus according to the embodiments. As depicted in FIG. 12, the design support apparatus includes a central processing unit (CPU) 1201, a read-only memory (ROM) 1202, a random access memory (RAM) 1203, a magnetic disk drive 1204, a magnetic disk 1205, an optical disk drive 1206, an optical disk 1207, a display 1208, an interface (I/F) 1209, a keyboard 1210, a mouse 1211, a scanner 1212, and a printer 1213, respectively connected by a bus 1200.

The CPU 1201 governs overall control of the design support apparatus. The ROM 1202 stores therein programs such as a boot program. The RAM 1203 is used as a work area of the CPU 1201. The magnetic disk drive 1204, under the control of the CPU 1201, controls the reading and writing of data with respect to the magnetic disk 1205. The magnetic disk 1205 stores therein data written under control of the magnetic disk drive 1204.

The optical disk drive 1206, under the control of the CPU 1201, controls the reading and writing of data with respect to the optical disk 1207. The optical disk 1207 stores therein data written under control of the optical disk drive 1206, the data being read by a computer.

The display 1208 displays, for example, data such as text, images, functional information, etc., in addition to a cursor, icons, and/or tool boxes. A cathode ray tube (CRT), a thin-film-transistor (TFT) liquid crystal display, a plasma display, etc., may be employed as the display 1208.

The I/F 1209 is connected to a network 1214 such as a local area network (LAN), a wide area network (WAN), and the Internet through a communication line and is connected to other apparatuses through the network 1214. The I/F 1209 administers an internal interface with the network 1214 and controls the input/output of data from/to external apparatuses. For example, a modem or a LAN adaptor may be employed as the I/F 1209.

The keyboard 1210 includes, for example, keys for inputting letters, numerals, and various instructions and performs the input of data. Alternatively, a touch-panel-type input pad or numeric keypad, etc. may be adopted. The mouse 1211 is used to move the cursor, select a region, or move and change the size of windows. A track ball or a joy stick may be adopted provided each respectively has a function similar to a pointing device.

The scanner 1212 optically reads an image and takes in the image data into the design support apparatus. The scanner 1212 may have an optical character reader (OCR) function as well. The printer 1213 prints image data and text data. The printer 1213 may be, for example, a laser printer or an ink jet printer.

The contents of various tables used in this embodiment will be described.

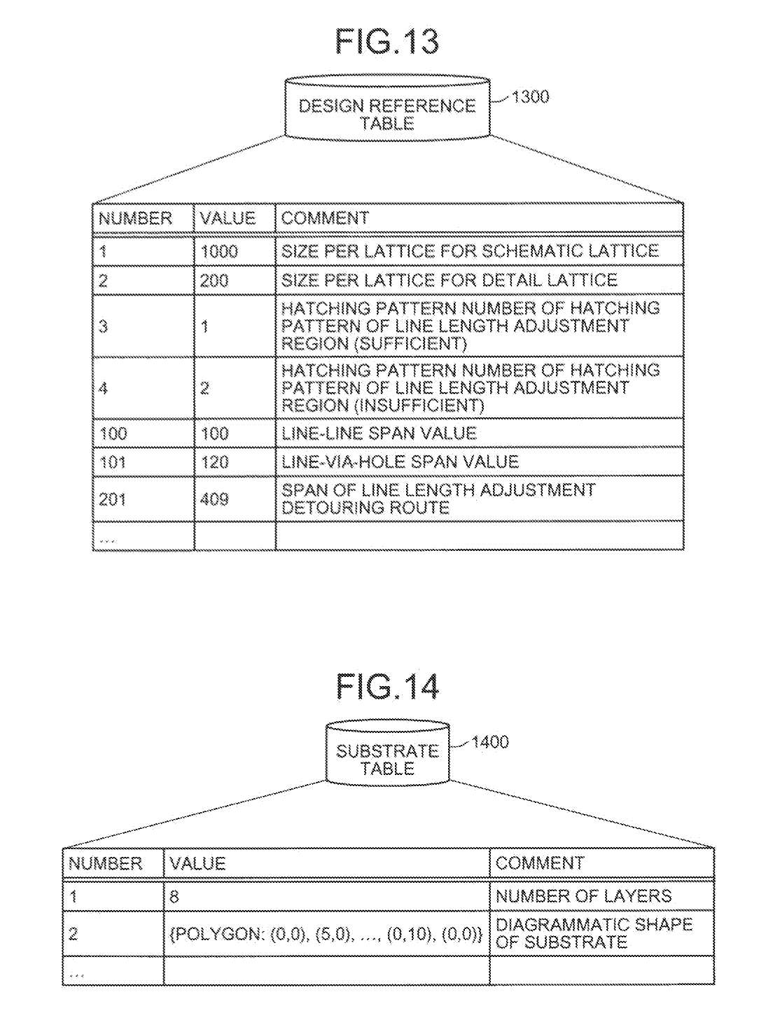

FIG. 13 is an explanatory diagram of an example of the contents of a design reference table 1300. The design reference table 1300 is a table that provides a design reference for layout. For example, the design reference table 1300 defines values for a line length constraint condition, such as a size per lattice for a schematic lattice, a size per lattice for a detail lattice, a hatching pattern number for a line length adjustment region (sufficient), a hatching pattern number for a line length adjustment region (insufficient), a line-line gap value, and a line-via-hole gap value. Wiring paths are laid out in accordance with the design reference.

FIG. 14 is an explanatory diagram of an example of the contents of a substrate table 1400. The substrate table 1400 is the table that provides information concerning a substrate, such as the number of layers making up the substrate and the diagrammatic shape of the substrate. For example, when the number of layers is 8, such layers as depicted in FIG. 11 consist of layers L1 to L8. The diagrammatic shape of the substrate is defined with apex coordinates of the shape.

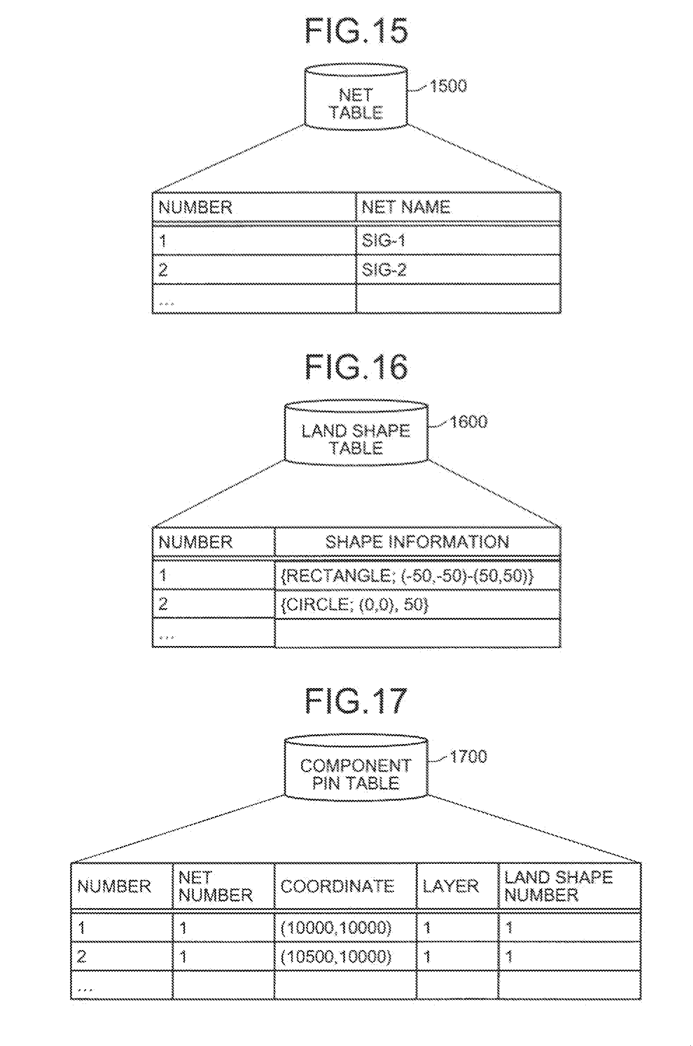

FIG. 15 is an explanatory diagram of an example of the contents of a net table 1500. The net table 1500 is the table that for each net, correlates a net number for identifying the net with a net name.

FIG. 16 is an explanatory diagram of an example of the contents of a land shape table 1600. The land shape table 1600 is the table that for each land, correlates a land shape number for identifying the land with shape information on the land. Shape information is information for identifying a shape. For example, when a land shape is a rectangle, the shape information is made up of “rectangle (identifier indicative of “rectangle”)” and two apex coordinates diagonal to each other. When a land shape is a circle, the shape information is made up of “circle (identifier indicative of “circle”)”, a central coordinate, and a radius.

FIG. 17 is an explanatory diagram of an example of the contents of a component pin table 1700. The component pin table 1700 is the table that for each component pin, correlates a component pin number for identifying the component pin, a net number of a net to which the component pin belongs, the coordinate position of the component pin, a layer number of a layer on which the component pin is disposed, and a land shape number corresponding to the component pin.

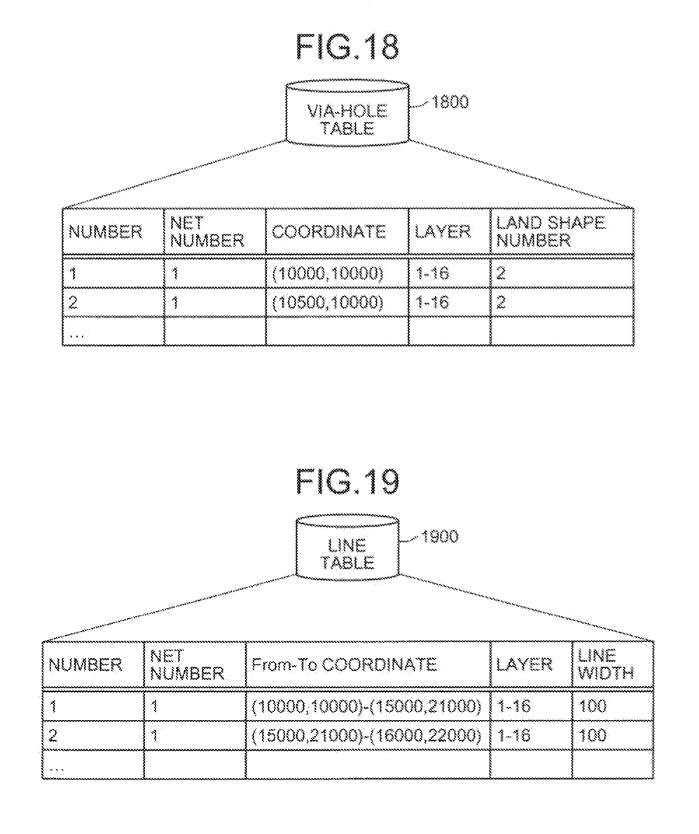

FIG. 18 is an explanatory diagram of an example of the contents of a via-hole table 1800. The via-hole table 1800 is the table that for each via-hole, correlates a via-hole number for identifying the via-hole, a net number of a net to which the via-hole belongs, the coordinate position of the via-hole, a layer number of a layer on which the via-hole is disposed, and a land shape number corresponding to the via-hole.

FIG. 19 is an explanatory diagram of an example of the contents of a line table 1900. The line table 1900 is the table that for each line, correlates a line number for identifying a line, a net number of a net to which the line belongs, the From-To coordinate position of the line, the line width of the line, and a layer number of a layer on which the line is laid. A wiring pattern is formed by drawing in accordance with the line width.

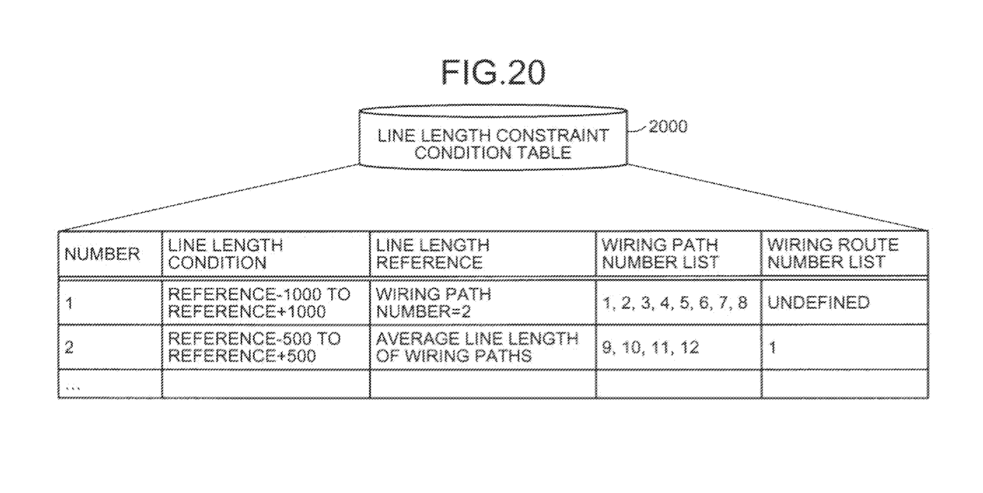

FIG. 20 is an explanatory diagram of an example of the contents of a line length constraint condition table 2000. The line length constraint condition table 2000 is a table that for each line length constraint condition, correlates a constraint condition number for identifying a line length constraint condition, a line length condition, a line length reference, a wiring path number list, and a wiring route number list. The line length condition indicates a range permitted by the line length constraint condition. Hence, a wiring path complying with line length condition information is a reference path, while a wiring path not complying with the line length condition information is a noncompliance path.

The constraint condition number corresponds to the condition name of FIG. 1 or FIG. 10. The line length reference is information indicative of a reference for wiring paths to be restricted under the constraint condition. For example, when a specific wiring path is determined to be the reference, a wiring path number of the specific wiring path (e.g., wiring path number 2) is set as the line length reference. In this case, the wiring path identified by the wiring path number is the reference path. The average line length of wiring paths to be constrained may be determined to be the line length reference. A value acquired as the line length reference is equivalent to the reference value in the line length constraint condition.

The wiring path number list is the list of wiring path numbers for identifying wiring paths to which the line length constraint condition is applied. The line length reference is set based on the wiring path number list. For example, when a specific wiring path number is determined to be the line length reference, the specific wiring path number is selected from the wiring path number list. Likewise, when the average line length of wiring paths is determined to be the line length reference, the average line length of a group of wiring paths specified by the wiring path number list is the line length reference.

The wiring route number list is the list of wiring route numbers for defining wiring group wiring routes specified by the wiring path number list.

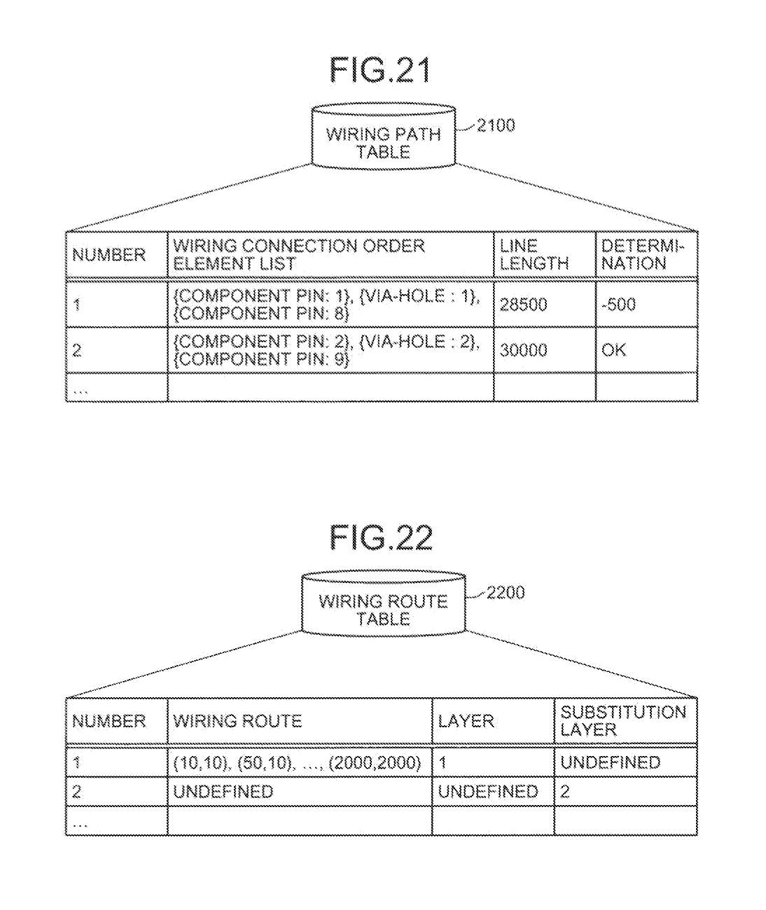

FIG. 21 is an explanatory diagram of an example of the contents of a wiring path table 2100. The wiring path table 2100 is a table that for each wiring path, correlates a wiring path number for identifying a wiring path, a wiring connection order element list, and line length determining information.

The wiring path number corresponds to the path name in the line length constraint condition. The wiring connection order element list is the list of such wiring elements as component pins and via-holes that are arranged in the order of connection. The line length is the line length of a wiring path, being equivalent to the line length in the line length constraint condition. The line length determining information is information indicative of the result of a determination on whether a wiring path is in compliance with the line length constraint condition. When the line length determining information is “OK”, the wiring path is in compliance with the line length constraint condition. When the line length determining information is a numerical value, however, the wiring path is not in compliance with the line length constraint condition. A positive numerical value means excess in line length, while a negative numerical value means insufficiency in line length.

FIG. 22 is an explanatory diagram of an example of the contents of a wiring route table 2200. The wiring route table 2200 is a table that for each wiring route, correlates a wiring route number for identifying a wiring route, a wiring route, a wiring layer number, and a substitute layer number. The wiring route is defined with a series of coordinate values.

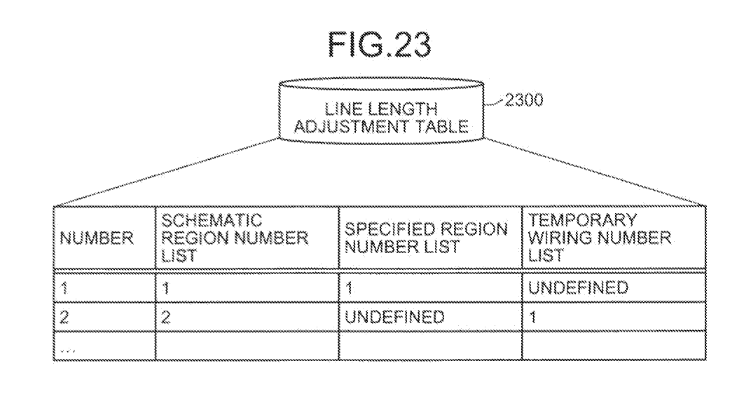

FIG. 23 is an explanatory diagram of an example of the contents of a line length adjustment table 2300. The line length adjustment table 2300 is a table that for each line length constraint condition, correlates a schematic region, a specified region, and temporary wiring. Specifically, for each line length constraint condition number, the line length adjustment table 2300 correlates a schematic region number list, a specified region number list, and a temporary wiring number list, with each other. For example, in a record on the first line of the line length adjustment table 2300, a schematic region with a schematic region number 1 and a specified region with a specified region number 1 are each defined as a schematic region for a wiring path identified by a line length constraint condition number 1.

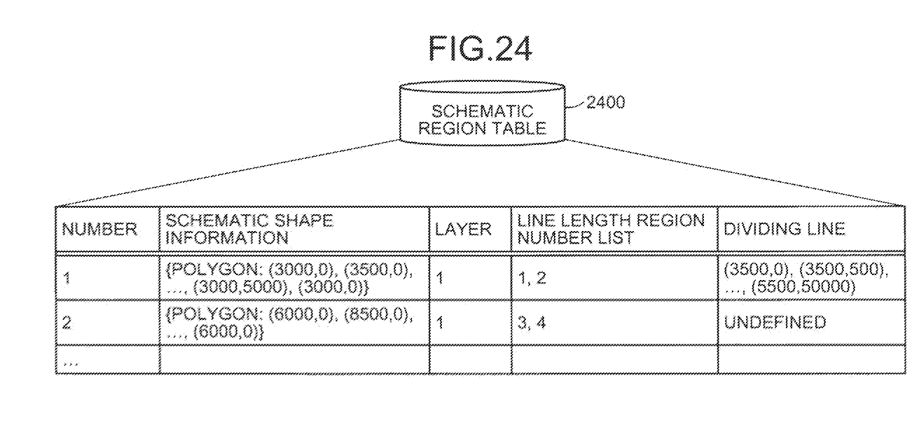

FIG. 24 is an explanatory diagram of an example of the contents of a schematic region table 2400. The schematic region table 2400 is a table that specifies a schematic region for each schematic region number. Specifically, for each schematic region number, the schematic region table 2400 correlates schematic shape information, a layer number, a line length region number list, and a dividing line. The schematic shape information is information for identifying the shape of a schematic region. The layer number is a number for identifying a layer on which the schematic region is set. The line length region number list is a list of line length region numbers for identifying a line length region in the schematic region. The dividing line is a group of coordinates representing apexes penetrated by a diving line dividing the schematic region.

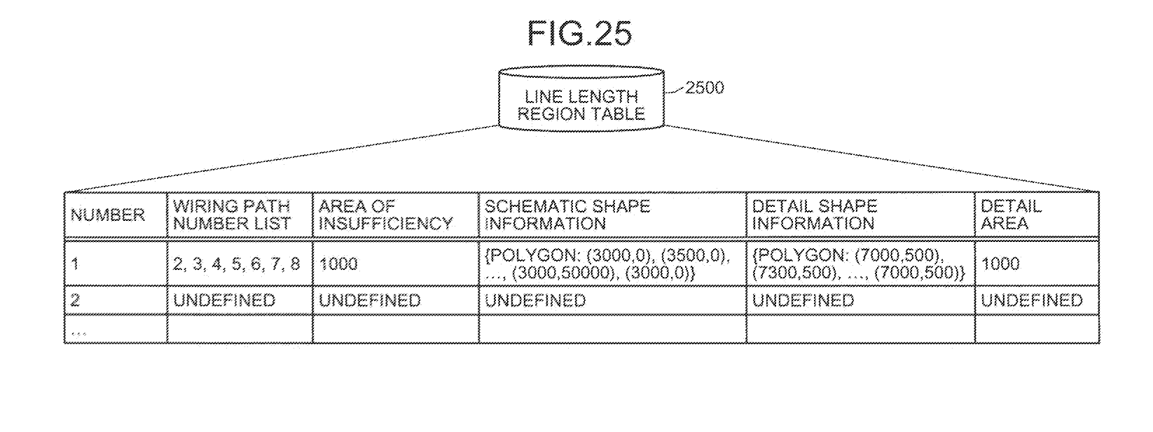

FIG. 25 is an explanatory diagram of an example of the contents of a line length region table 2500. The line length region table 2500 is a table that for each line length region number, correlates a wiring path number list, the area of insufficiency, schematic shape information, detail shape information, and a detail area.

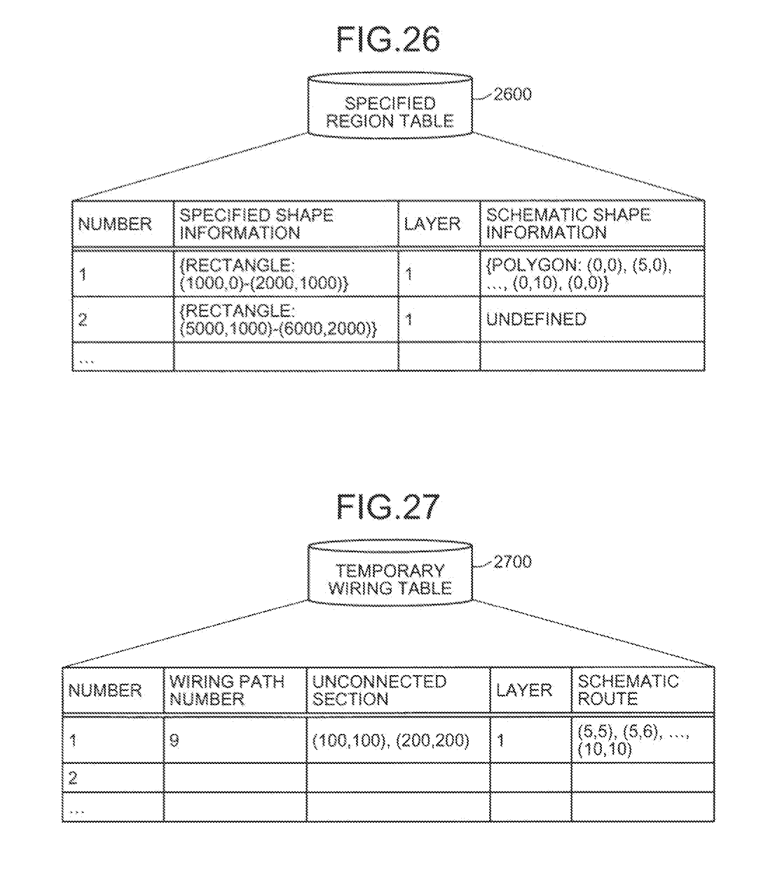

FIG. 26 is an explanatory diagram of an example of the contents of a specified region table 2600. The specified region table 2600 is a table that for each specified region number, correlates specified shape information, a layer number, and schematic shape information.

FIG. 27 is an explanatory diagram of an example of the contents of a temporary wiring table 2700. The temporary wiring table 2700 is a table that for each temporary wiring number, correlates a wiring path number, an unconnected section, a layer number, and a schematic route.

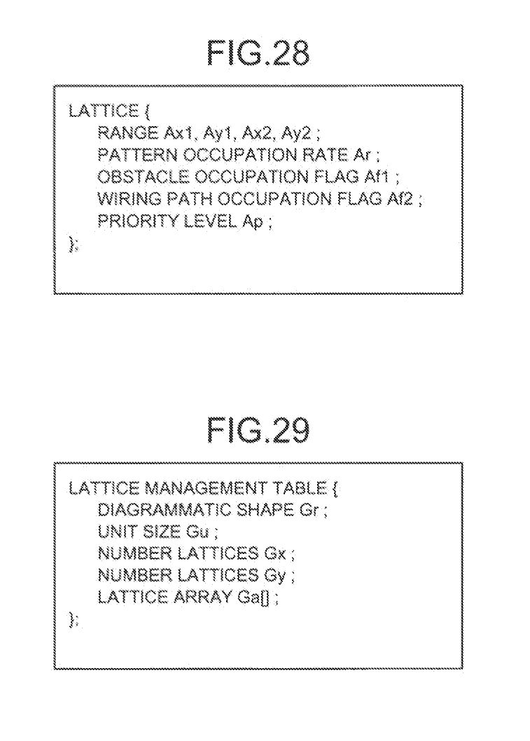

FIG. 28 is an explanatory diagram of an example of the contents of a lattice structure. The lattice as a structure is made up of a range {Ax1, Ay1, Ax2, Ay2}, a pattern occupation rate Ar, an obstacle occupation flag Af1, a wiring path occupation flag Af2, and a priority level Ap. The range {Ax1, Ay1, Ax2, Ay2} is information for specifying the shape of a lattice, which is specified as a rectangle with the upper left apex {Ax1, Ay1} and the lower right apex {Ax2, Ay2}.

FIG. 29 is an explanatory diagram of an example of the contents of a lattice management table structure. The lattice management table as a structure is made up of a diagrammatic shape Gr, a unit size Gu, the number of lattices Gx, the number of lattices Gy, and a lattice array Ga[ ]. The diagrammatic shape Gr is the diagrammatic shape of a rectangle including a given diagrammatic shape S. The unit size Gu is for specifying the unit size of lattices making up the lattice management table. The number of lattices Gx is the number of lattices in the x direction on the lattice management table. The number of lattices Gy is the number of lattices in the y direction on the lattice management table. The lattice array Ga[ ] represents a group of lattices included in the lattice management table.

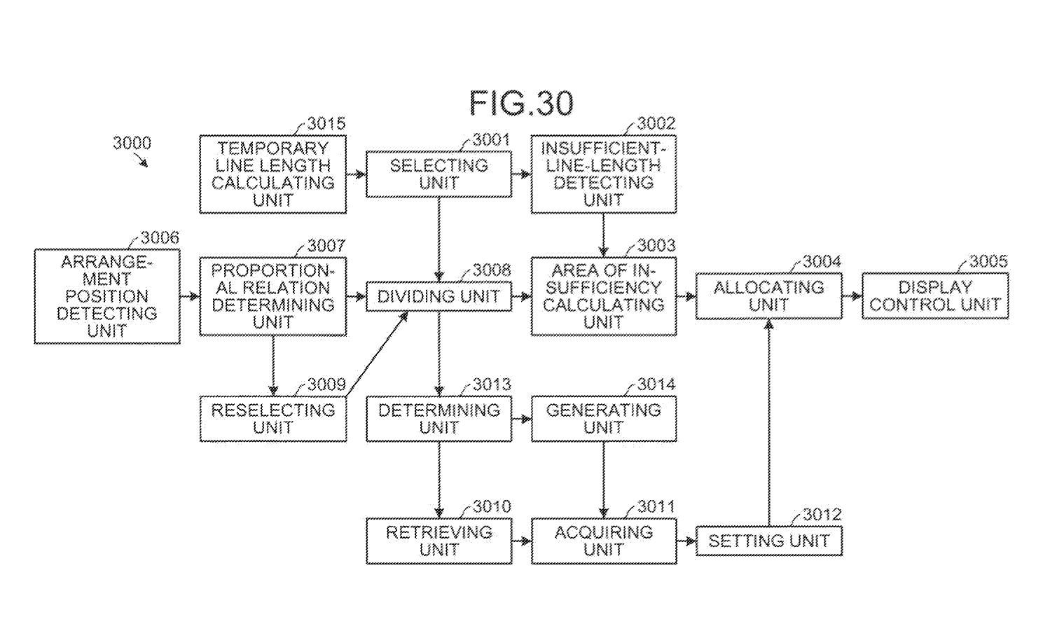

FIG. 30 is a block diagram of a functional configuration of the design support apparatus. A design support apparatus 3000 includes a selecting unit 3001, a insufficient-line-length detecting unit 3002, an area of insufficiency calculating unit 3003, an allocating unit 3004, a display control unit 3005, an arrangement position detecting unit 3006, a proportional relation determining unit 3007, a dividing unit 3008, a reselecting unit 3009, a retrieving unit 3010, an acquiring unit 3011, a setting unit 3012, a determining unit 3013, a generating unit 3014, and a temporary line length calculating unit 3015, the functions of which, for example, are implemented when the CPU 1201 executes programs stored in such memory devices as the ROM 1202, the RAM 1203, the magnetic disk 1205, and the optical disk 1207 depicted in FIG. 12 or by the I/F 1209.

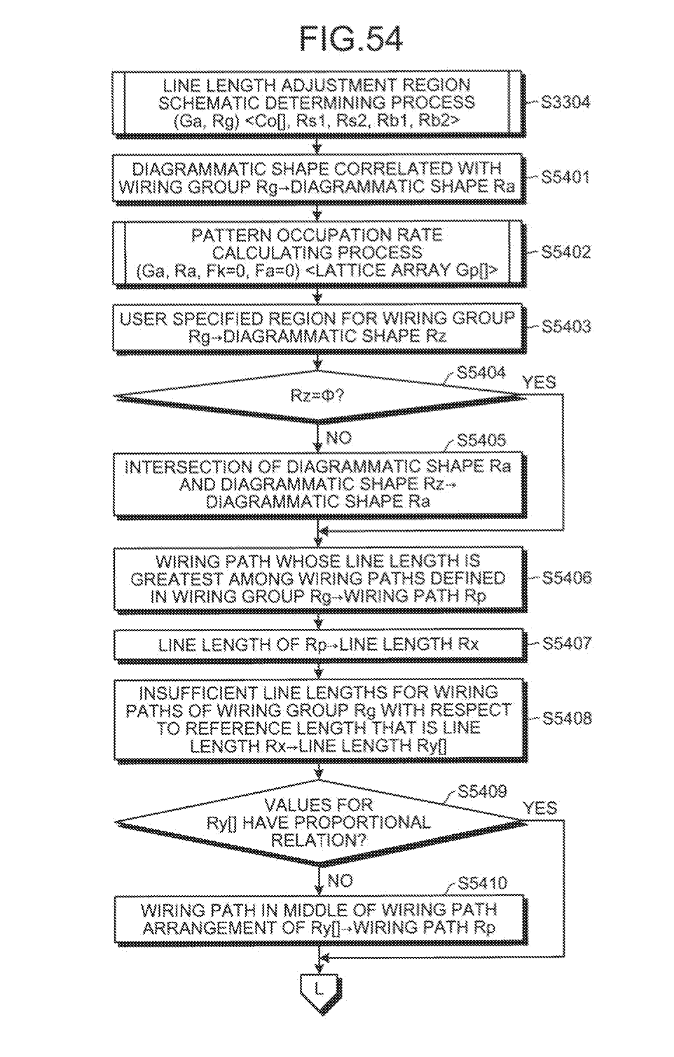

The selecting unit 3001 selects a specific wiring path whose line length is the greatest from among the wiring paths making up a wiring group connecting a transmission origin to a transmission destination. The transmission origin is, for example, the receiver 102. The wiring group is, for example, a wiring pattern consisting of a bundle of wiring paths, such as the bus 103. The selecting unit 3001 selects the wiring path whose line length is greatest from among the wiring paths making up the wiring group, as the specific wiring path. The remaining wiring paths other than the selected wiring path are, therefore, shorter in line length than the specific wiring path. The selecting unit 3001 carries out a process at step S5406 of a flowchart depicted in FIG. 54, which will be described later.

The insufficient-line-length detecting unit 3002 detects insufficient line lengths of the remaining wiring paths with respect to the specific wiring path selected by the selecting unit 3001. For example, insufficient line length is calculated by subtracting the line length of a remaining wiring path from the specific wiring path.

The area of insufficiency calculating unit 3003 calculates the area of insufficiency according to the sum of insufficient line lengths of the remaining wiring paths detected by the insufficient-line-length detecting unit 3002. For example, the area of insufficiency for the wiring group is calculated by multiplying the sum of the insufficient line lengths detected by the insufficient-line-length detecting unit 3002 by a line length adjustment width read out from the design reference table 1300 depicted in FIG. 13.

The allocating unit 3004 allocates a line length adjustment region according to the total area of insufficiency calculated by the area of insufficiency calculating unit 3003, to the vicinity of the wiring group. The definition of vicinity is as follows. In this embodiment, the lattice management table representing a group of lattices arranged in a matrix formation is adopted. As a result, a lattice including the remaining wiring path farthest from the specific wiring path or a lattice adjacent to that lattice is selected first as a lattice in the vicinity. The lattice including the remaining wiring path farthest from the specific wiring path is sufficient for wiring when the wiring pattern occupation rate of the lattice is equal to or less than a given rate, in which case, therefore, the lattice is selected as the lattice in the vicinity.

The region is expanded stepwise toward the outside of the wiring group until the region goes beyond the area of insufficiency. When the line length adjustment region is determined schematically, the lattice management table is segmented to determine the line length adjustment region in detail. These detailed processes will be described later with reference to flowcharts.

The display control unit 3005 controls a display screen to display the wiring group and the line length adjustment region allocated by the allocating unit 3004 on the display screen. The allocating unit 3004 may allocate the line length adjustment region in the vicinity of a wiring group free from an obstacle, as depicted in the second display example. The allocating unit 3004 may allocate the line length adjustment region in a region whose range is specified in the vicinity to the wiring group, as depicted in the third display example.

The arrangement position detecting unit 3006 detects the order in which the wiring paths are arranged. According to the order of arrangement of the wiring paths detected by the arrangement position detecting unit 3006, the proportional relation determining unit 3007 determines whether a proportional relation exists between insufficient line length and the order of arrangement. A proportional relation indicates a trend in variation between the insufficient line lengths following the order of arrangement of wiring paths and existence of a proportional relation is determined by calculation of correlation coefficients.

The dividing unit 3008 has a function of dividing the wiring group by a boundary line to include a specific wiring path in a sub-wiring group, based on a determination result obtained by the proportional relation determining unit 3007. If the existence of the proportional relation is determined, division of the wiring group by the dividing unit 3008 results in a sub-wiring group substantially composed of the specific wiring path only and a sub-wiring group mainly composed of the remaining wiring paths other than the specific wiring path because the specific wiring path is situated closer to one end of the arrangement of wiring paths.

In this case, for each sub-wiring group resulting from the division by the dividing unit 3008, the area of insufficiency calculating unit 3003 calculates the area of insufficiency according to the sum of insufficient line lengths of the remaining wiring paths in a sub-wiring group. Further, for each of the sub-wiring groups, the allocating unit 3004 allocates to a vicinity of the sub-wiring group, a line length adjustment region according to the area of insufficiency.

The reselecting unit 3009 has a function of newly selecting, as the specific wiring path, a wiring path arranged in the middle of multiple wiring paths, if the proportional relation determining unit 3007 determines the nonexistence of the proportional relation. Specifically, insufficient line lengths are substantially equal to each other if a proportional relation does not exist. In such a case, the wiring group is not divided with respect to the specific wiring path as reference path but rather is divided with respect to the wiring path arranged in the middle, enabling more efficient allocation by the allocating unit 3004.

The retrieving unit 3010 has a function of retrieving, for each sub-wiring group resulting from the division by the dividing unit 3008, the shortest route between ends of a boundary line and detouring the sub-wiring group. For example, the retrieving unit 3010 retrieves the shortest route that does not pass through the diagrammatic shape of a sub-wiring group (passage through the boundary is permitted).

For each sub-wiring group, the acquiring unit 3011 acquires a detouring region detouring the sub-wiring group to enable wiring, from a figure encompassed by the boundary line and the shortest route retrieved by the retrieving unit 3010. For each sub-wiring group, the setting unit 3012 adjusts the area of the detouring region acquired by the acquiring unit 3011 to make the area equal to or less than the area of insufficiency and thus, sets the line length adjustment region.

For each sub-wiring group, the determining unit 3013 determines whether the area of the detouring region is at most the area of insufficiency. If the determining unit 3013 determines the area of the detouring region to be equal to or less than the area of insufficiency, the retrieving unit 3010 newly retrieves the shortest route that is between ends of the boundary line and detours the sub-wiring group the most. This means that when multiple shortest routes are present, the shortest route that detours the sub-wiring group the most is selected, enabling selection of a larger line length adjustment region. The acquiring unit 3011 then acquires, from a figure encompassed by the boundary line and the shortest route newly retrieved by the retrieving unit 3010, a detouring region detouring the sub-wiring group.

If the determining unit 3013 determines the area of the detouring region to be equal to or less than the area of insufficiency, the generating unit generates a figure by expanding the figure encompassed by the boundary line and the shortest route newly retrieved by the retrieving unit 3010 by a given extent. Through this process, the figure is expanded stepwise until the figure covers the area of insufficiency. In this case, the acquiring unit 3011 acquires a detouring region detouring the sub-wiring group from the figure generated by the generating unit.

The temporary line length calculating unit 3015 calculates the temporary line length of an unconnected wiring path in the wiring group. Specifically, as depicted in the fourth and fifth display examples, even if some or all of wiring paths making up the wiring group are unconnected, a line length adjustment region is allocated to be displayed using temporary line lengths. In this case, the selecting unit 3001 selects a specific wiring path from among wiring paths making up the wiring group, using the temporary line length calculated by the temporary line length calculating unit 3015.

The insufficient-line-length detecting unit 3002 detects insufficient line lengths of the remaining wiring paths with respect to the specific wiring path, using the temporary line length calculated by the temporary line length calculating unit 3015. The area of insufficiency calculating unit 3003 calculates the area of insufficiency according to the sum of the insufficient line lengths of the remaining wiring paths, using the temporary line lengths calculated by the temporary line length calculating unit 3015.

The allocating unit 3004 may allocate the line length adjustment region in such a way that the allocated line length adjustment region does not overlap another line length adjustment region, as depicted in the sixth display example. The determining unit 3013 determines whether the area of the line length adjustment region is sufficient, based on the area of insufficiency, as depicted in the eighth display example. In this case, if the determining unit 3013 determines the area of the line length adjustment region to be insufficient, the allocating unit allocates to another layer, a region equivalent to the area of insufficiency, enabling the area of insufficiency to be allocated to a substitute layer.

The determining unit 3013 determines whether the area of the line length adjustment region is sufficient, based on the area of insufficiency. If the determining unit 3013 determines the area of the line length adjustment region to be insufficient, the display control unit 3005 displays the line length adjustment region on the display screen in a manner different from the manner of display in the case of the line length adjustment region being sufficient. In other words, if the line length adjustment region is insufficient, the display control unit 3005 displays the line length adjustment region in a manner that enables the designer to know that the line length adjustment region is insufficient, using a hatched pattern, character display, etc. This allows the designer to know in advance that the line length adjustment region is insufficient and thus, reduces setbacks in wiring design.

A design support procedure of this embodiment will be described.

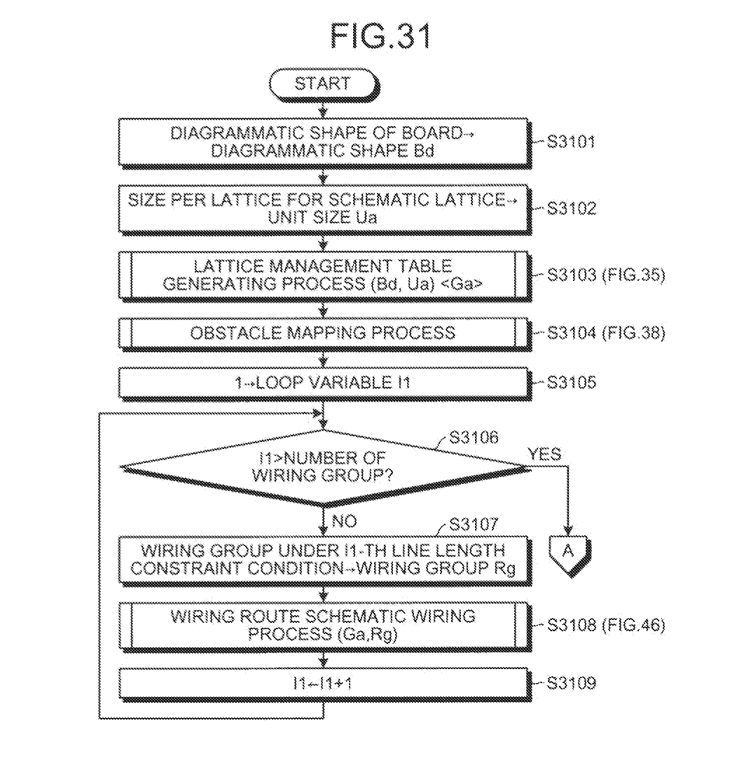

FIGS. 31 to 33 are flowcharts of the design support procedure by the design support apparatus according to this embodiment. In FIG. 31, at steps S3101 to S3103, a substrate shape is divided into a mesh of unit lattices of a relatively large size.

Specifically, the substrate table 1400 of FIG. 14 is referenced and, the layer number and the diagrammatic shape of the substrate to be designed are readout, whereby the diagrammatic shape is set as a diagrammatic shape Bd (step S3101). Subsequently, the design reference table 1300 of FIG. 13 is referenced (e.g., a record number 1) to set the size per unit lattice for the schematic lattice as a unit size Ua (step S3102). A lattice management table generating process is then carried out using a function with arguments of the diagrammatic shape Bd and the unit size Ua and a return value of the lattice management table Ga (step S3103).

Through the lattice management table generating process (step S3103), which will be described in detail later, the lattice management table Ga is acquired as the return value. The lattice management table Ga is a table obtained by dividing the diagrammatic shape Bd of the substrate into a mesh of lattices in the unit size Ua for the schematic lattice.

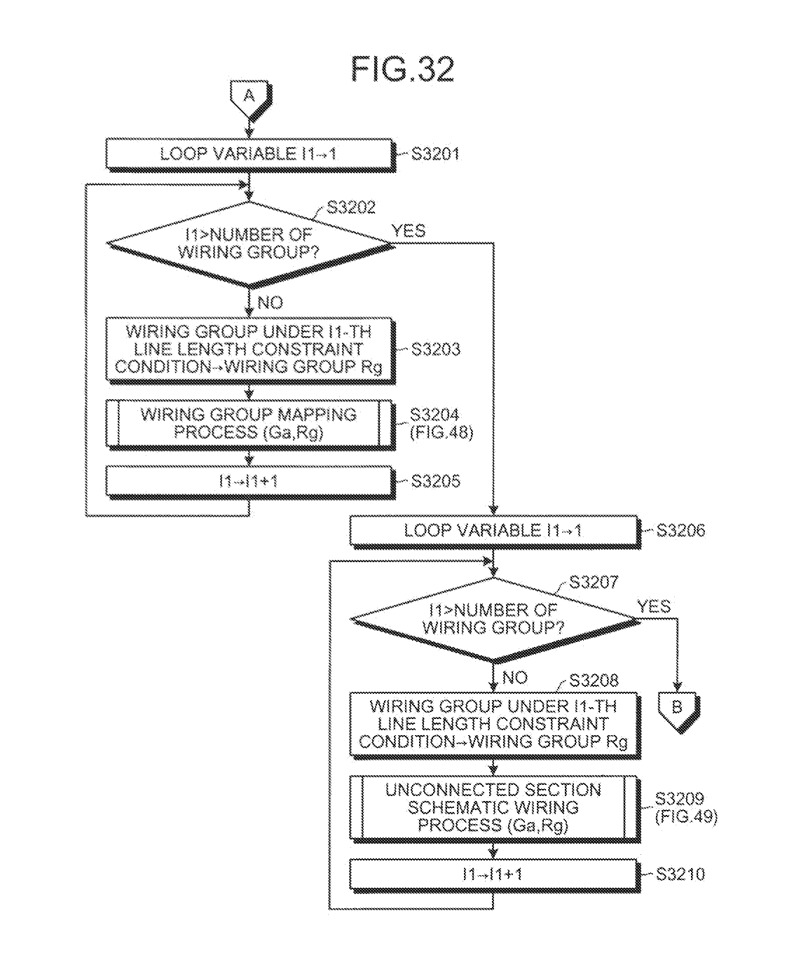

By the processing at step S3104 and subsequent steps as well as by the processing at steps S3201 to S3210 of FIG. 32, information of wiring pattern elements is reflected on the meshed lattices of the lattice management table Ga. Specifically, to realize the second display example, an obstacle mapping process is carried out first (step S3104). In the obstacle mapping process (step S3104), which will be described in detail later, an obstacle is mapped onto the lattice management table Ga.

To realize the fifth display example, steps S3105 to S3109 are then carried out. Specifically, a loop variable I1 is set to 1 (step S3105), and whether the loop variable I1 exceeds the number of wiring groups is determined (step S3106). The number of wiring groups is equivalent to the number of line length constraint conditions, thus equal to the number of records of the line length constraint condition table of FIG. 20.

When the loop variable I1 is equal to or less than the number of wiring groups (step S3106: NO), a wiring group under the I1-th line length constraint condition is set as a wiring group Rg (step S3107). Specifically, a group of wiring paths identified by wiring path numbers listed on the wiring path number list in the record for the I1-th wiring group in the line length constraint condition table 2000 are set as the wiring group Rg.

A wiring route schematic wiring process is then carried out (step S3108). In the wiring route schematic wiring process (step S3108), which will be described in detail later, the lattice management table Ga and the wiring group Rg are used as arguments.

Following the wiring route schematic wiring process (step S3108), the loop variable I1 is increased by 1 (step S3109), and the procedure returns to step S3106. Through this process, the wiring route schematic wiring process is carried out for all line length constraint conditions. When the loop variable I1 exceeds the number of wiring groups (step S3106: YES), the procedure proceeds to step S3201 of FIG. 32.

In FIG. 32, the loop variable I1 is reset to 1 following YES at step S3106 (step S3201), and whether the loop variable I1 exceeds the number of wiring groups is determined (step S3202).

When the loop variable I1 is equal to or less than the number of wiring groups (step S3202: NO), a wiring group under the I1-th line length constraint condition is set as a wiring group Rg (step S3203). Specifically, a group of wiring paths identified by wiring path numbers listed on the wiring path number list in the record for the I1-th wiring group in the line length constraint condition table 2000 are set as the wiring group Rg.

A wiring group mapping process is then carried out (step S3204). In the wiring group mapping process (step S3204), which will be described in detail later, the lattice management table Ga and the wiring group Rg are used as arguments.

Following the wiring group mapping process (step S3204), the loop variable I1 is increased by 1 (step S3205), and the procedure returns to step S3202. Through this process, the wiring group mapping process is carried out for all line length constraint conditions. When the loop variable I1 exceeds the number of wiring groups (step S3202: YES), the procedure proceeds to step S3206.

To realize the fourth display example, the loop variable I1 is reset to 1 (step S3206), and whether the loop variable I1 exceeds the number of wiring groups is determined (step S3207).

When the loop variable I1 is equal to or less than the number of wiring groups (step S3207: NO), a wiring group under the I1-th line length constraint condition is set as the wiring group Rg (step S3208). Specifically, a group of wiring paths identified by wiring path numbers listed in the wiring path number list in the record for the I1-th wiring group on the line length constraint condition table 2000 are set as the wiring group Rg.

An unconnected section schematic wiring process is then carried out (step S3209). In the unconnected section schematic wiring process (step S3209), which will be described in detail later, the lattice management table Ga and the wiring group Rg are used as arguments.

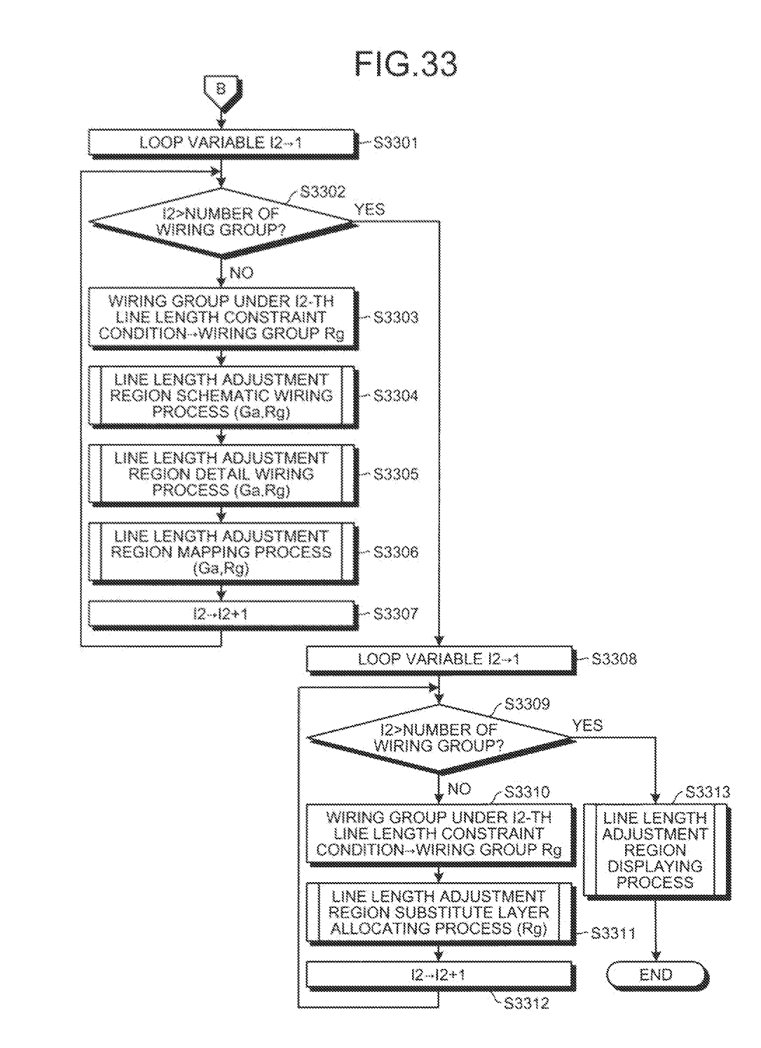

Following the unconnected section schematic wiring process (step S3209), the loop variable I1 is increased by 1 (step S3210), and the procedure returns to step S3207. Through this process, the unconnected section schematic wiring process is carried out for all line length constraint conditions. When the loop variable I1 exceeds the number of wiring groups (step S3207: YES), the procedure proceeds to step S3301 of FIG. 33.

Subsequently, to realize the sixth display example, the schematic shape of a line length adjustment region is determined and a detailed region is further determined at steps S3301 to S3307.

In FIG. 33, a loop variable I2 is set to 1 (step S3301), and whether the loop variable I2 exceeds the number of wiring groups is determined (step S3302). When the loop variable I2 is equal to or less than the number of wiring groups (step S3302: NO), a wiring group under the I2-th line length constraint condition is determined to be the wiring group Rg (step S3303). Specifically, a group of wiring paths identified by wiring path numbers listed in the wiring path number list in the record for the I2-th wiring group on the line length constraint condition table 2000 are set as the wiring group Rg.

A line length adjustment region schematic wiring process (step S3304), a line length adjustment region detail wiring process (step S3305), and a line length adjustment region mapping process (step S3306) are then carried out. In each of the line length adjustment region schematic wiring process (step S3304), the line length adjustment region detail wiring process (step S3305), and the line length adjustment region mapping process (step S3306), which will be described in detail later, the lattice management table Ga and the wiring group Rg are used as arguments.

Following the line length adjustment region mapping process (step S3306), the loop variable I2 is increased by 1 (step S3307), and the procedure returns to step S3302. In this manner, the schematic wiring process, detail wiring process, and mapping process on the line length adjustment region are carried out for all line length constraint conditions. When the loop variable I2 exceeds the number of wiring groups (step S3302: YES), the procedure proceeds to step S3308.

Subsequently, to realize the eighth display example, an insufficiency of the line length adjustment region is allocated to a substitute layer. Specifically, the loop variable I2 is reset to 1 (step S3308), and whether the loop variable I2 exceeds the number of wiring groups is determined (step S3309).

When the loop variable I2 is equal to or less than the number of wiring groups (step S3309: NO), a wiring group under the I2-th line length constraint condition is determined to be the wiring group Rg (step S3310). Specifically, a group of wiring paths identified by wiring path numbers listed in the wiring path number list in the record for the I2-th wiring group on the line length constraint condition table 2000 are set as the wiring group Rg.

A line length adjustment region substitute layer allocating process is then carried out (step S3311). In the line length adjustment region substitute layer allocating process (step S3311), which will be described in detail later, the wiring group Rg is used an argument.

Following the line length adjustment region substitute layer allocating process (step S3311), the loop variable I2 is increased by 1 (step S3312), and the procedure returns to step S3309. In this manner, the line length adjustment region substitute layer allocating process is carried out for all line length constraint conditions. When the loop variable I2 exceeds the number of wiring groups (step S3309: YES), a line length adjustment region displaying process is carried out (step S3313). In the line length adjustment region displaying process (step S3313), which will be described in detail later, the line length adjustment region is displayed.

In the lattice management table generating process, the diagrammatic shape S and the unit size U are used as arguments and the lattice management table G is used as a return value.

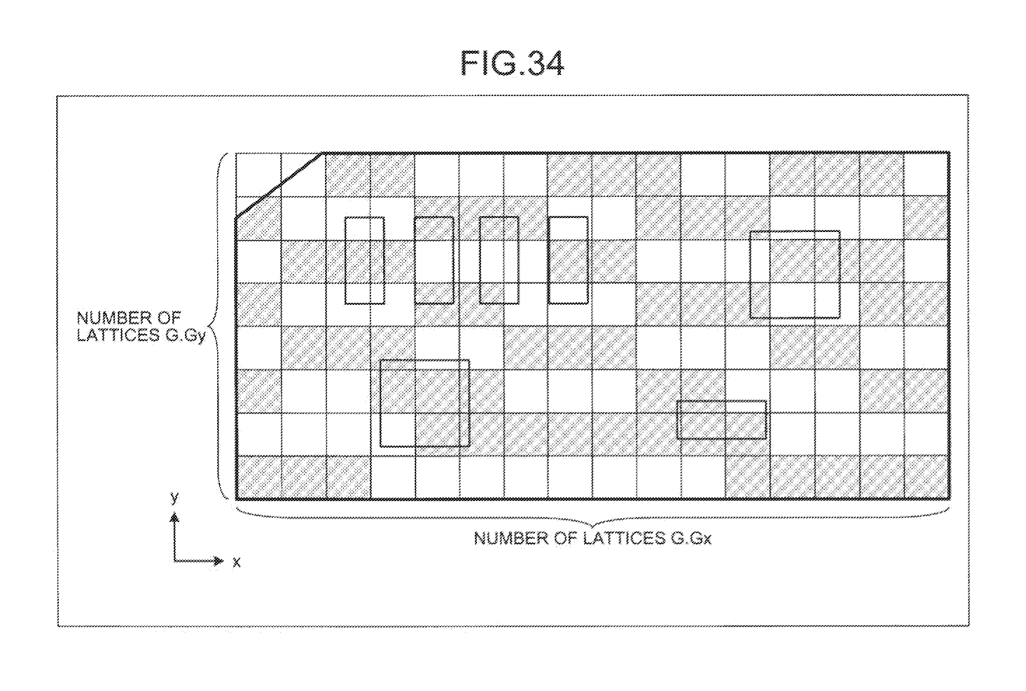

FIG. 34 is an explanatory diagram of an example of the lattice management table. When the lattice management table is used at step S3103, the diagrammatic shape S=Bd, the unit size U=Ua, and the lattice management table G=Ga are set.

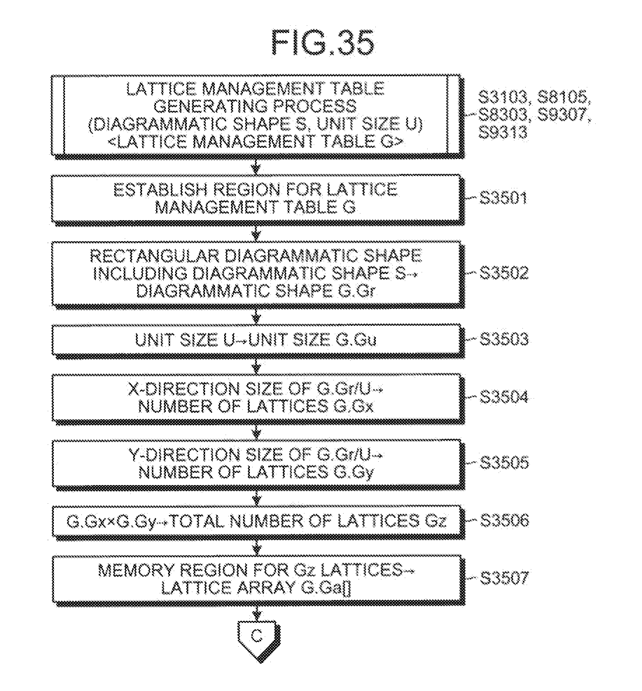

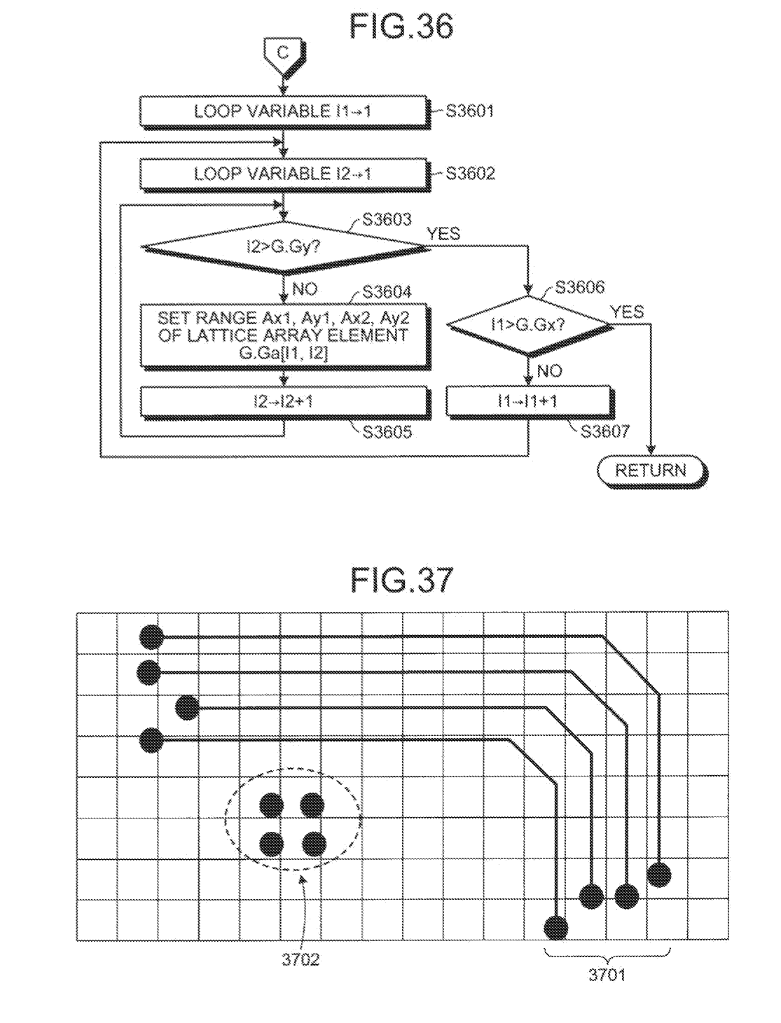

FIGS. 35 and 36 are flowcharts detailing a procedure of the lattice management table generating process. In FIG. 35, a region for the lattice management table G is established (step S3501), and a rectangular diagrammatic shape including the diagrammatic shape S is set as a diagrammatic shape G.Gr (step S3502). The unit size U is set as a unit size G.Gu (step S3503), and the number of lattices G.Gx in the x direction is calculated (step S3504). Specifically, the length of the diagrammatic shape G.Gr in the x direction divided by the unit size G.Gu gives the number of lattices G.Gx in the x direction.

In the same manner, the number of lattices G.Gy in the y direction perpendicular to the x direction is calculated (step S3505). Specifically, the length of the diagrammatic shape G.Gr in the y direction divided by the unit size G.Gu gives the number of lattices G.Gy in the y direction. Subsequently, the total number of lattices Gz (=G.Gx×G.Gy) is calculated (step S3506), and a memory region for Gz lattices is set as a lattice array G.Ga[ ](step S3507), after which the procedure proceeds to step S3601 of FIG. 36.

Subsequently, in FIG. 36, the loop variable I1 is set to 1 (step S3601), the loop variable I2 is also set to 1 (step S3602), and whether I2>G.Gy is satisfied is determined (step S3603). If I2>G.Gy is not satisfied (step S3603: NO), the range Ax1, Ay1, Ax2, Ay2 of a lattice array element G.Ga[I1, I2] is set (step S3604). The lattice array element G.Ga[I1, I2] is a lattice represented by apexes (Ax1, Ay1) and (Ax2, Ay2) that are diagonal to each other.

Subsequently, the loop variable I2 is increased by 1 (step S3605), and the procedure returns to step S3603. If I2>G.Gy is satisfied at step S3603 (step S3603: YES), whether I1>G.Gx is satisfied is determined (step S3606). If I1>G.Gx is not satisfied (step S3606: NO), the loop variable I1 is increased by 1 (step S3607), and the procedure returns to step S3602, at which the loop variable I2 is set to 1.

If I1>G.Gx is satisfied (step S3606: YES), every lattice array element G.Ga[I1, I2] is specified, which gives the lattice management table G as a return value. Hence the lattice management table G as a structure is built.

In the obstacle mapping process, obstacle mapping is carried out on the lattice management table G.

FIG. 37 is an explanatory diagram of an example of the lattice management table that results after completion of obstacle mapping. When the lattice management table is used at step S3104, the lattice management table G=Ga is set. Wiring pattern elements (line element and via-hole element) not subjected to calculation on a line length adjustment region are mapped onto the lattice management table G. In FIG. 37, 3701 denotes a wiring pattern element subjected to calculation on the line length adjustment region, and 3702 denotes a wiring pattern element not subjected to the calculation. In this case, the wiring pattern element 3702 is mapped as an obstacle onto the lattice management table G.

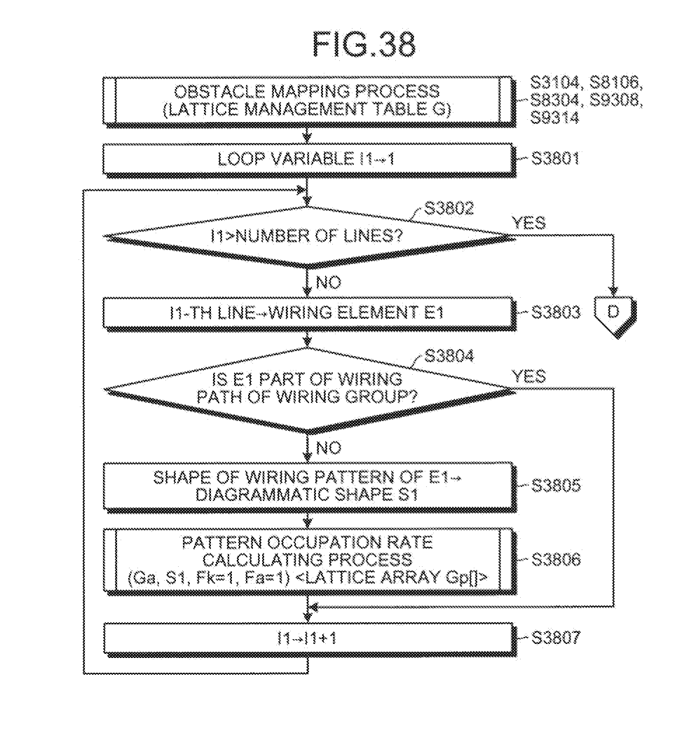

FIGS. 38 to 40 are flowcharts detailing a procedure of the obstacle mapping process. A mapping process of mapping a line as an obstacle, a mapping process of mapping a via-hole as an obstacle, and a mapping process of mapping a component pin as an obstacle are described in FIGS. 38, 39, and 40, respectively.

In FIG. 38, the loop variable I1 is set to 1 (step S3801), and whether the loop variable I1 exceeds the number of lines is determined (step S3802). The number of lines is the total number of lines entered in the line table 1900 of FIG. 19.

If the loop variable I1 does not exceed the number of lines (step S3802: NO), the I1-th line is set as a wiring element E1 (step S3803), and whether the wiring element E1 is part of a wiring path in a wiring group is determined (step S3804). Specifically, whether the line as the wiring element E1 (line segment connecting From-To coordinate values) is included in a wiring path identified by the wiring path number list on the line length constraint condition table 2000 is determined.

More specifically, because the wiring path is identified by referring to the wiring path table 2100 of FIG. 21 to check the wiring connection order element list, coordinate values for a component pin, via-hole, etc., in the wiring connection order element list are acquired by referring to the component pin table 1700 of FIG. 17 and the via-hole table 1800 of FIG. 18, and the acquired coordinate values are connected to identify a line segment coinciding with the wiring path. Hence, whether the line as the wiring element E1 is located on this line segment as the wiring path is determined.

If the wiring element E1 is part of the wiring path in the wiring group (step S3804: YES), the wiring element E1 is not an obstacle, in which case the procedure proceeds to step S3807. If the wiring element E1 is not part of the wiring path (step S3804: NO), the wiring element E1 is an obstacle, in which case the shape of a wiring pattern of the wiring element E1 is set as a diagrammatic shape S1 (step S3805). Specifically, the line width of the line as the wiring element E1 is acquired by referring to the line table 1900 of FIG. 19, and the line width is reflected on the line to acquire the shape of the wiring pattern of the wiring element E1. This acquired shape is set as the diagrammatic shape S1.

A pattern occupation rate calculating process is then carried out (step S3806). In the pattern occupation rate calculating process (step S3806), which will be described in detail later, the lattice management table G=Ga, the diagrammatic shape S=S1, a figure type flag Fk=1, and an addition flag Fa=1 are set. The figure type flag Fk and the addition flag Fa will be described later. With this setting, the lattice array Gp[ ] is acquired.

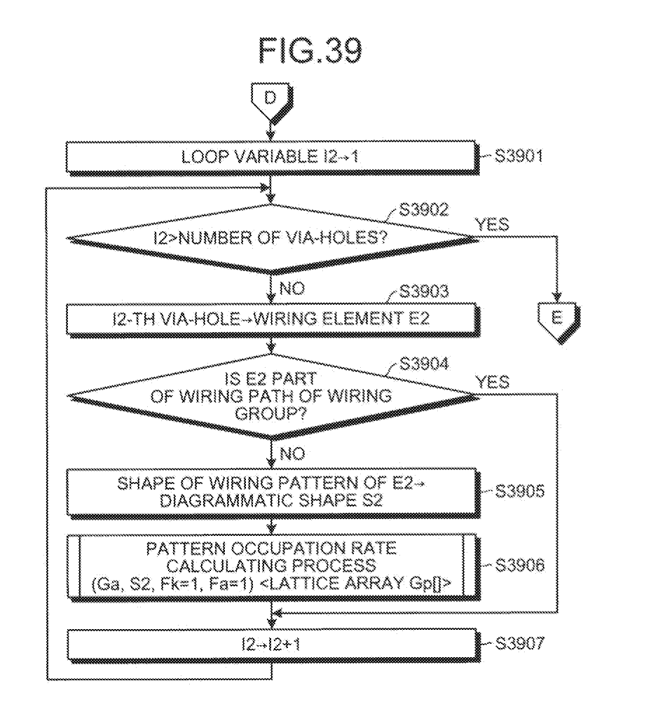

After a pattern occupation rate is calculated on the diagrammatic shape S1, the loop variable I1 is increased by 1 (step S3807), and the procedure returns to step S3802. If the loop variable I1 exceeds the number of lines at step S3802 (step S3802: YES), the procedure proceeds to step S3901 of FIG. 39.

In FIG. 39, the loop variable I2 is set to 1 (step S3901), and whether the loop variable I2 has exceeded the number of via holes is determined (step S3902). The number of lines is the total number of via holes entered in the via hole table 1800 of FIG. 18.

If the loop variable I2 has not exceeded the number of via holes (step S3902: NO), the I2-th via hole is set as a wiring element E2 (step S3903), and whether the wiring element E2 is part of a wiring path in a wiring group is determined (step S3904). Specifically, whether the coordinate values of the via hole as the wiring element E2 is included in a wiring path identified by the wiring path number list on the line length constraint condition table 2000 is determined.

More specifically, because the wiring path is identified by referring to the wiring path table 2100 of FIG. 21 to check the wiring connection order element list, coordinate values for a component pin, via-hole, etc., in the wiring connection order element list are acquired by referring to the component pin table 1700 of FIG. 17 and the via-hole table 1800 of FIG. 18, and the acquired coordinate values are connected to identify a line segment coinciding with the wiring path. Hence, whether the via hole as the wiring element E2 is located on this line segment as the wiring path is determined.

If the wiring element E2 is part of the wiring path in the wiring group (step S3904: YES), the wiring element E2 is not an obstacle, in which case the procedure proceeds to step S3907. If the wiring element E2 is not part of the wiring path (step S3904: NO), the wiring element E2 is an obstacle, in which case the shape of a wiring pattern of the wiring element E2 is set as a diagrammatic shape S2 (step S3905).

Specifically, by referring to the via-hole table 1800 of FIG. 18, a record for the land shape of the via-hole in the land shape table 1600 is identified based on the land shape number of the via-hole as the wiring element E2. This specified land shape is reflected in the form of the coordinate position of the via-hole as the wiring element E2 to acquire the shape of the wiring pattern of the wiring element E2. This acquired shape is set as the diagrammatic shape S2.

A pattern occupation rate calculating process is then carried out (step S3906). In the pattern occupation rate calculating process (step S3906), which will be described in detail later, the lattice management table G=Ga, the diagrammatic shape S=S2, a figure type flag Fk=1, and an addition flag Fa=1 are set. With this setting, the lattice array Gp[ ] is acquired.

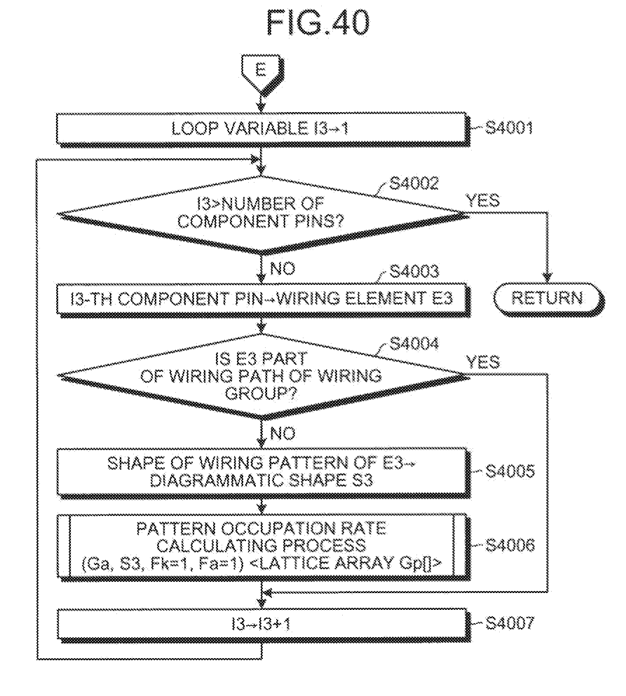

After a pattern occupation rate is calculated on the diagrammatic shape S2, the loop variable I2 is increased by 1 (step S3907), and the procedure returns to step S3902. If the loop variable I2 exceeds the number of via holes at step S3902 (step S3902: YES), the procedure proceeds to step S4001 of FIG. 40.

In FIG. 40, the loop variable I3 is set to 1 (step S4001), and whether the loop variable I3 exceeds the number of component pins is determined (step S4002). The number of component pins is the total number of component pins entered in the component pin table 1700.

If the loop variable I3 does not exceed the number of component pins (step S4002: NO), the 13-th line is set as a wiring element E3 (step S4003), and whether the wiring element E3 is part of a wiring path in a wiring group is determined (step S4004). Specifically, whether the coordinate values of the component pin as the wiring element E3 is included in a wiring path identified by the wiring path number list on the line length constraint condition table 2000 is determined.

More specifically, because the wiring path is identified by referring to the wiring path table 2100 of FIG. 21 to check the wiring connection order element list, coordinate values for a component pin, via-hole, etc., in the wiring connection order element list are acquired by referring to the component pin table 1700 of FIG. 17 and the via-hole table 1800 of FIG. 18, and the acquired coordinate values are connected to identify a line segment coinciding with the wiring path. Hence, whether the component pin as the wiring element E3 is located on this line segment as the wiring path is determined.

If the wiring element E3 is part of the wiring path in the wiring group (step S4004: YES), the wiring element E3 is not an obstacle, in which case the procedure proceeds to step S4007. If the wiring element E3 is not part of the wiring path (step S4004: NO), the wiring element E3 is an obstacle, in which case the shape of a wiring pattern of the wiring element E3 is set as a diagrammatic shape S1 (step S4005).

Specifically, by referring to the component pin table 1700 of FIG. 17, a record for the land shape of the component pin in the land shape table 1600 is identified based on the land shape number of the component pin as the wiring element E3. This specified land shape is reflected in the form of the coordinate position of the component pin as the wiring element E3 to acquire the shape of the wiring pattern of the wiring element E3. This acquired shape is set as the diagrammatic shape S3.

A pattern occupation rate calculating process is then carried out (step S4006). In the pattern occupation rate calculating process (step S4006), which will be described in detail later, the lattice management table G=Ga, the diagrammatic shape S=S3, a figure type flag Fk=1, and an addition flag Fa=1 are set. With this setting, the lattice array Gp[ ] is acquired.

After a pattern occupation rate is calculated on the diagrammatic shape S3, the loop variable I3 is increased by 1 (step S4007), and the procedure returns to step S4002. If the loop variable I3 exceeds the number of via holes at step S4002 (step S4002: YES), the obstacle mapping process ends.

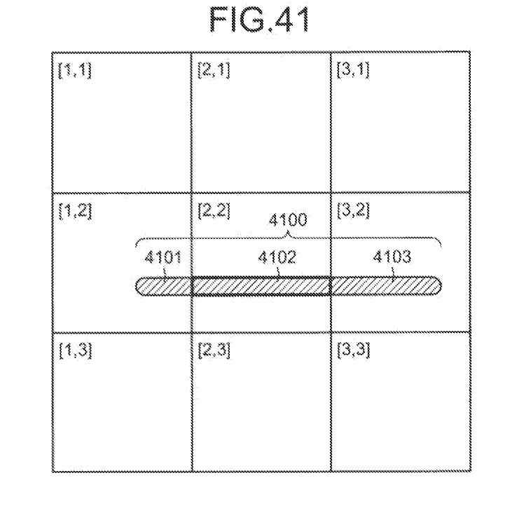

FIG. 41 is an explanatory diagram of a specific example of the pattern occupation rate calculating process. In FIG. 41, lattice array elements G.Ga[x, y] in 3×3 matrix arrangement are used for a simpler explanation. Each of the lattice array elements G.Ga[x, y] is abbreviated to [x, Y].

For example, for a FIG. 4100 composed of FIGS. 4101 to 4103, when the area of the FIG. 4101 in a lattice array element G.Ga[1, 2] is Sa and the area of one lattice is Sr, the pattern occupation rate Ar of the lattice array element G.Ga[1, 2] is obtained by the equation: Ar=(Sa/Sr)×100 [%]. In the same manner, the pattern occupation rate Ar of each of lattice array elements G.Ga[2, 2] and G.Ga[3, 2] is calculated. Because other lattice array elements G.Ga[1, 1] to G.Ga[3, 1] and G.Ga[1, 3] to G.Ga[3, 3] have no figure, Ar=0 results at these lattice array elements. The lattice array Gp[ ]={[1, 2], [2, 2], [3, 2]} representing a combination of the lattice array elements G.Ga[1, 2] to G.Ga[3, 2] satisfying Ar≠0 is returned as a return value.

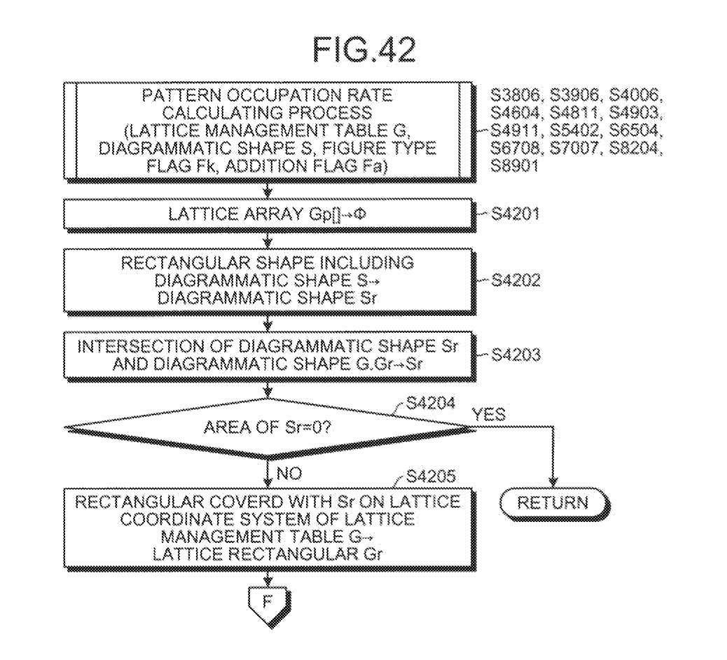

FIGS. 42 to 44 are flowcharts detailing a procedure of the pattern occupation rate calculating process. In the pattern occupation rate calculating process, the lattice management table G, the diagrammatic shape S, the figure type flag Fk, and the addition flag Fa are used as arguments, and the lattice array Gp[ ] is finally obtained as a return value.

The diagrammatic shape S=S1 is set in the pattern occupation rate calculating process at step S3806, the diagrammatic shape S=S2 is set in the pattern occupation rate calculating process at step S3906, and the diagrammatic shape S=S3 is set in the pattern occupation rate calculating process at step S4006. In the pattern occupation rate calculating processes at steps S3806, S3906, and S4006, the lattice management table G is the lattice management table Ga generated by the lattice management table generating process (step S3103).

The figure type flag Fk is a flag for determining whether a given diagrammatic shape element is an obstacle or a wiring path. If Fk=1 is satisfied, the diagrammatic shape element is an obstacle. If Fk=2 is satisfied, the diagrammatic shape element is a wiring path. If Fk=0 is satisfied, no determination is made.

The addition flag Fa is a flag for determining whether or not to add a rate of inclusion of a given diagrammatic shape. The rate of inclusion of the diagrammatic shape is not added if Fa=0 is satisfied, and is added if Fa=1 is satisfied. In the pattern occupation rate calculating processes at steps S3806, S3906, and S4006, both flags are set to satisfy Fk=1 and Fa=1.

A combination of the figure type flag Fk and the addition flag Fa may satisfy {Fk=0, Fa=0}. In this case, only the lattices overlapping the diagrammatic shape S given as the argument are determined to return the lattices as the lattice array Gp[ ].

In FIG. 42, the lattice array Gp[ ]=φ (empty set) is set (step S4201), and a rectangular shape including the diagrammatic shape S is set as a diagrammatic shape Sr (step S4202). For example, in the pattern occupation rate calculating process (step S3806), a rectangular shape including the diagrammatic shape S1 that is the shape of the wiring pattern of the wiring element E1 is set as the diagrammatic shape Sr.

An intersection of the diagrammatic shape Sr and the diagrammatic shape G.Gr is then set as the diagrammatic shape Sr (step S4203). The diagrammatic shape G.Gr is the rectangular shape including the diagrammatic shape S at step S3502 of the flowchart of the lattice management table generating process (step S3103). Because the diagrammatic shape S at step S3502 is the diagrammatic shape Bd (diagrammatic shape of the substrate), the diagrammatic shape G.Gr at step S4203 is the rectangular shape including the diagrammatic shape Bd of the substrate.

Whether the area of the diagrammatic shape Sr as the intersection is zero is determined (step S4204). If the area is not zero (step S4204: NO), a rectangle covered with the diagrammatic shape Sr on the lattice coordinate system of the lattice management table G (lattice management table Ga for the diagrammatic shape Bd of the substrate at steps S3806, S3906, and S4006) is set as a lattice rectangular Gr (step S4205), after which the procedure proceeds to step S4301.

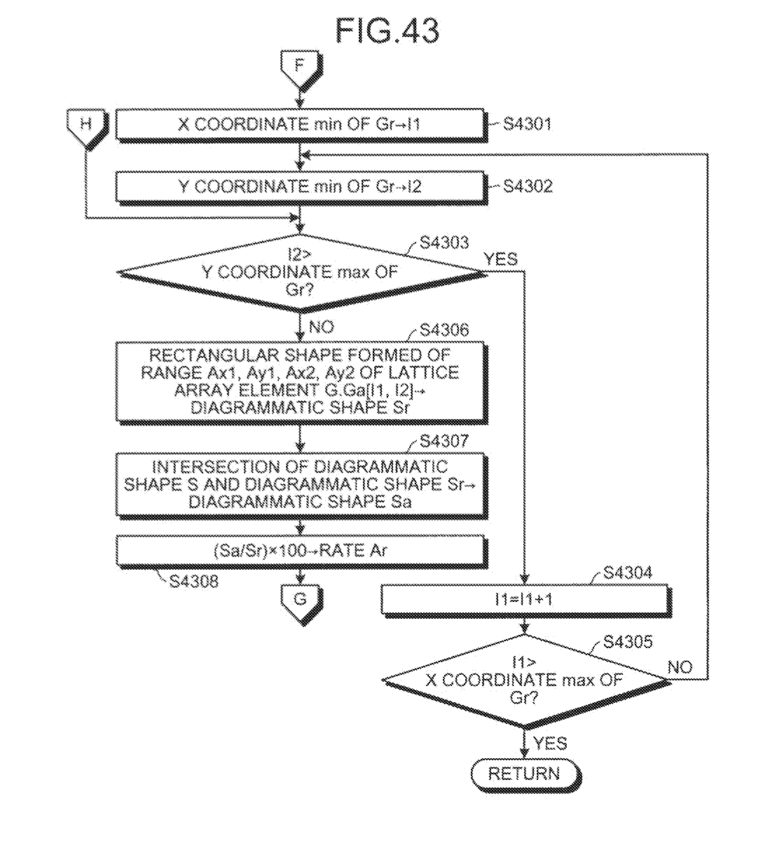

In FIG. 43, the loop variable I1 is set to the minimum of the X coordinate (X coordinate min) of the lattice rectangular Gr set at step S4205 (step S4301), and the loop variable I2 is set to the minimum of the Y coordinate (Y coordinate min) of the lattice rectangular Gr set at step S4205 (step S4302).

Whether the variable I2 exceeds the maximum of the Y coordinate (Y coordinate max) of the lattice rectangular Gr is then determined (step S4303). If the variable I2 exceeds the maximum (step S4303: YES), the variable I1 is increased by 1 (step S4304), and whether the variable I1 exceeds the maximum of the X coordinate (X coordinate max) of the lattice rectangular Gr is determined (step S4305). If the variable I1 does not exceed the maximum (step S4305: NO), the procedure returns to step S4302, at which the variable I2 is set again to the minimum of the Y coordinate of the lattice rectangular Gr.

If the variable I2 does not exceed the maximum of the Y coordinate of the lattice rectangular Gr at step S4303 (step S4303: NO), a rectangular shape formed by the range Ax1, Ay1, Ax2, Ay2 of the lattice array element G.Ga[I1, I2] (i.e., lattice) is set as the diagrammatic shape Sr (step S4306).

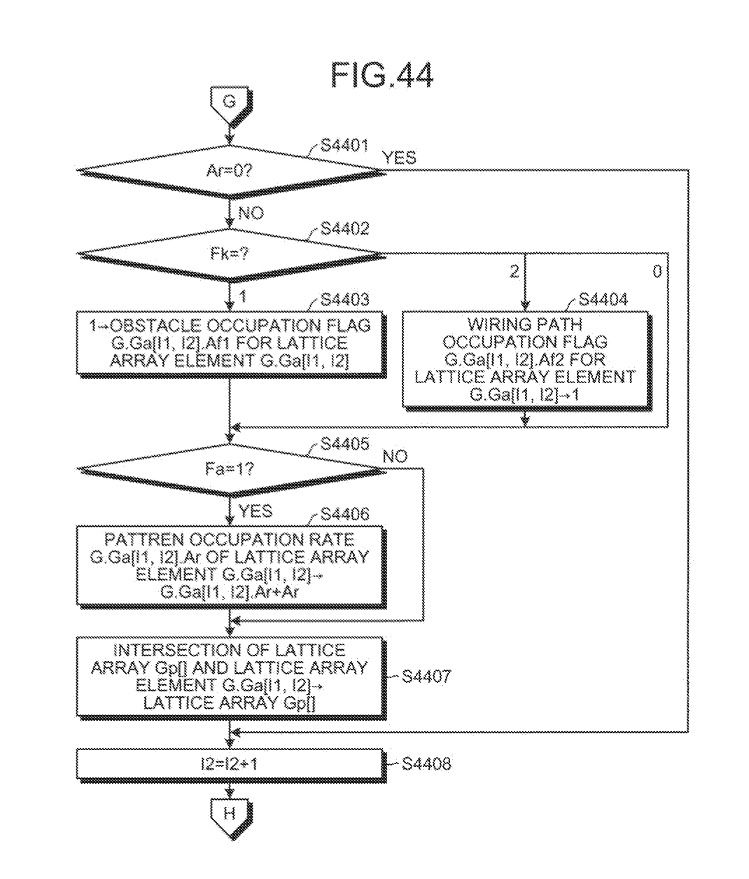

The intersection of the diagrammatic shape S and the diagrammatic shape Sr acquired at step S4306 is then set as a diagrammatic shape Sa (step S4307). In FIG. 41, for example, the latticed rectangular shape of the lattice array element G.Ga[2, 2] is equivalent to the diagrammatic shape Sr, and the FIG. 4100 is equivalent to the diagrammatic shape S. Hence, the intersection of the diagrammatic shape S and the diagrammatic shape Sr is equivalent to the diagrammatic shape 4102. Subsequently, the rate Ar is calculated (step S4308), and the procedure proceeds to step S4401 of FIG. 44.

In FIG. 44, whether Ar=0 is satisfied is determined (step S4401). If Ar=0 is satisfied (step S4401: YES), the procedure proceeds to step S4408. If Ar=0 is not satisfied (step S4401: NO), the value of the figure type flag Fk is determined (step S4402). If Fk=0 is satisfied (step S4402: 0), the procedure proceeds to step S4405.

If Fk=1 is satisfied (step S4402: 1), an obstacle occupation flag G.Ga[I1, I2].Af1 for the lattice array element G.Ga[I1, I2] is set to 1 (step S4403), and the procedure proceeds to step S4405. If Fk=2 is satisfied (step S4402: 2), a wiring path occupation flag G.Ga[I1, I2].Af2 for the lattice array element G.Ga[I1, I2] is set to 1 (step S4404), and the procedure proceeds to step S4405.

Following this, whether the addition flag Fa=1 is satisfied is determined (step S4405). If Fa=1 is not satisfied (step S4405: NO), the procedure proceeds to step S4407. If Fa=1 is satisfied (step S4405: YES), the rate Ar is added to the pattern occupation rate G.Ga[I1, I2].Ar (initial value 0) of the lattice array element G.Ga[I1, I2] (step S4406) to update the pattern occupation rate G.Ga[I1, I2].Ar.

An intersection of the lattice array Gp[ ] and the lattice array element G.Ga[I1, I2] is then set as a new lattice array Gp[ ] (step S4407), and the loop variable I2 is increased by 1 (step S4408), after which the procedure returns to step S4303 of FIG. 43.

If the area of the diagrammatic shape Sr as the intersection is zero at step S4204 of FIG. 42 (step S4204: YES), the lattice array Gp[ ] is returned as the return value, terminating the pattern occupation rate calculating process. Likewise, if the loop variable I1 exceeds the maximum of the X coordinate of the lattice rectangle Gr at step S4305 of FIG. 43 (step S4305: YES), the lattice array Gp[ ] is returned as the return value, terminating the pattern occupation rate calculating process.

The wiring route schematic wiring process will be described. The wiring route schematic wiring process is a process of identifying a wiring route in the wiring route table 2200 of FIG. 22, based on the wiring route number list for a wiring group identified for each line length constraint condition in the line length constraint condition table 2000 of FIG. 20 (group of wiring paths identified by the wiring path number list), and of carrying out schematic wiring on the lattice management tale Ga for the diagrammatic shape Bd of the substrate.

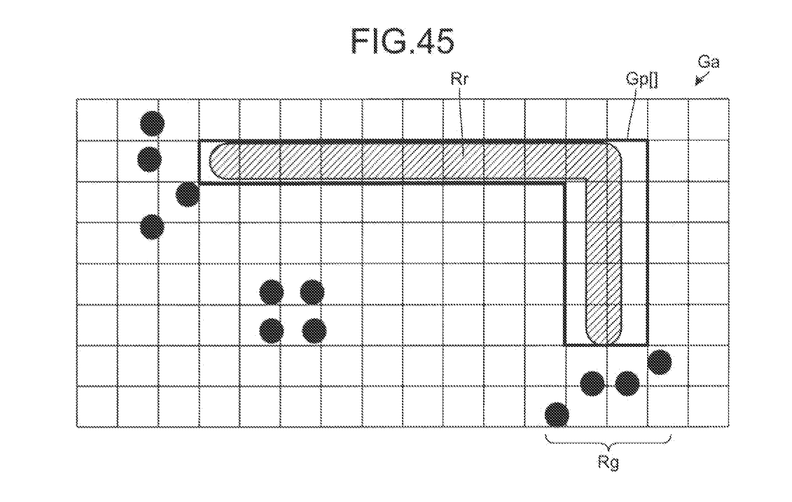

FIG. 45 is an explanatory diagram of a specific example of the wiring route schematic wiring process. A wiring route Rr is mapped on the lattice management table Ga. The lattice array Gp[ ] is a set of lattices including the wiring route Rr.

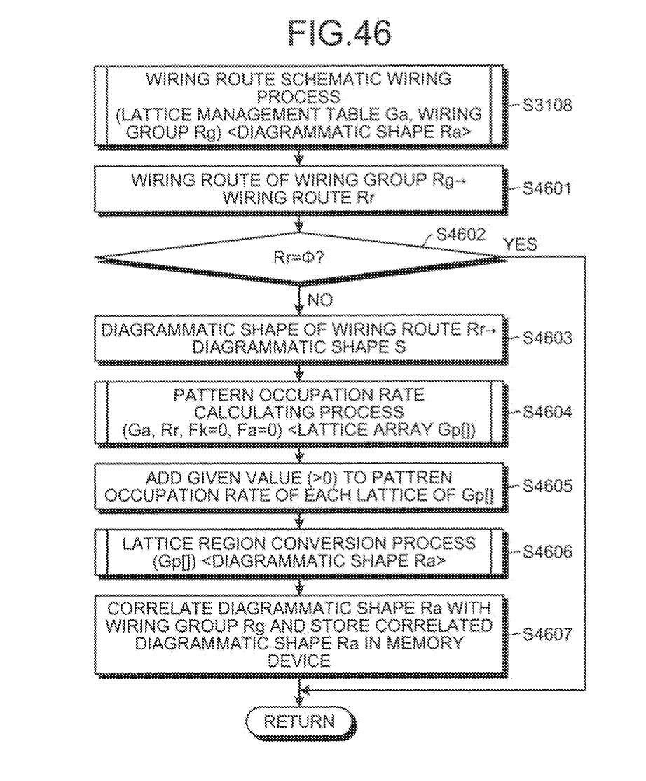

FIG. 46 is a flowchart detailing a procedure of the wiring route schematic wiring process (step S3108). The wiring route schematic wiring process (step S3108) is carried out as a function that uses the lattice management table Ga for the diagrammatic shape Bd of the substrate and the wiring group Rg as arguments and that returns the diagrammatic shape Ra representing schematic wiring of the wiring group Rg as a return value.

The wiring route of the wiring group Rg selected at step S3107 of FIG. 31 is set as the wiring route Rr (step S4601). Specifically, a wiring route number in the record corresponding to the wiring group Rg is read out from the line length constraint condition table 2000 of FIG. 20 to point out the wiring route number on the wiring route table 2200 of FIG. 22. The corresponding wiring route is thus read out to be set as the wiring route Rr.

Whether the wiring route Rr=φ (empty set) is satisfied is then determined (step S4602). If the wiring route Rr is an empty set (step S4602: YES), the wiring route Rr is not present, which makes schematic wiring impossible, thereby terminating the wiring route schematic wiring process (step S3108).

If Rr=φ is not satisfied (step S4602: NO), the diagrammatic shape of the wiring route Rr is set as the diagrammatic shape S that is an argument in the pattern occupation rate calculating process at step S4604 (step S4603). The pattern occupation rate calculating process is then carried out (step S4604).

In the pattern occupation rate calculating process (step S4604), the lattice management table G=Ga, the diagrammatic shape S=Rr, the figure type flag Fk=0, and the addition flag Fa=0 are set, and the process is carried out in accordance with the procedure of FIG. 42. Hence, in the pattern occupation rate calculating process (step S4604), the lattice array Gp[ ] that is a group of lattices overlapping the wiring route Rr given as the argument is returned.

A given value (>0) is added to the pattern occupation rate of each lattice in the lattice array Gp[ ] (step S4605). Because the addition flag Fa is set to 0 in the pattern occupation rate calculating process (step S4604), the pattern occupation rate G.Ga[I1, I2].Ar of the lattice array element G.Ga[I1, I2] included in the lattice array Gp[ ] remains 0. To provide each lattice in the lattice array Gp[ ] with schematic wiring, therefore, the given value is added to the pattern occupation rate G.Ga[I1, I2].Ar of the lattice array element G.Ga[I1, I2].

Subsequently, a lattice region conversion process is carried out (step S4606). The lattice region conversion process (step S4606), which will be described later, is carried out as a function that uses the lattice array Gp[ ] as an argument and that returns the diagrammatic shape Ra representing schematic wiring of the wiring group Rg as a return value.

The diagrammatic shape Ra acquired by the lattice region conversion process (step S4606) is then correlated with the wiring group Rg and is stored in the memory device (step S4607). Specifically, when a schematic region number in the schematic region table 2400 is not set in the schematic region number list in the line length adjustment table 2300 that corresponds to the wiring group Rg, (1) a new record is added to the schematic region table 2400 to set the diagrammatic shape Ra in the schematic shape information on the schematic region in the new record, and (2) the schematic region number set in the new record added at (1) is added to the schematic region number list in the line length adjustment table 2300 that corresponds to the wiring group Rg.

If a schematic region number in the schematic region table 2400 is set in the schematic region number list in the line length adjustment table 2300 that corresponds to the wiring group Rg, (3) the schematic shape information in the record in the schematic region table 2400 that is pointed to by the schematic region number in the schematic region number list in the line length adjustment table 2300 that corresponds to the wiring group Rg is updated with the diagrammatic shape Ra. The wiring route schematic wiring process is then ended.

A wiring group mapping process will be described. The wiring group mapping process is carried out as a function of sequentially mapping wiring paths in a wiring group onto the lattice management table G (=Ga).

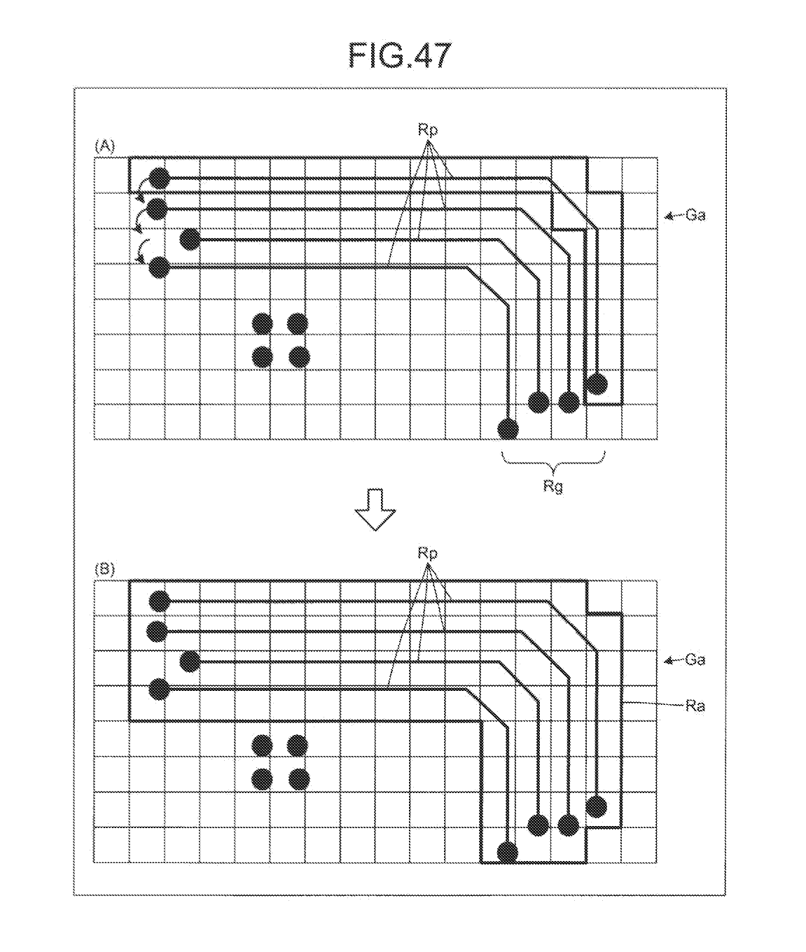

FIG. 47 is an explanatory diagram of a specific example of the wiring group mapping process. In (A) of FIG. 47, wiring paths Rp making up the wiring group Rg are mapped sequentially onto the lattice management table Ga. In (B) of FIG. 47, the diagrammatic shape Ra including all mapped wiring paths Rp is acquired.

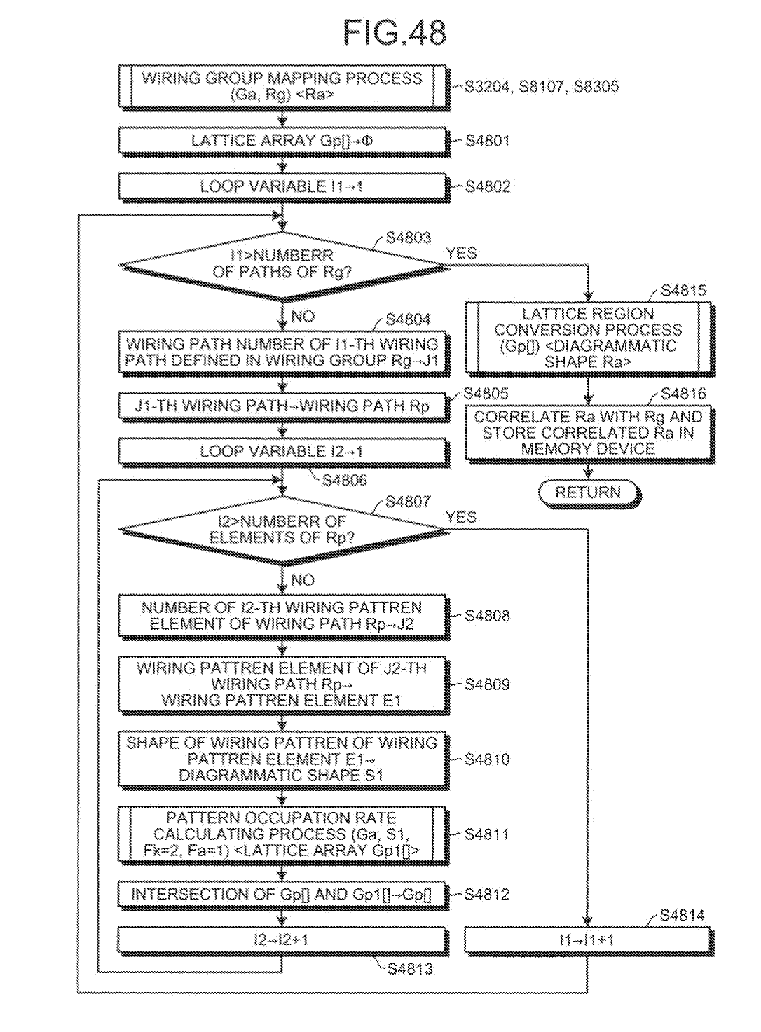

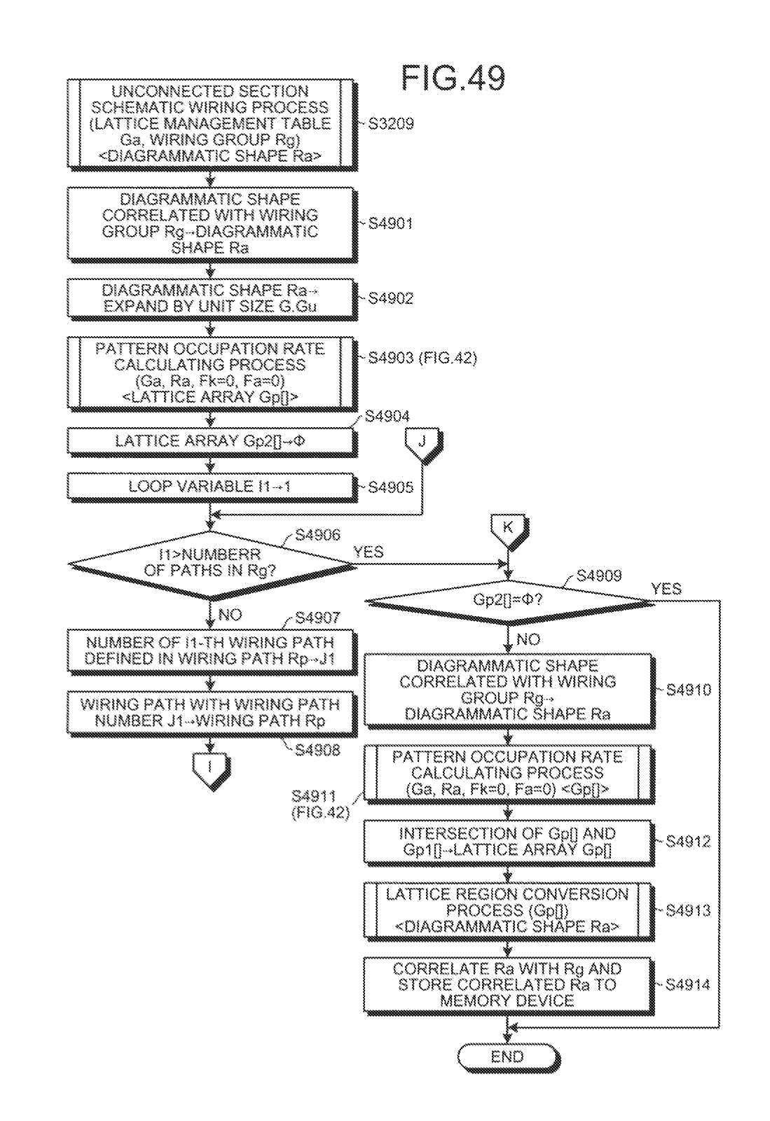

FIG. 48 is a flowchart detailing a procedure of the wiring group mapping process. In the wiring group mapping process, the lattice management table G and the wiring group Rg are used as arguments and the diagrammatic shape Ra is returned as a return value. In the wiring group mapping process of FIG. 32 (step S3204), the lattice management table G=Ga is set.

The lattice array Gp[ ]=φ (empty set) is set (step S4801), and the loop variable I1=1 is set (step S4802). Whether the loop variable I1 exceeds the number of wiring paths making up the wiring group Rg is then determined (step S4803). If the loop variable I1 does not exceed the number of wiring paths (step S4803: NO), the wiring path number of the I1-th wiring path defined in the wiring group Rg is set to J1 (step S4804), and the J1-th wiring path is set as the wiring path Rp (step S4805). Specifically, J1 represents the J1-th position in decreasing order from the top (left end) of the wiring path number list in a record of a line length constraint condition managed in the line length constraint condition table 2000.

The loop variable I2 is then set to 1 (step S4806), and whether the loop variable I2 exceeds the number of wiring pattern elements on the wiring path Rp is determined (step S4807). Wiring pattern elements are component pins and via-holes listed in the wiring connection order element list on the wiring path table 2100. The number of wiring pattern elements is the total number of the component pins and via-holes listed in the wiring connection order element list that are on the wiring path Rp.

If the loop variable I2 does not exceed the number of wiring pattern elements on the wiring path Rp (step S4807: NO), the number of the I2-th wiring pattern element on the wiring path Rp is set as J2 (step S4808), and the I2-th wiring pattern element on the wiring path Rp is set as the wiring pattern element E1 (step S4809). Specifically, J2 represents the J2-th position in decreasing order from the top (left end) of the wiring connection order element list in a record of the wiring path Rp managed in the wiring path table 2100.

The shape of a wiring pattern of the wiring pattern element E1 is then set as the diagrammatic shape S1 (step S4810). For example, when J2 represents the top position of the wiring connection order element list in the record of the wiring path Rp, the diagrammatic shape of the pattern element E1 (component pin or via-hole) as the top element is the diagrammatic shape S1. When the J2 represents the second or lower position from the top, a combination of the diagrammatic shape of a line from the (J2−1)-th wiring pattern element and the diagrammatic shape of the J2-th wiring pattern E1 (component or via-hole) is the diagrammatic shape S1. Following step S4810, the pattern occupation rate calculating process is carried out (step S4811).

In the pattern occupation rate calculating process (step S4811), the lattice management table G=Ga, the diagrammatic shape S=S1, the figure type flag Fk=2, and the addition flag Fa=1 are set, and the process is carried out in accordance with the procedure of FIG. 42. Hence, in the pattern occupation rate calculating process (step S4811), a group of lattices making up the diagrammatic shape S1 that is the shape of the wiring pattern of the wiring pattern element E1 are returned as a lattice array Gp1[ ].

An intersection of the lattice array Gp[ ] (initial value is φ) and the lattice array Gp1[ ] is determined to set the union as a new lattice array Gp[ ] (step S4812). The loop variable I2 is then increased by 1 (step S4813), and the procedure returns to step S4807.

If the loop variable I2 exceeds the number of wiring pattern elements on the wiring path Rp (step S4807: YES), the loop variable I1 is increased by 1 (step S4818), and the procedure returns to step S4803.

If the loop variable I1 exceeds the number of wiring paths making up the wiring group Rg at step S4803 (step S4803: YES), the lattice region conversion process is carried out (step S4815). In the lattice region conversion process (step S4815), the lattice array Gp[ ] is used an argument and the diagrammatic shape Ra is returned as a return value.

The diagrammatic shape Ra including all the mapped wiring paths Rp (see FIG. 47B) is correlated with the wiring group Rg and is stored in the memory device (step S4816). Specifically, when a schematic region number in the schematic region table 2400 is not set in the schematic region number list in the line length adjustment table 2300 that corresponds to the wiring group Rg, (1) a new record is added to the schematic region table 2400 to set the diagrammatic shape Ra in the schematic shape information on the schematic region in the new record, and (2) the schematic region number set in the new record added at (1) is added to the schematic region number list in the line length adjustment table 2300 that corresponds to the wiring group Rg.

If a schematic region number in the schematic region table 2400 is set in the schematic region number list in the line length adjustment table 2300 that corresponds to the wiring group Rg, (3) the schematic shape information in the record in the schematic region table 2400 that is pointed to by the schematic region number in the schematic region number list in the line length adjustment table 2300 that corresponds to the wiring group Rg is updated with the diagrammatic shape Ra. The wiring group mapping process is then ended.

The unconnected section schematic wiring process (step S3209) for realizing the fourth display example will be described. The unconnected section schematic wiring process (step S3209) is a process of determining a diagrammatic shape in the case of schematic wiring on an unconnected section, as described in the fourth display example. The unconnected section schematic wiring process (step S3209) is carried out as a function that uses the lattice management table Ga and the wiring group Rg as arguments and that returns the wiring group Rg as a return value.

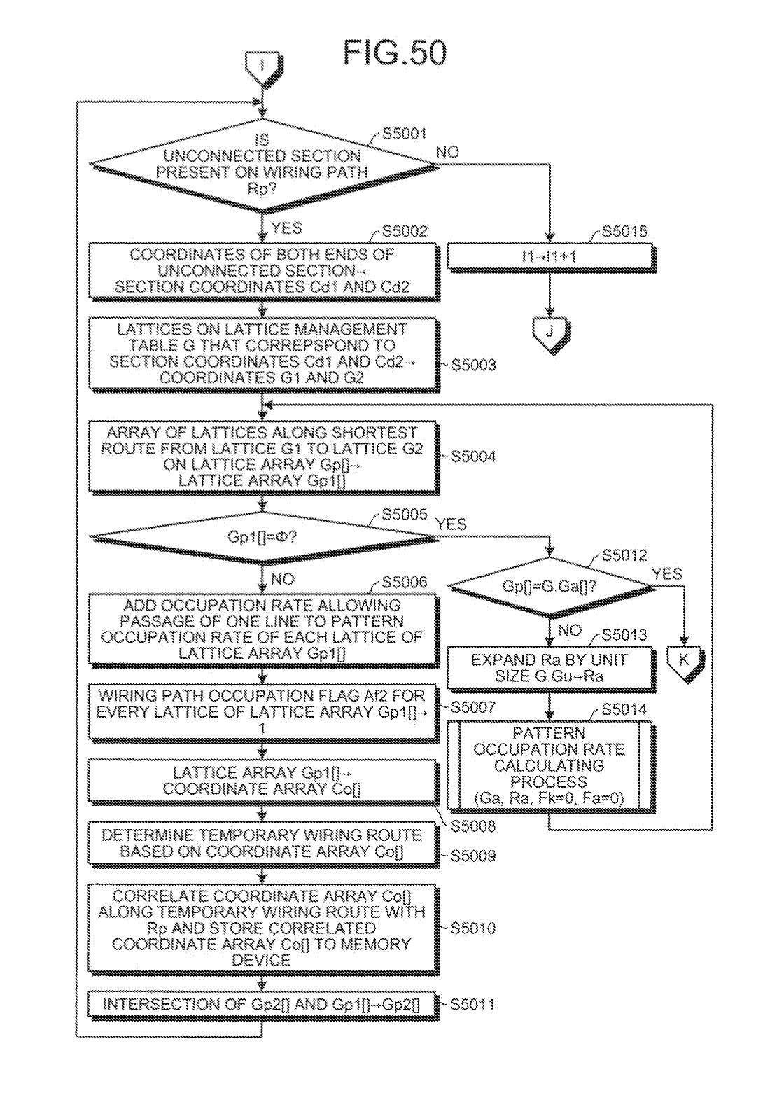

FIGS. 49 and 50 are flowcharts detailing a procedure of the unconnected section schematic wiring process (step S3209). In FIG. 49, the diagrammatic shape correlated with the wiring group Rg is set as the diagrammatic shape Ra (step S4901). The diagrammatic shape Ra is then expanded by the unit size G.Gu (step S4902). Subsequently, the pattern occupation rate calculating process of FIG. 42 is carried out (step S4903).

In the pattern occupation rate calculating process (step S4903), the lattice management table G=Ga, the diagrammatic shape S=Ra, the figure type flag Fk=0, and the addition flag Fa=0 are set, and the process is carried out in accordance with the procedure of FIG. 42. Hence, in the pattern occupation rate calculating process (step S4903), the lattice array Gp[ ] consisting of a group of lattices overlapping the diagrammatic shape Ra given as the argument is returned as a return value.

A lattice array Gp2[ ]=φ (empty set) is set (step S4904), and the loop variable I1=1 is set (step S4905). Whether the loop variable I1 exceeds the number of wiring paths making up the wiring group Rg is then determined (step S4906).

If the loop variable I1 does not exceed the number of wiring paths (step S4906: NO), the wiring path number of the I1-th wiring path defined in the wiring group Rg is set as J1 (step S4907), and the wiring path with the wiring path number J1 is set as the wiring path Rp (step S4908), after which the procedure proceeds to step S5001 of the FIG. 50.

If the loop variable I1 exceeds the number of wiring paths making up the wiring group at step S4906 (step S4906: YES), whether the lattice array Gp2[ ]=φ is satisfied is determined (step S4909). If the lattice array Gp2[ ]=φis satisfied (step S4909: YES), the diagrammatic shape Ra is not acquired. As a result, the unconnected section schematic wiring process (step S3209) is ended.

If the lattice array Gp2[ ]=φ is not satisfied (step S4909: NO), the diagrammatic shape correlated with the wiring group Rg is set as the diagrammatic shape Ra (step S4910), and the pattern occupation rate calculating process of FIG. 42 is carried out (step S4911).

In the pattern occupation rate calculating process (step S491), the lattice management table G=Ga, the diagrammatic shape S=Ra, the figure type flag Fk=0, and the addition flag Fa=0 are set, and the process is carried out in accordance with the procedure of FIG. 42. Hence, in the pattern occupation rate calculating process (step S4910), the lattice array Gp[ ] consisting of a group of lattices overlapping the diagrammatic shape Ra given as the argument is returned as a return value.

An intersection of the acquired lattice array Gp[ ] (initial value is φ) and the lattice array Gp1[ ] is determined (step S4912), and the lattice region conversion process is carried out (step S4913). In the lattice region conversion process (step S4913), the lattice array Gp[ ] is used an argument and the diagrammatic shape Ra is returned as a return value.

Subsequently, the acquired diagrammatic shape Ra is correlated with the wiring group Rg and is stored to the memory device (step S4914). Specifically, if a schematic region number in the schematic region table 2400 is not set in the schematic region number list in the line length adjustment table 2300 that corresponds to the wiring group Rg, (1) a new record is added to the schematic region table 2400 to set the diagrammatic shape Ra in the schematic shape information on the schematic region in the new record, and (2) the schematic region number set in the new record added at (1) is added to the schematic region number list in the line length adjustment table 2300 that corresponds to the wiring group Rg.

If a schematic region number in the schematic region table 2400 is set in the schematic region number list in the line length adjustment table 2300 that corresponds to the wiring group Rg, (3) the schematic shape information in the record in the schematic region table 2400 that is pointed to by the schematic region number in the schematic region number list in the line length adjustment table 2300 that corresponds to the wiring group Rg is updated with the diagrammatic shape Ra. The unconnected section schematic wiring process is then ended.

In FIG. 50, whether an unconnected section is present on the JI-th wiring path Rp is determined (step S5001). If an unconnected section is present (step S5001: YES), the coordinates of both ends of the unconnected section are set as section coordinates Cd1 and Cd2 (step S5002). The lattices on the lattice management table G (=Ga) that correspond to the section coordinates Cd1 and Cd2 are set as lattices G1 and G2 (step S5003).

An array of lattices along the shortest route 1 leading from the lattice G1 to lattice G2 on the lattice array Gp[ ] acquired by the pattern occupation rate calculating process (step S4903) are set as the lattice array Gp1[ ] (step S5004). Retrieval conditions on this shortest route 1 include the following conditions (1) to (3). (1) The shortest route 1 is the shortest route from the starting point to the end point. (2) Under condition (1), even if an imaginary wiring pattern is generated based on the shortest route and is added to lattices on the route, no lattice with the pattern occupation rate over 100% exists. (3) Under condition (1), when plural routes of the same length are found, the route that makes the sum of lattice pattern occupation rates maximum is selected.

Subsequently, whether the lattice array Gp1[ ]=φ(empty set) is satisfied is determined (step S5005). If the lattice array Gp1[ ]=φ is not satisfied (step S5005: NO), a pattern occupation rate allowing the passage of one line is added to the pattern occupation rate of each lattice of the lattice array Gp1[ ] (step S5006).

The wiring path occupation flag Af2 for each lattice of the lattice array Gp1[ ] is then set to 1 (step S5007). Subsequently, the lattice array Gp1[ ] is set as a coordinate array Go[ ] (step S5008), and a temporary wiring route is determined based on the coordinate array G0[ ] (step S5009). The coordinate array Co[ ] along the determined temporary wiring route is then correlated with the wiring path Rp and is stored in the memory device (step S5010).

Specifically, (1) a new record is added to the temporary wiring table 2700, and the coordinate array Co[ ] along the temporary wiring route is set as an unconnected section. (2) A temporary wiring number in the new record of (1) is added to the temporary wiring number list in a record of a line length adjustment number corresponding to the wiring group Rg in the line length adjustment table 2300.

An intersection of the lattice array Gp2[ ] and the lattice array Gp1[ ] is determined to set the union as the lattice array Gp2[ ] (step S5011), and the procedure returns to step S5001. If Gp1[ ]=φ is satisfied at step S5005 (step S5005: YES), whether Gp[ ]=G.Ga[ ] is satisfied is determined (step S5012), which means whether the diagrammatic shape Ra can be further expanded is determined.

If Gp[ ]=G.Ga[ ] is not satisfied (step S5012: NO), the diagrammatic shape Ra is expanded by the unit size G.Gu (step S5013), and the pattern occupation rate calculating process is carried out (step S5014).

In the pattern occupation rate calculating process (step S5014), the lattice management table G=Ga, the diagrammatic shape S=Ra, the figure type flag Fk=0, and the addition flag Fa=0 are set, and the process is carried out in accordance with the procedure of FIG. 42. Hence, in the pattern occupation rate calculating process (step S5014), the lattice array Gp[ ] consisting of a group of lattices overlapping the diagrammatic shape Ra given as the argument is returned as a return value. Subsequently, the procedure returns to step S5004.

If Gp[ ]=G.Ga[ ] is satisfied at step S5012 (step S5012: YES), the diagrammatic shape Ra cannot be further expanded, in which case the procedure returns to step S4909 of FIG. 49.

If no unconnected section is present on the wiring path Rp at step S5001 (step S5001: NO), the loop variable I1 is increased by 1 (step S5015), and the procedure returns to step S4906 of FIG. 49. A specific example of the unconnected section schematic wiring process (step S3209) will be described.

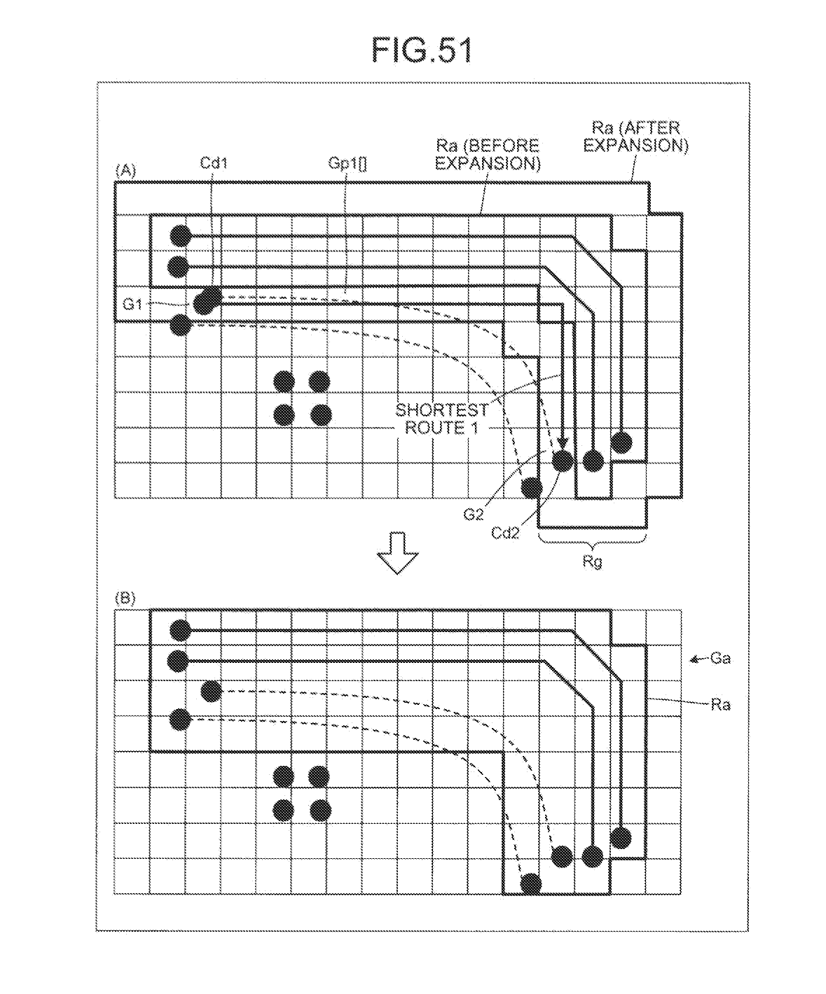

FIG. 51 is an explanatory diagram of the unconnected section schematic wiring process (step S3209). (A) in FIG. 51 depicts a specific example of the process at steps S5006 to S5011. To determine a temporary wiring route, the diagrammatic shape Ra is expanded by the unit size G.Gu (step S4902). The lattice array Gp1[ ] that is the array of lattices making up the shortest route 1 is determined inside the diagrammatic shape Ra.

Carrying out temporary wiring on the shortest route 1 means placing a wiring pattern equivalent to one line in lattices along the route 1. For this reason, the process at step S5006 is carried out beforehand. The temporary wiring route is then determined in compliance with the retrieval conditions on the shortest route 1. The temporary wiring route may identical to the shortest route 1 in some cases and may be different from the shortest route 1 in other cases. The coordinate array Co[ ] is an array of the typical coordinates of lattices making up the temporary wiring route. The typical coordinate may be a specific apex coordinate or the central coordinate of a lattice.

(B) in FIG. 51 depicts a specific example of the process at steps S4910 to S4914. The diagrammatic shape Ra is the diagrammatic shape acquired by the lattice region conversion process (step S4913). Hence, the diagrammatic shape including schematic wiring on an unconnected section is acquired.

The lattice region conversion process will be described. The lattice region conversion process is the process of carrying out region conversion by finding an intersection of groups of lattices and determining a final diagrammatic shape. In the lattice region conversion process, therefore, an argument is the lattice array Gp[ ] and a return value is the diagrammatic shape Sp. The lattice region conversion process is carried out at steps S4606, S4815, and S4913.

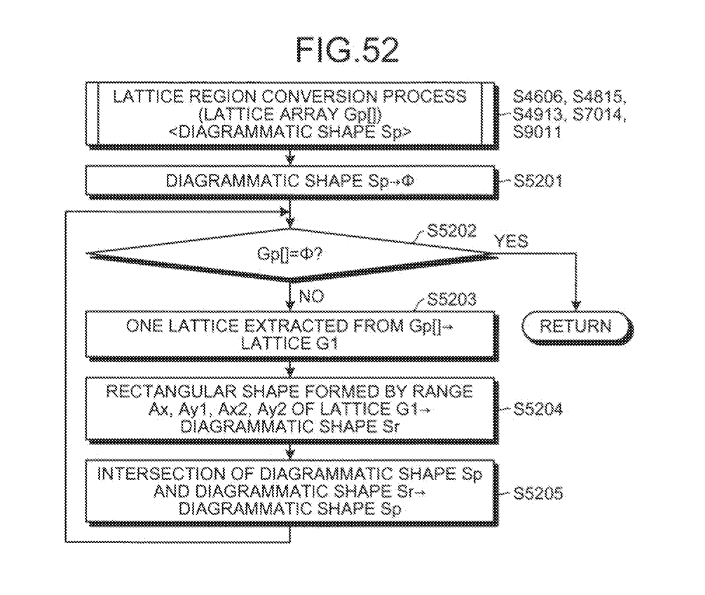

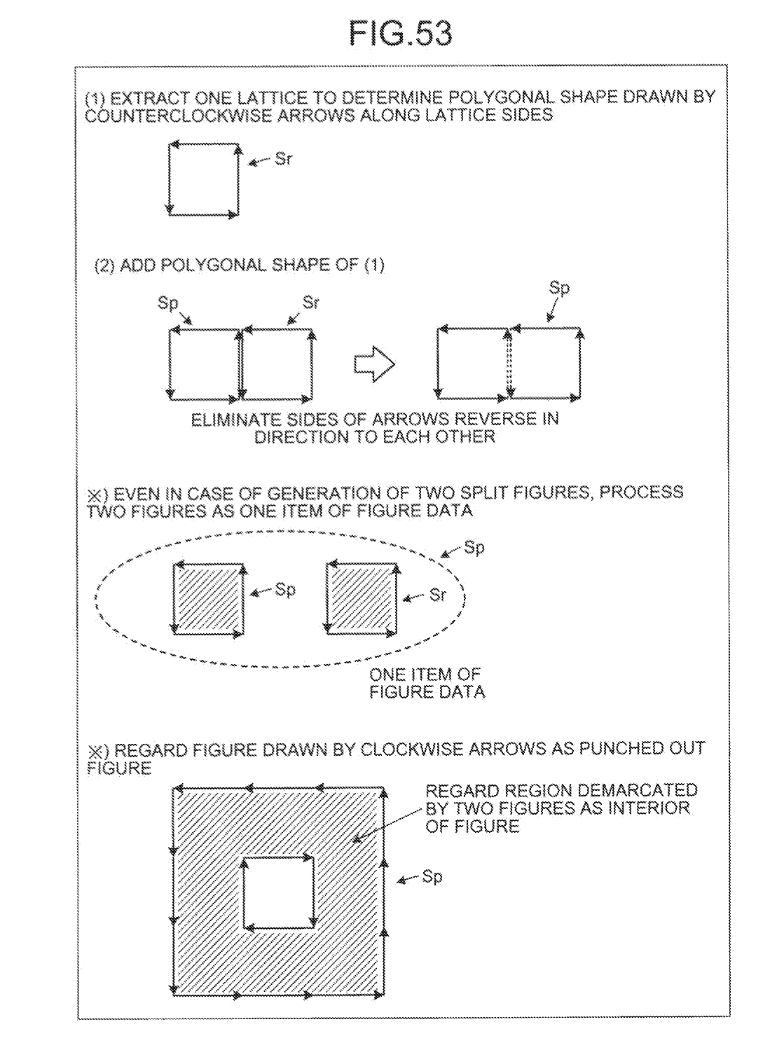

FIG. 52 is a flowchart detailing a procedure of the lattice region conversion process. The diagrammatic shape Sp=φ (empty set) is set (step S5201), and whether the lattice array Gp[ ]=φ (empty set) is satisfied is determined (step S5202). If Gp[ ]4 is not satisfied (step S5202: NO), one lattice is extracted from the lattice array Gp[ ] and the extracted lattice is set as the lattice G1 (step S5203).

A rectangular shape formed by the range Ax1, Ay1, Ax2, Ay2 of the extracted lattice G1 is then set as the diagrammatic shape Sr (step S5204). An intersection of the diagrammatic shape Sp and the diagrammatic shape Sr is set as a new diagrammatic shape Sp that is a diagrammatic shape intersection (step S5205), after which the procedure returns to step S5202. If Gp[ ]4 is satisfied at step S5202 (step S5202: YES), the lattice region conversion process is ended.

FIG. 53 is an explanatory diagram of a specific example of the lattice region conversion process. In this process, (1) a polygonal shape drawn by counterclockwise arrows along lattice sides is determined each time the lattice G1 is extracted at step S5203, and the determined polygonal shape is set as the diagrammatic shape Sr. (2) When the intersection is determined at step S5205, if the diagrammatic shapes Sp and Sr are adjacent to each other, arrows of lattice sides reverse in direction to each other are eliminated to generate the diagrammatic shape Sp. Even if the diagrammatic shapes Sp and Sr are separated from each other, an intersection of both diagrammatic shapes is determined and is set as the single diagrammatic shape Sp. If a figure drawn by clockwise arrows is generated in the course of generation of the diagrammatic shape Sp, the figure is punched out from the diagrammatic shape Sp.

The line length adjustment region schematic determining process will be described. In this embodiment, for the line length adjustment region, processes of schematic determining, detail determining, and mapping are carried sequentially.

FIGS. 54 to 56 are flowcharts detailing a procedure of the line length adjustment region schematic determining process (step S3304). In the line length adjustment region schematic determining process (step S3304), the lattice management table Ga and the wiring group Rg are used as arguments and the coordinate array Co[ ], areas Rs1 and Rs2, and diagrammatic shapes Rb1 and Rb2 are returned as return values.

In FIG. 54, a diagrammatic shape correlated with the wiring group Rg is set as the diagrammatic shape Ra (step S5401). The pattern occupation rate calculating process of FIG. 42 is then carried out (step S5402).

In the pattern occupation rate calculating process (step S5402), the lattice management table G=Ga, the diagrammatic shape S=Ra, the figure type flag Fk=0, and the addition flag Fa=0 are set, and the process is carried out in accordance with the procedure of FIG. 42. Hence, in the pattern occupation rate calculating process (step S5402), the lattice array Gp[ ] consisting of a group of lattices overlapping the diagrammatic shape Ra given as the argument is returned as a return value.

To realize the third display example, a user specified region for the wiring group Rg is set as a diagrammatic shape Rz (step S5403). If Rz=φ (empty set) is satisfied (step S5404: YES), no user specified region is present, in which case the procedure proceeds to step S5406. If Rz=φ (empty set) is not satisfied (step S5404: NO), an intersection of the diagrammatic shape Ra and the user specified region Rz is determined and is set as the diagrammatic shape Ra (step S5405).

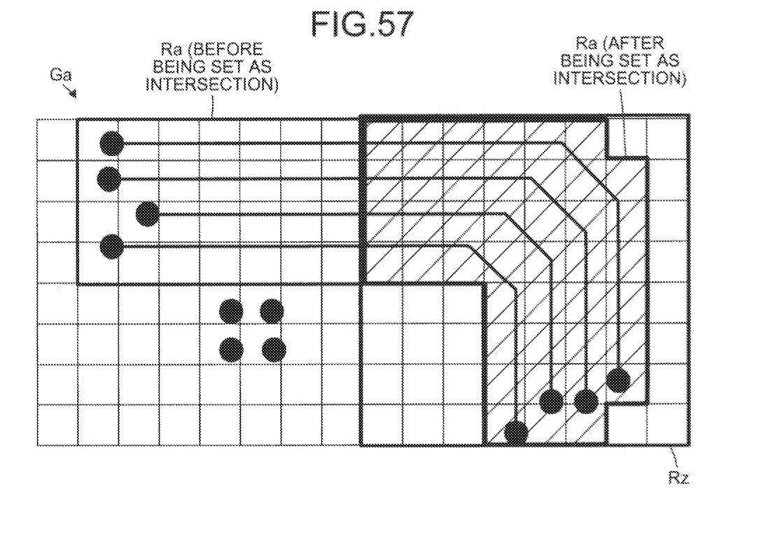

FIG. 57 is an explanatory diagram of a resulting diagrammatic shape intersection of the diagrammatic shape Ra and the user specified region Rz. A wiring path whose line length is greatest among wiring paths defined in the wiring group Rg is then set as the wiring path Rp (step S5406), and the line length of the wiring path Rp is set as the line length Rx (step S5407).

Insufficient line lengths of the wiring paths of the wiring group Rg with respect to a reference length that is the line length Rx of the wiring path Rp is set as a line length Ry[ ] (step S5408). Elements of the line length Ry[ ] are insufficient line lengths of the remaining wiring paths other than the wiring path Rp, among wiring paths making up the wiring group Rg.

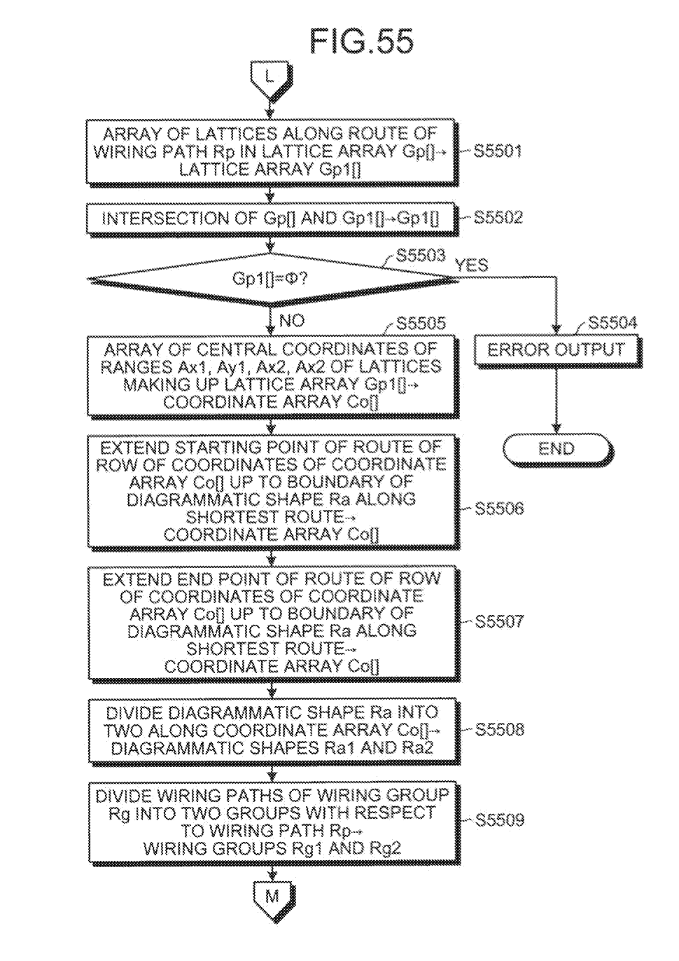

Whether element values in the line length Ry[ ] have a proportional relation with each other is determined (step S5409). If the element values have the proportional relation (step S5409: YES), the procedure proceeds to step S5501 of FIG. 55. If the element values have no proportional relation (step S5409: NO), with respect to the arrangement of wiring paths of the line length Ry[ ], the wiring path in the middle is set as the wiring path Rp (step S5410).

Determination of a proportional relation will be described in detail. Where a line length adjustment region is to be located varies depending on whether the insufficient line lengths of the remaining wiring paths, other than the wiring path Rp having the greatest line length in the wiring group Rg, have a proportional relation.

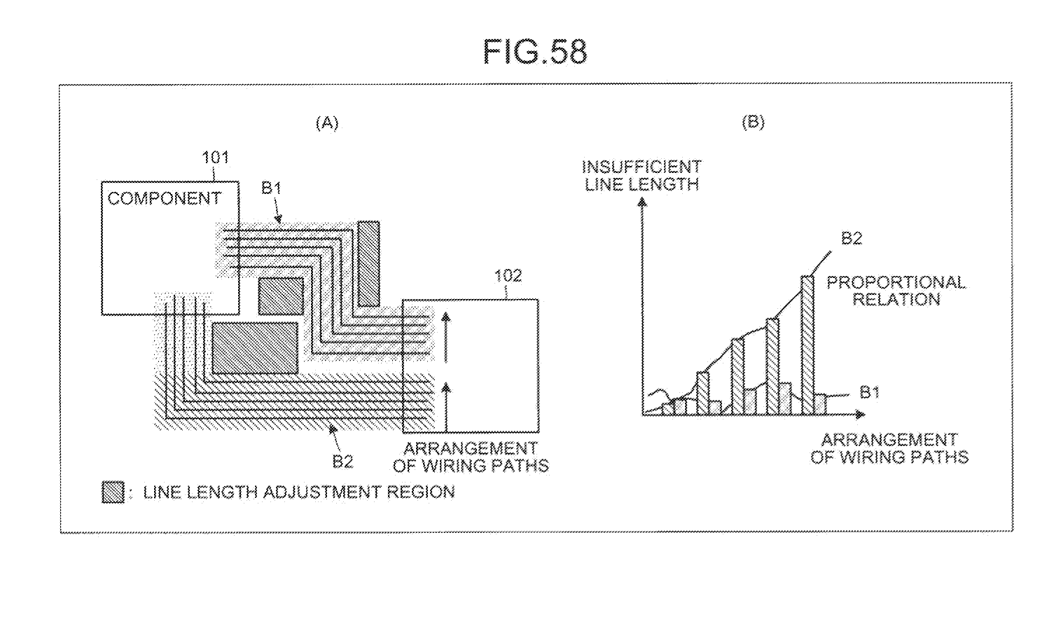

FIG. 58 is an explanatory diagram of determination of a substantial position of a line length adjustment region based on the proportional relation of insufficient line lengths. (A) in FIG. 58 depicts a case of forming a bus B1 and a bus B2 between the driver 1 and the receiver 102. Arrows at the right ends of the buses B1 and B2 represent the arrangement of wiring paths in the buses B1 and B2.

(B) in FIG. 58 is a graph of insufficient line lengths in the order of arrangement of the remaining wiring paths other than the wiring path Rp with the maximum line length that is plotted for each of the buses B1 and B2. As depicted in (B) insufficient line lengths on the bus B1 are nearly equal while insufficient line lengths on the bus B2 are proportional to each other. For the bus B1, therefore, each wiring path may be adjusted in line length, so that a line length adjustment region is preferably disposed on both sides of the bus B1. For the bus B2, on the other hand, a wiring path higher in location has a greater insufficient line length, so that a wiring path on the upper side is likely to be adjusted in line length. It is preferable, therefore, for the line length adjustment region be disposed on the upside of the bus B2.

The existence of proportional relation may be determined by calculating a correlation coefficient. A correlation coefficient r for variables x and y is obtained by the following equation.

r=(covariance of x and y)/{(standard deviation of x)×(standard deviation of y)}

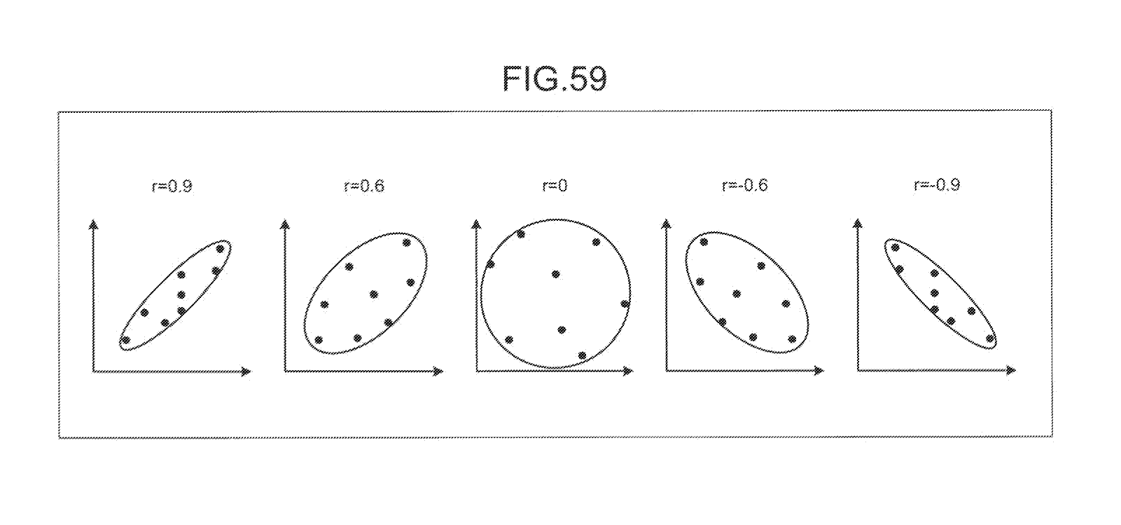

FIG. 59 is a graph of a correlation. The correlation coefficient r takes a value of 0<r≦1.0 if a positive correlation exists, a value of r=0 when no correlation exists, and a value of −1.0≦r<0 if a negative correlation exists.

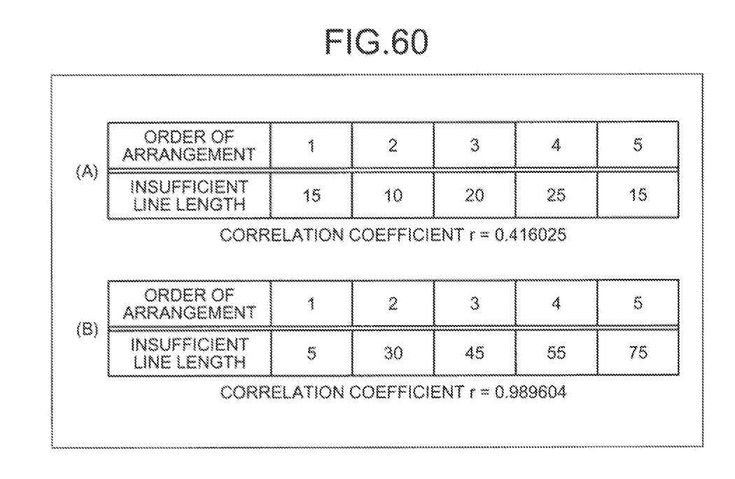

FIG. 60 is an explanatory diagram of the insufficient line lengths on the buses B1 and B2 of FIG. 58 and correlation coefficients. (A) in FIG. 60 depicts the insufficient line lengths on the bus B1 and (B) in FIG. 60 depicts the insufficient line lengths on the bus B2. In this case, specifically, a threshold r_t (0<r_t<1.0) for the correlation coefficient r is set, and nonexistence of the proportional relation is determined when −r_t<r<r_t is satisfied while existence of the proportional relation is determined when r≦−r_t or r≧r_t is satisfied.

Returning to FIG. 55, an array of lattices along the route of the wiring path Rp in the lattice array Gp[ ] acquired at step S5402 is set as the lattice array Gp1[ ] (step S5501), and an intersection of the lattice array Gp[ ] and the lattice array Gp1[ ] is determined (step S5502). The lattice array Gp[ ] is a group of lattices included in the diagrammatic shape Ra.

Whether the lattice array Gp1[ ] as the intersection is φ (empty set) is then determined (step S5503). If Gp1[ ]=φ is satisfied (step S5503: YES), an error message is output (step S5504), after which a series of processes are ended. If Gp1[ ]=φ is not satisfied (step S5503: NO), an array of the central coordinates of lattices making up the lattice array Gp1[ ] are set as the coordinate array Co[ ] (step S5505).

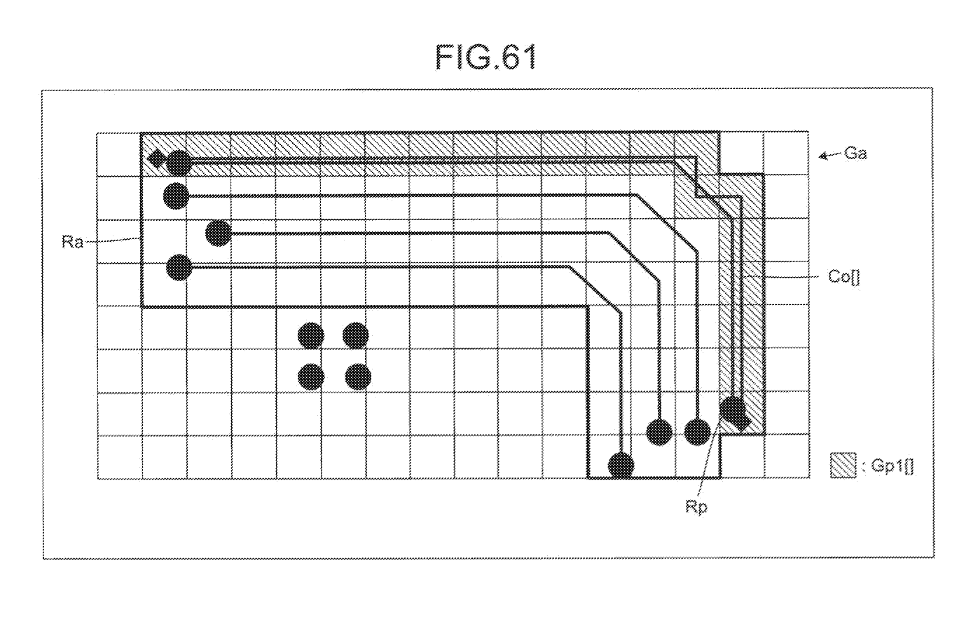

FIG. 61 is an explanatory diagram of the coordinate array Co[ ] acquired at step S5505. The hatched lattice array Gp1[ ] is the intersection resulting at step S5502.

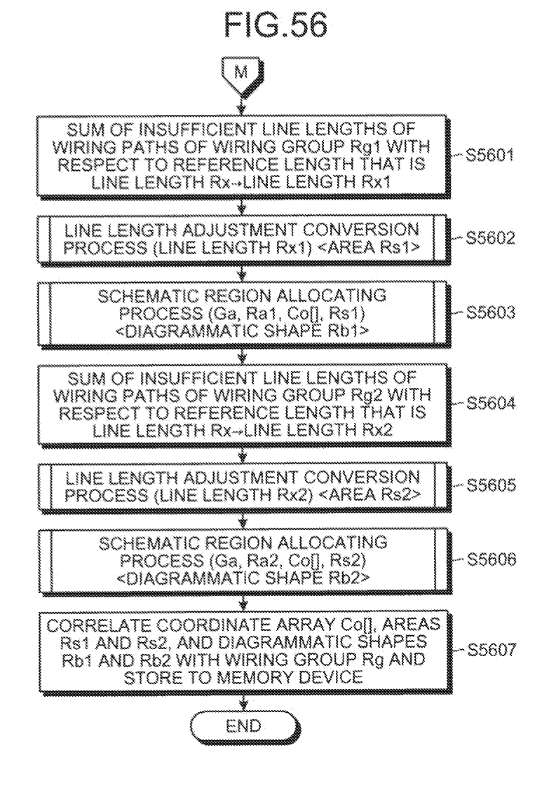

Returning to FIG. 55, the starting point and the end point of the route of a row of coordinates of the coordinate array Co[ ] are extended up to the boundary of the diagrammatic shape Ra (steps S5506 and S5507) to divide the diagrammatic shape Ra into two along the coordinate array Co[ ] as a boundary (step S5508). With respect to the wiring path Rp, then, the wiring paths of the wiring group Rg is divided into two groups Rg1 and RG2 of wiring paths (step S5509), after which the procedure proceeds to step S5601 of FIG. 56.

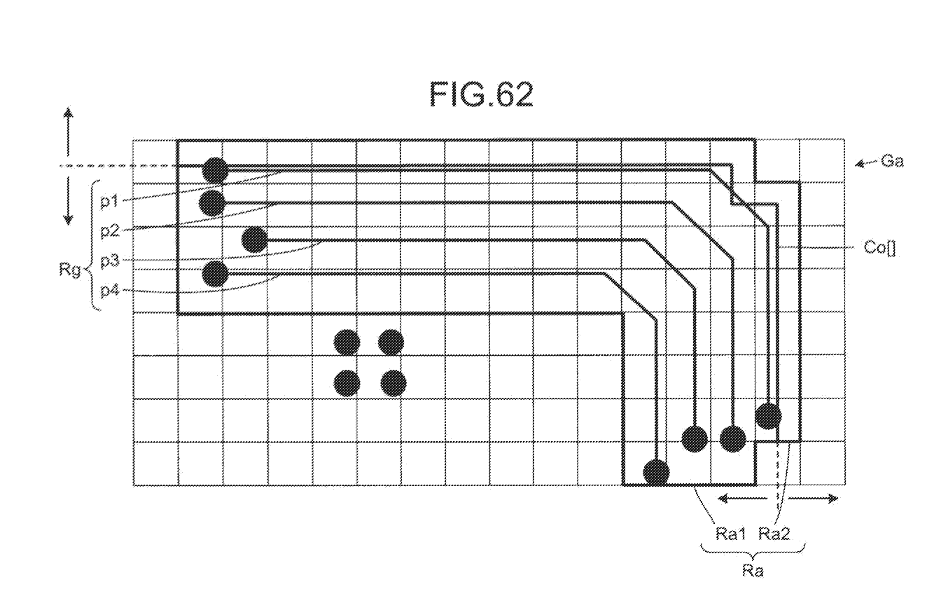

FIG. 62 is an explanatory diagram of an example of the dividing at steps S5506 to S5509. The diagrammatic shape Ra is divided into diagrammatic shapes Ra1 and Ra2 along the coordinate array Co[ ] as the boundary. In the same manner, the wiring group Rg including the wiring paths p1 to p4 is divided into the wiring group Rg1 including the wiring paths p2 to p4 in the diagrammatic shape Ra1 and into the wiring group Rg2, which includes no wiring path. Because the wiring path p1 is equivalent to the wiring path Rp, the wiring path p1 does not belong to any wiring group.

In FIG. 56, the sum of insufficient line lengths of the wiring paths of the wiring group Rg1 with respect to the reference length that is the line length Rx is calculated to set the sum of insufficient line lengths as a line length Rx1 (step S5601). Subsequently, a line length adjustment conversion process is carried out (step S5602). The line length adjustment conversion process (step S5602), which will be described in detail later, is carried out as a function that uses the line length Rx1 as an argument and that returns an area Rs1 as a return value. A schematic region allocating process is then carried out (step S5603). The schematic region allocating process (step S5603), which will be described in detail later, is carried out as a function that uses the lattice management table Ga, the diagrammatic shape Ra1, the coordinate array Co[ ], and the area Rs1 as arguments and that returns a diagrammatic shape Rb1 as a return value.

Likewise, the sum of insufficient line lengths of the wiring paths of the wiring group Rg2 with respect to the reference length that is the line length Rx is determined to set the sum of insufficient line lengths as a line length Rx2 (step S5604). Subsequently, the line length adjustment conversion process is carried out (step S5605). The line length adjustment conversion process (step S5605), which will be described in detail later, is carried out as a function that uses the line length Rx2 as an argument and that returns an area Rs2 as a return value. The schematic region allocating process is then carried out (step S5606). The schematic region allocating process (step S5606), which will be described in detail later, is carried out as a function that uses the lattice management table Ga, the diagrammatic shape Ra2, the coordinate array Co[ ], and the area Rs2 as arguments and that returns a diagrammatic shape Rb2 as a return value.

Subsequently, the coordinate array Co[ ], the areas Rs1 and Rs2, and the diagrammatic shapes Rb1 and Rb2 are correlated with the wiring group Rg and stored to the memory device (step S5607). Specifically, two new records are added to the schematic region table 2400, and the coordinate array Co[ ] is set in the dividing line in both records. The diagrammatic shape Rb1 is set in the substantial shape information in one of the records, while the diagrammatic shape Rb2 is set in the schematic shape information in the other of the records. The schematic region numbers in both records are added to the schematic region number list in the record in the line length adjustment table 2300 that corresponds to the wiring group Rg.

Two new records are added to the line length region table 2500, and the wiring path numbers of wiring paths making up the wiring group Rg are set in the wiring path number list in both records. The area Rs1 is set in the area of insufficiency in one of the records, while the area Rs2 is set in the area of insufficiency in the other of the records. The diagrammatic shape Rb1 is set in the schematic shape information in one of the records, while the diagrammatic shape Rb2 is set in the schematic shape information in the other of the records. At this point, the detail shape information and the detail area in both records are empty (undefined). Hence, the line length adjustment region schematic determining process is ended.

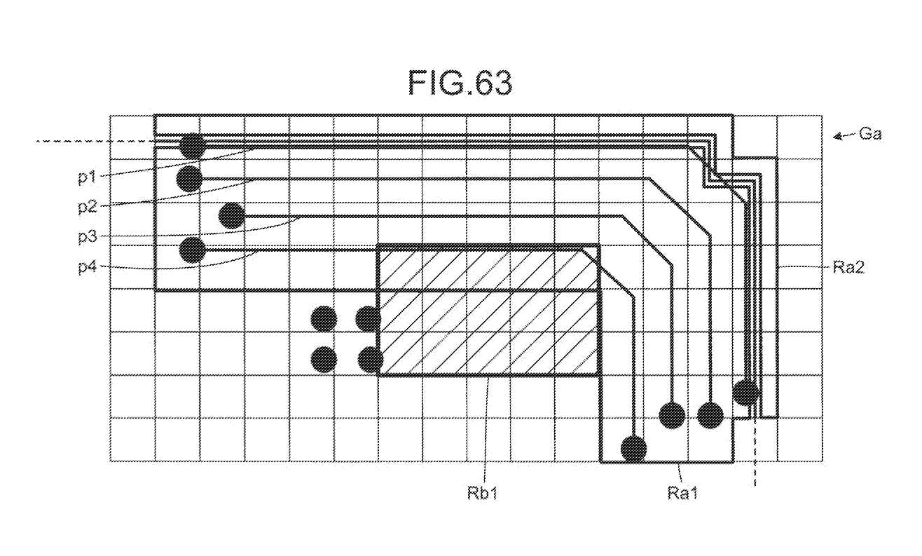

FIG. 63 is an explanatory diagram of the lattice management table Ga that results after schematic region allocation is over. For the diagrammatic shape Ra1, the diagrammatic shape Rb1 serving as a schematic region is allocated by the schematic region allocating process (step S5603). For the diagrammatic shape Ra2, because the wiring group Rg2 is φ (empty set), that is, no wiring path is present in the diagrammatic shape Ra2, the diagrammatic shape Rb2 is φ (empty set).

The line length adjustment conversion process will be described. The line length adjustment conversion process is carried out at steps S5602 and S5605. In the line length adjustment conversion process, the line length Rx1 (or Rx2) is used as an argument and a converted area Rs (Rs=Rs1 in the case of the line length Rx1, while Rs=Rs2 in the case of the line length Rx2) is returned as a return value. The case of line length Rx1 will be described.

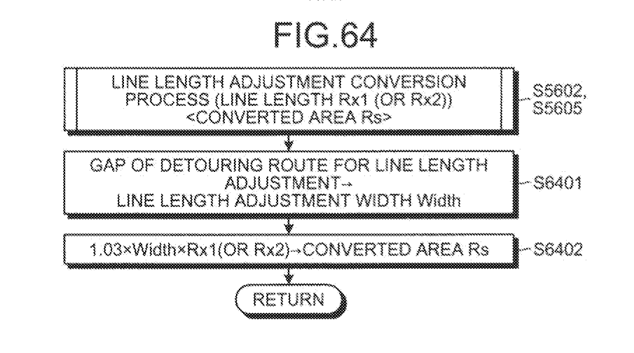

FIG. 64 is a flowchart detailing a procedure of the line length adjustment conversion process (steps S5602 and S5606). Reference is made to the design reference table 1300 to read out the span of a detour route for line length adjustment, and the read span is set as a line length adjustment width Width (step S6401). The converted area Rs (=Rs1) is then calculated using the following equation (step S6402).

Converted area Rs=1.03×Width×Rx1

“1.03” is a coefficient for establishing a relatively large area. The line length adjustment width Width is equivalent to an inter-lattice span (constant).

The schematic region allocating process will be described. The schematic region allocating process is carried out at steps S5603 and S5606. The schematic region allocating process is carried out as a function that uses the lattice management table Ga, the diagrammatic shape Ra (Ra1 or Ra2), the coordinate array Co[ ], and the area Rs (Rs1 or Rs2) as arguments and that returns the diagrammatic shape Rb1 (or Rb2) as a return value. At step S5603, the diagrammatic shape Ra1 and the area Rs1 acquired by the line length adjustment conversion process (step S5602) are set as the arguments Ra and Rs. At step S5606, the diagrammatic shape Ra2 and the area Rs2 acquired by the line length adjustment conversion process (step S5605) are set as the arguments Ra and Rs.

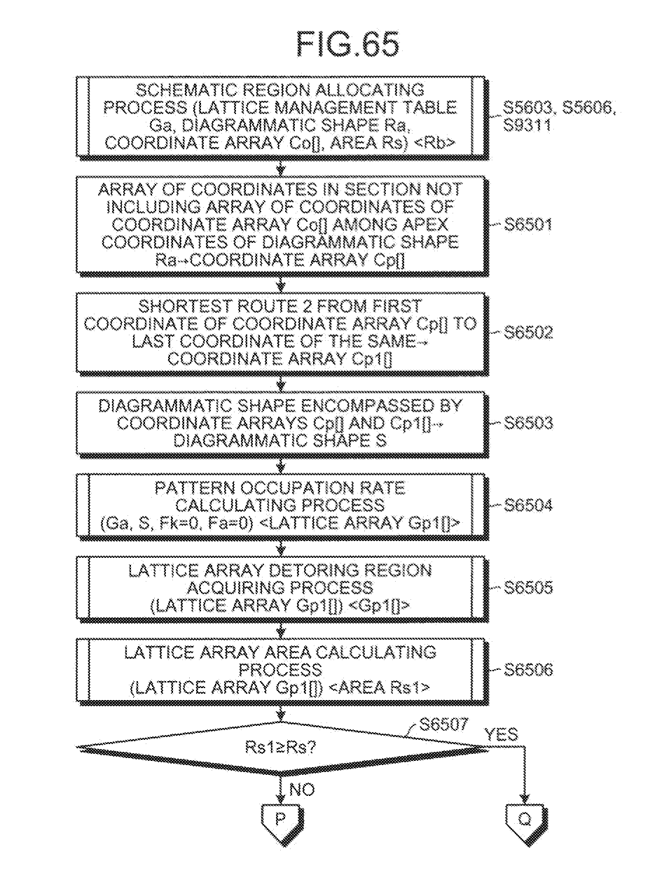

FIGS. 65 to 70 are flowcharts detailing a procedure of the schematic region allocating process (steps S5603 and S5606). In FIG. 65, among the apex coordinates of the diagrammatic shape Ra, an array of coordinates in a section not including an array of coordinates of the coordinate array Co[ ] are set as a coordinate array Cp[ ] (step S6501).

Subsequently, an array of coordinates from the first coordinate of the coordinate array Co[ ] to the last coordinate of the same are set as a coordinate array Cp1[ ] to determine the shortest route 2 that passes through the coordinate array Cp1[ ] (step S6502).

A diagrammatic shape encompassed by the coordinate array Co[ ] and the coordinate array Cp1[ ] is set as the diagrammatic shape S (step S6503), and the pattern occupation rate calculating process of FIG. 42 is carried out (step S6504).

In the pattern occupation rate calculating process (step S6504), the lattice management table G=Ga, the diagrammatic shape S, the figure type flag Fk=0, and the addition flag Fa=0 are set, and the process is carried out in accordance with the procedure of FIG. 42. Hence, in the pattern occupation rate calculating process (step S6504), the lattice array Gp1[ ] consisting of a group of lattices overlapping the diagrammatic shape S given as the argument is returned as a return value.

Subsequently, a lattice array detouring region acquiring process is then carried out (step S6505). In the lattice array detouring region acquiring process, which will be described in detail later, the lattice array Gp1[ ] is used as an argument and the lattice array Gp1[ ] is returned as a return value.

A lattice array area calculating process is then carried out (step S6506). In the lattice array area calculating process, which will be described in detail later, the lattice array Gp1[ ] is used as an argument and the area Rs1 is returned as a return value.

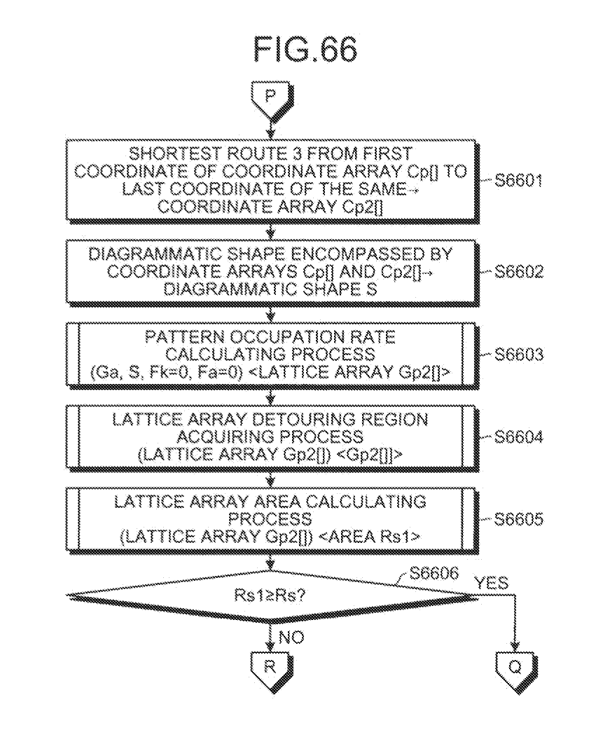

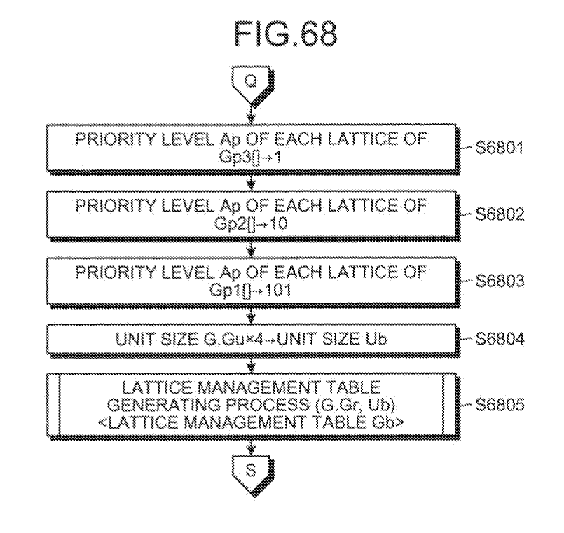

Whether Rs1≧Rs is satisfied is then determined (step S6507). If Rs1≧Rs is not satisfied (step S6507: NO), the procedure proceeds to step S6601 of FIG. 66. If Rs1≧Rs is satisfied (step S6507: YES), the procedure proceeds to step S6801 of FIG. 68.

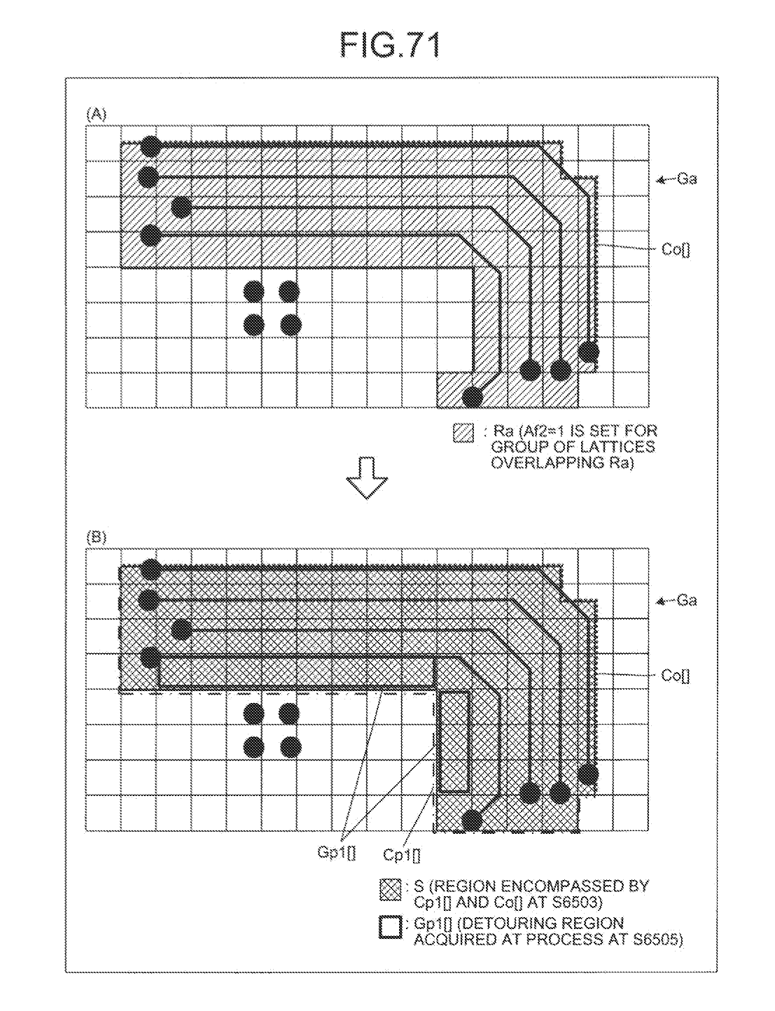

FIG. 71 is an explanatory diagram of a first specific example of the schematic region allocating process. In FIG. 71, (A) depicts the lattice management table Ga before determination of the shortest route 2. Conditions for determining the shortest route 2 are: (1) the shortest route 2 is the shortest route from the starting point to the end point; (2) the route does not pass through a figure (passing along the boundary is allowed) under the condition (1); and (3) when plural routes of the same length are found, a route of which a section coinciding with the figure boundary is maximum is selected under the condition (1).

In (B) of FIG. 71, a region encompassed by the coordinate array Cp1[ ] serving as the shortest route 2 and the coordinate array Co[ ] is set as the diagrammatic shape S, and the lattice array Gp1[ ] is acquired by the lattice array detouring region acquiring process (step S6505).

The case of not satisfying Rs1≧Rs at step S6507 of FIG. 65 (step S6507: NO) will be described.

In FIG. 66, an array of coordinates from the first coordinate of the coordinate array Co[ ] to the last coordinate of the same are set as a coordinate array Cp2[ ] to determine the shortest route 3 that passes through the coordinate array Cp2[ ] (step S6601).

A diagrammatic shape encompassed by the coordinate array Co[ ] and the coordinate array Cp2[ ] is set as the diagrammatic shape S (step S6602), and the pattern occupation rate calculating process of FIG. 42 is carried out (step S6603).

In the pattern occupation rate calculating process (step S6603), the lattice management table G=Ga, the diagrammatic shape S, the figure type flag Fk=0, and the addition flag Fa=0 are set, and the process is carried out in accordance with the procedure of FIG. 42. Hence, in the pattern occupation rate calculating process (step S6603), the lattice array Gp2[ ] consisting of a group of lattices overlapping the diagrammatic shape S given as the argument is returned as a return value.

Subsequently, a lattice array detouring region acquiring process is then carried out (step S6604). In the lattice array detouring region acquiring process, which will be described in detail later, the lattice array Gp2[ ] is used as an argument and the lattice array Gp2[ ] is returned as a return value.

A lattice array area calculating process is then carried out (step S6605). In the lattice array area calculating process, which will be described in detail later, the lattice array Gp2[ ] is used as an argument and the area Rs1 is returned as a return value.

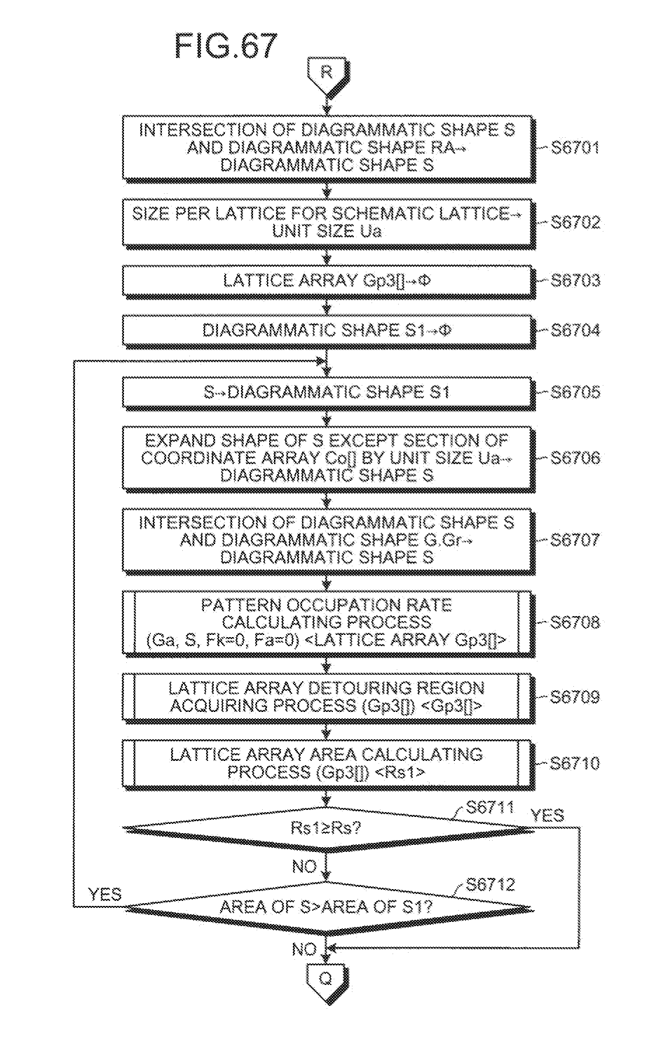

Whether Rs1≧Rs is satisfied is then determined (step S6606). If Rs1≧Rs is not satisfied (step S6606: NO), the procedure proceeds to step S6701 of FIG. 67. If Rs1≧Rs is satisfied (step S6606: YES), the procedure proceeds to step S6801 of FIG. 68.

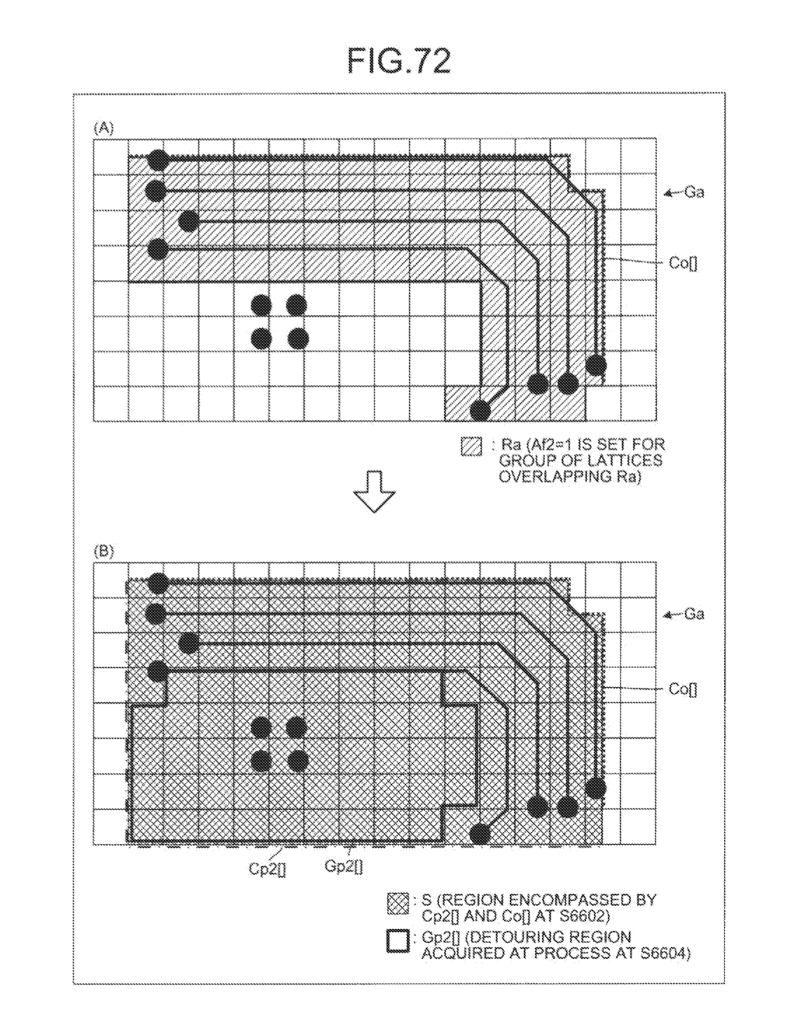

FIG. 72 is an explanatory diagram of a second specific example of the schematic region allocating process. In FIG. 72, (A) depicts the lattice management table Ga before determination of the shortest route 3. Conditions for determining the shortest route 3 are: (1) the shortest route 3 is the shortest route from the starting point to the end point; (2) the route does not pass through a figure (passing along the boundary is allowed) under the condition (1); and (3) when plural routes of the same length are found, a route passing farthest from a figure is selected under the condition (1).

In (B) of FIG. 72, a region encompassed by the coordinate array Cp2[ ] serving as the shortest route 3 and the coordinate array Co[ ] is set as the diagrammatic shape S, and the lattice array Gp2[ ] is acquired by the lattice array detouring region acquiring process (step S6604).

The case of not satisfying Rs1≧Rs at step S6606 of FIG. 66 (step S606: NO) will be described.

In FIG. 67, an intersection of the diagrammatic shape S acquired at step S6602 and the diagrammatic shape Ra is newly set as the diagrammatic shape S (step S6701). The size per lattice for the schematic lattice is then set as the unit size Ua (step S6702), and a lattice array Gp3[ ]=φ (empty set) is set (step S6703).

The diagrammatic shape S1=φ (empty set) is set (step S6704), and the diagrammatic shape S is given to the diagrammatic shape S1 (step S6705). The diagrammatic shape S except the section of the coordinate array Co[ ] is then expanded by the unit size Ua (step S6706).

Subsequently, an intersection of the diagrammatic shape S and the diagrammatic shape G.Gr is determined (step S6707), which is followed by execution of the pattern occupation rate calculating process of FIG. 42 (step S6708).

In the pattern occupation rate calculating process (step S6708), the lattice management table G=Ga, the diagrammatic shape S, the figure type flag Fk=0, and the addition flag Fa=0 are set, and the process is carried out in accordance with the procedure of FIG. 42. Hence, in the pattern occupation rate calculating process (step S6708), the lattice array Gp1[ ] consisting of a group of lattices overlapping the diagrammatic shape S given as the argument is returned as a return value.

Subsequently, a lattice array detouring region acquiring process is then carried out (step S6709). In the lattice array detouring region acquiring process, which will be described in detail later, the lattice array Gp3[ ] is used as an argument and the lattice array Gp3[ ] is returned as a return value.

A lattice array area calculating process is then carried out (step S6710). In the lattice array area calculating process, which will be described in detail later, the lattice array Gp3[ ] is used as an argument and the area Rs1 is returned as a return value.

Whether Rs1≧Rs is satisfied is then determined (step S6711). If Rs1≧Rs is satisfied (step S6711: YES), the procedure proceeds to step S6810 of FIG. 68. If Rs1≧Rs is not satisfied (step S6711: NO), whether the diagrammatic shape S is larger in area than the diagrammatic shape S1 is determined (step S6712). If the diagrammatic shape S is larger in area than the diagrammatic shape S1 (step S6712: YES), the procedure returns to step S6705. If the diagrammatic shape S is not larger in area than the diagrammatic shape S1 (step S6712: NO), the procedure proceeds to step S6801 of FIG. 68.

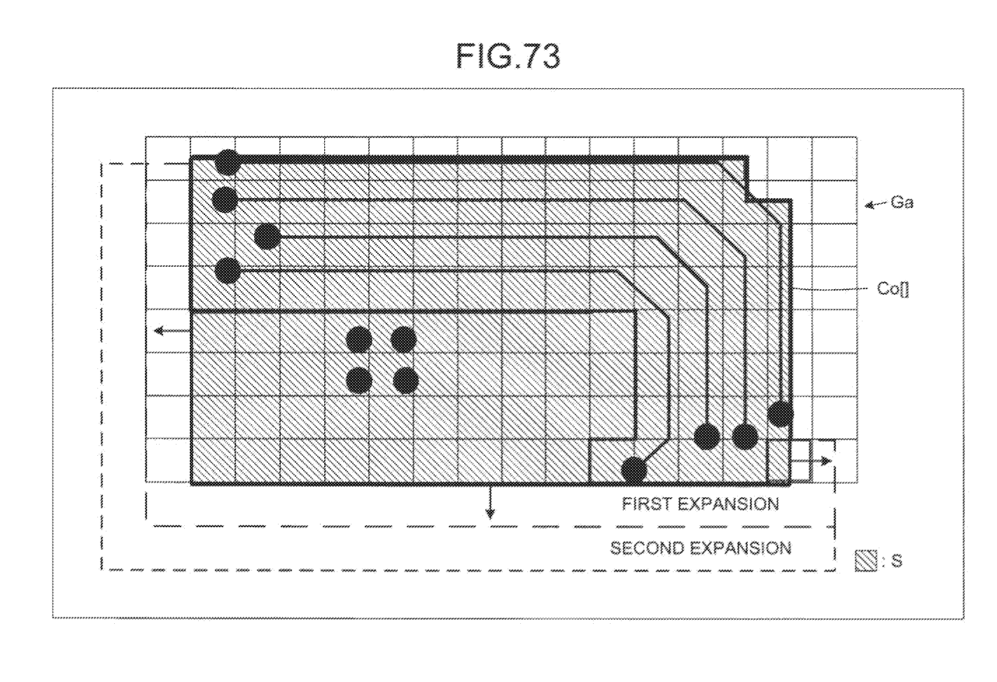

FIG. 73 is an explanatory diagram of a third specific example of the schematic region allocating process. FIG. 73 depicts an example of the expansion at step S6706. Specifically, the diagrammatic shape S except the coordinate array Co[ ] is expanded by the unit size Ua at a time.

A case of satisfying Rs1≧Rs (step S6507: YES, step S6606: YES, and step S6711: YES) will be described.

In FIG. 68, the priority level Ap of each lattice of the lattice array Gp3[ ] is set to 1 (step S6801), the priority level Ap of each lattice of the lattice array Gp2[ ] is set to 10 (step S6802), and the priority level Ap of each lattice of the lattice array Gp1[ ] is set to 101 (step S6803). The greater the value of the priority level Ap is, the higher a priority order is. A size four times the unit size G.Gu is set as the unit size Ub (step S6804), and the lattice management table generating process of FIG. 35 is carried out (step S6805).

In the lattice management table generating process (step S6805), the diagrammatic shape S=G.Gr and the unit size U=Ub are set as arguments, and the process is carried in accordance with the procedure of FIG. 35. The lattice management table Gb is thus returned as a return value in the lattice management table generating process (step S6805).

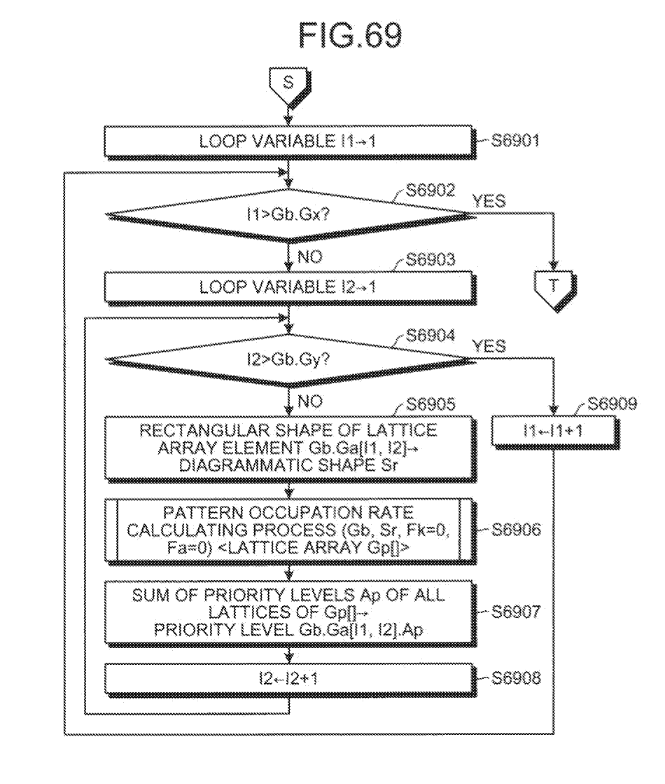

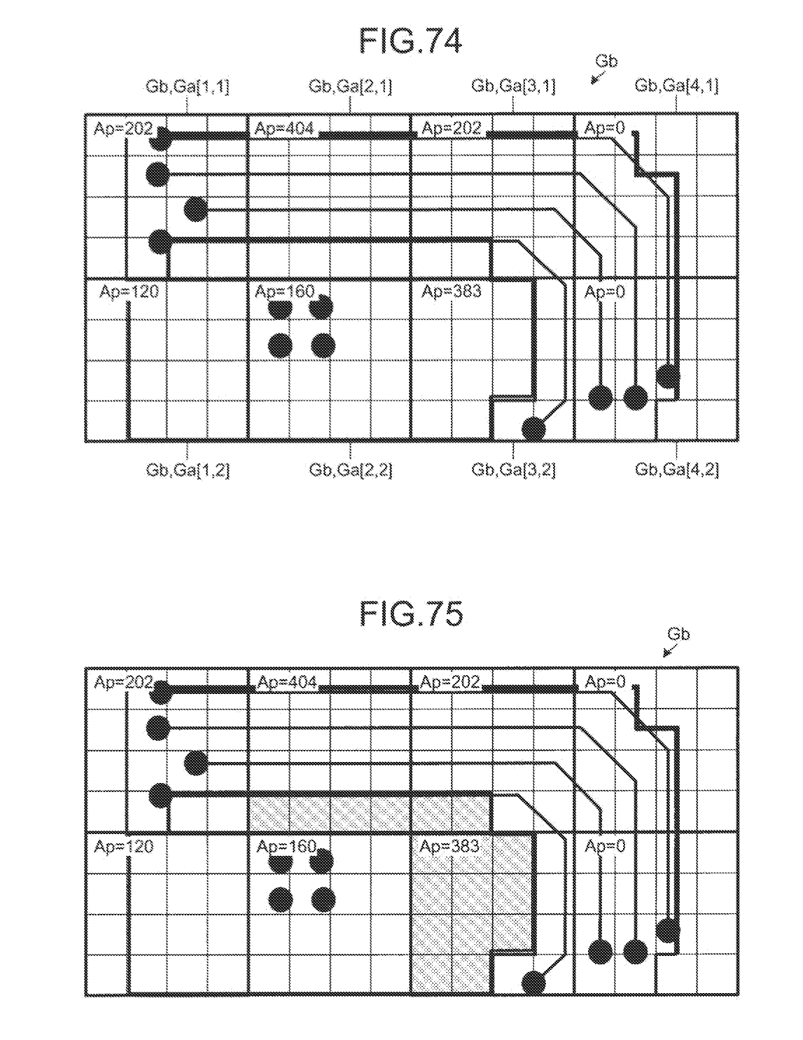

FIG. 74 is an explanatory diagram of the lattice management table Gb, which is a table whose unit lattice is larger than that of the lattice management table Ga as the result of the expansion to the unit size Ub. In FIG. 74, the lattice management table Ga has 8×16 lattices, while the lattice management table Gb has 2×4 lattices. For the 8 lattices of the lattice management table Gb, the (sum of) priority level Ap is calculated by the process depicted in FIG. 69.

In FIG. 69, the loop variable is set to 1 (step S6901), and whether I1>Gb.Gx is satisfied is determined (step S6902). Gb.Gx represents the number of lattices in the X axis direction of the lattice management table Gb. Gb.Gx is 4 in FIG. 74.

If I1>Gb.Gx is not satisfied (step S6902: NO), the loop variable I2 is set to 1 (step S6903), and whether I2>Gb.Gy is satisfied is determined (step S6904). Gb.Gy is 2 in FIG. 74.

If I2>Gb.Gy is not satisfied (step S6904: NO), the rectangular shape of a lattice array element Gb.Ga[I1, I2] is set as the diagrammatic shape Sr (step S6905). The pattern occupation rate calculating process is then carried out (step S6906).

In the pattern occupation rate calculating process (step S6906), the lattice management table G=Gb, the diagrammatic shape Sr, the figure type flag Fk=0, and the addition flag Fa=0 are set, and the process is carried out in accordance with the procedure of FIG. 42. Hence, in the pattern occupation rate calculating process (step S6906), the lattice array Gp[ ] consisting of a group of lattices overlapping the diagrammatic shape Sr given as the argument is returned as a return value.

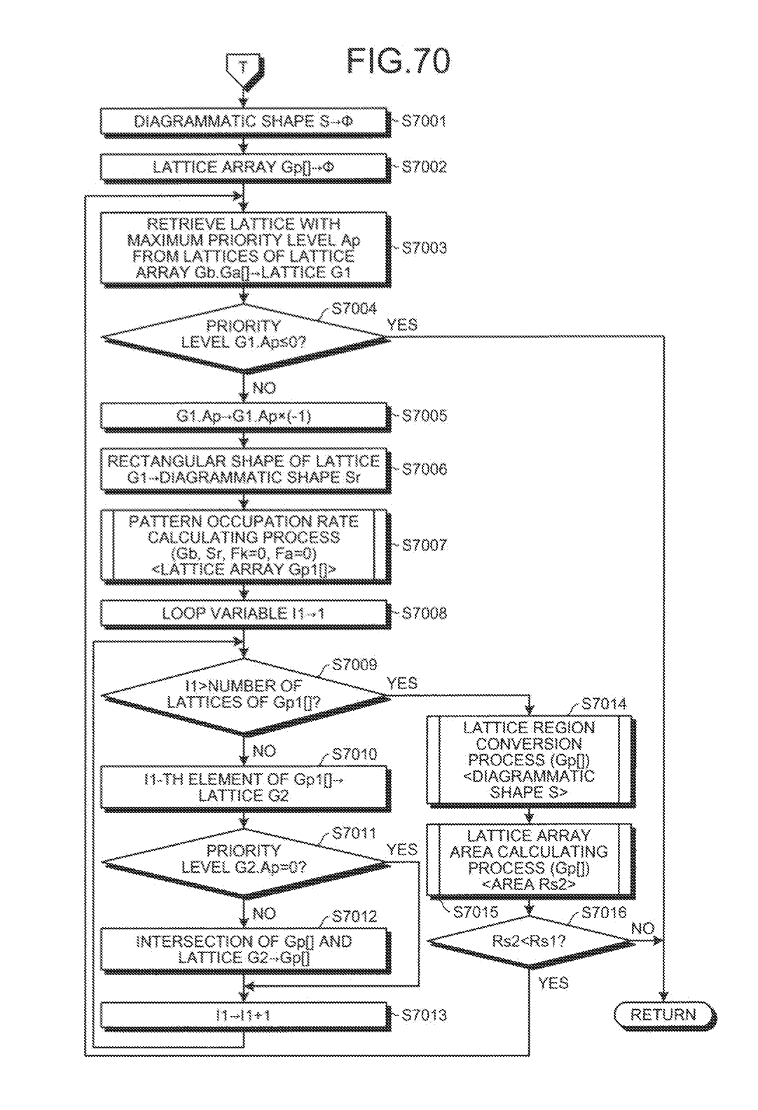

The sum of the priority levels Ap of all the lattices of the lattice array Gp[ ] (lattices on the lattice management table Ga in the case of FIG. 74) is set as the priority level Gb.Ga[I1, I2].Ap of the lattice array element Gb.Ga[I1, I2] (step S6907). Subsequently, the loop variable I2 is increased by 1 (step S6908), and the procedure returns to step S6904. If I2>Gb.Gy is satisfied at step S6904 (step S6904: YES), the loop variable I1 is increased by 1 (step S6909), and the procedure returns to step S6902. If I1>Gb.Gx is satisfied at step S6902 (step S6902: YES), the procedure proceeds to step S7001 of FIG. 70.

In FIG. 70, the diagrammatic shape S=φ (empty set) is set (step S7001), and the lattice array Gp[ ]=φ (empty set) is set (step S7002). The lattice with the greatest priority level Ap is then retrieved from among lattices making up the lattice array Gb.Ga[ ] and set as the lattice G1 (step S7003). If plural lattices having the greatest priority level Ap are present (lattices with the same priority level maximum are present), to make the region continuous, lattices selected in greater number among lattices in four directions are retrieved as the lattice G1. When retrieval in such a manner is impossible, selected lattices for which the sum of their priority levels Ap is least among lattices in four directions are retrieved (because the priority level Ap of a selected lattice becomes a negative value at step S7005).

Whether the priority level G1.Ap of the retrieved lattice G1 satisfies G1.Ap≦0 is determined (step S7004). If G1.Ap≦0 is satisfied (step S7004: YES), the schematic region allocating process is ended.

If G1.Ap≦0 is not satisfied (step S7004: NO), the priority level G1.Ap is turned to a negative value (step S7005). The rectangular shape of the lattice G1 is then set as the diagrammatic shape Sr (step S7006), and the pattern occupation rate calculating process of FIG. 42 is carried out (step S7007).

In the pattern occupation rate calculating process (step S7007), the lattice management table G=Gb, the diagrammatic shape Sr, the figure type flag Fk=0, and the addition flag Fa=0 are set, and the process is carried out in accordance with the procedure of FIG. 42. Hence, in the pattern occupation rate calculating process (step S7007), the lattice array Gp1[ ] consisting of a group of lattices overlapping the diagrammatic shape Sr given as the argument is returned as a return value.

Subsequently, the loop variable I1 is set to 1 (step S7008), and whether the loop variable I1 exceeds the number of lattices of the lattice array Gp1[ ] is determined (step S7009). If the loop variable I1 does not exceed the number of lattices of the lattice array Gp1[ ] (step S7009: NO), the I1-th element of the lattice array Gp1[ ] is set as a lattice G2 (step S7010), and whether the priority level G2.Ap of the lattice G2 satisfies G2.Ap=0 is determined (step S7011).

If G2.Ap=0 is satisfied (step S7011: YES), the procedure proceeds to step S7013. If G2.Ap=0 is not satisfied (step S7011: NO), an intersection of the lattice array Gp[ ] and the lattice G2 is set as a new lattice array Gp[ ] (step S7012), and the procedure proceeds to step S7013, at which the loop variable I1 is increased by 1 (step S7013), after which the procedure returns to step S7009.

If the loop variable I1 exceeds the number of lattices of the lattice array Gp1[ ] at step S7009 (step S7009: YES), the lattice region conversion process of FIG. 52 is carried out (step S7014). In the lattice region conversion process (step S7014), the final lattice array Gp[ ] acquired at step S7012 is used as an argument, and the diagrammatic shape S is returned as a return value.

FIG. 75 is an explanatory diagram of an example of the result of the lattice region conversion process (step S7014). On the lattice management table Gg of FIG. 75, a group of hatched lattices of the unit size G.Gu are equivalent to the lattice array Gp[ ] acquired at steps S7009 to S7013, and the shape consisting of this group of lattices is the diagrammatic shape S.

The lattice array area calculating process is then carried out (step S7015). In the lattice array area calculating process (step S7015), which will be described later, the lattice array Gp[ ] is used as an argument and the area Rs2 is returned as a return value.

Subsequently, whether the calculated area Rs2 satisfies Rs2<Rs1 (Rs1 represents the area acquired at step S6710) is determined (step S7016). If Rs2<Rs1 is satisfied (step S7016: YES), the procedure returns to step S7003. If Rs2<Rs1 is not satisfied (step S7016: NO), the schematic region allocating process is ended.

The lattice array detouring region acquiring process will be described. The lattice array detouring region acquiring process is carried out at steps S6505 of FIG. 65, S6604 of FIG. 66, and S6709 of FIG. 67. The lattice array detouring region acquiring process is carried out as a function that uses the lattice array Gp[ ] as an argument and that returns the lattice array Gp1[ ] in an empty region in contact with a wiring path, as a return value.

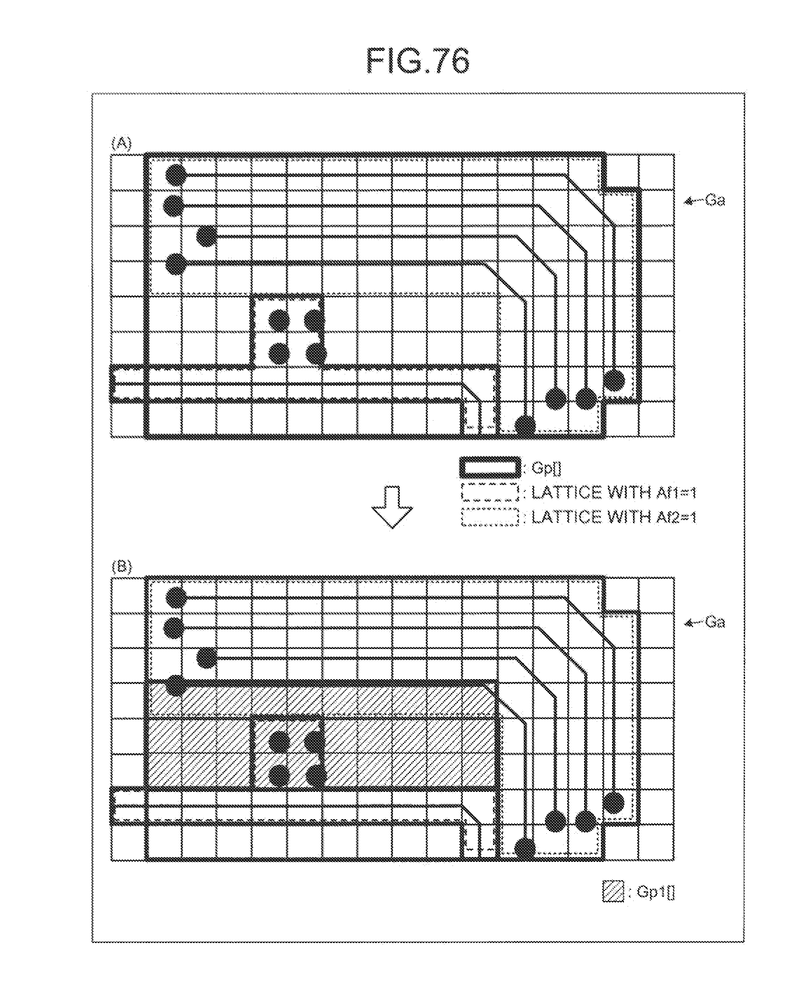

FIG. 76 is an explanatory diagram of a specific example of the lattice array detouring region acquiring process. On the lattice management table Ga of FIG. 76A, lattices with the obstacle occupation flag Af1=1 and lattices with the wiring path occupation flag Af2=1 are set. It is assumed in this situation that the lattice array Gp[ ] encompassed by a thick line is given. In (B) of FIG. 76, an empty region (detouring region) that is in contact with a wiring path in the region of the lattice array Gp[ ] is returned as the lattice array Gp1[ ].

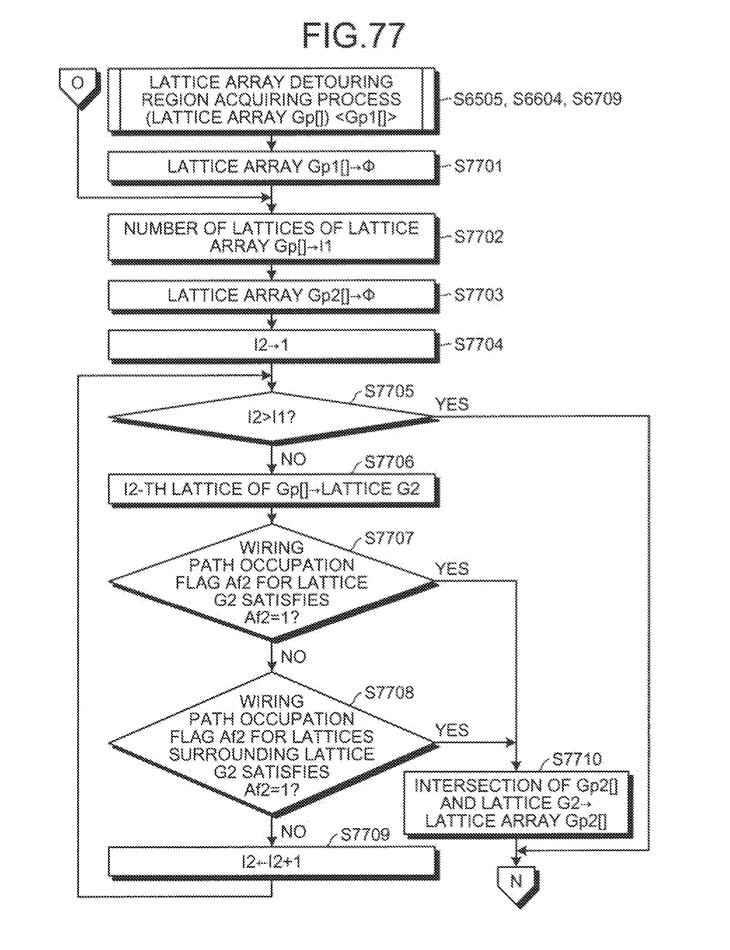

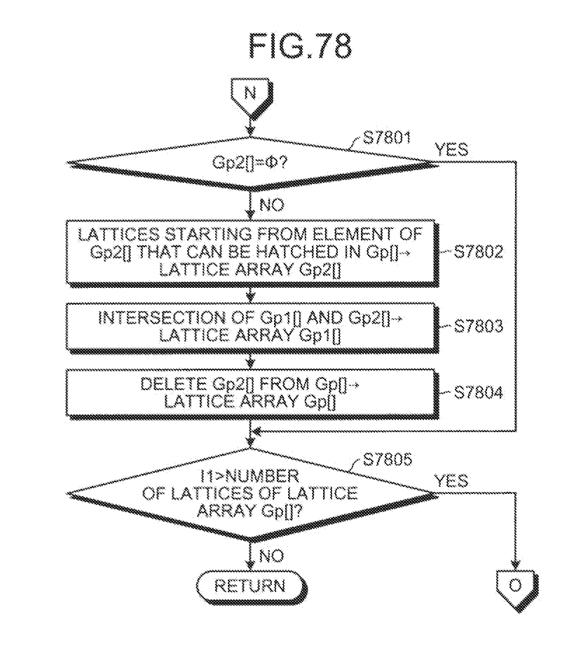

FIGS. 77 and 78 are flowcharts detailing a procedure of the lattice array detouring region acquiring process. In FIG. 77, the lattice array Gp1[ ]=φ (empty set) is set (step S7701), and the number of lattices of the lattice array Gp[ ] is set to the value of the loop variable I1 (step S7702). The lattice array Gp[ ] is then set as the lattice array Gp2[ ]=φ (empty set) (step S7703), and the loop variable I2 is set to 1 (step S7704).

Whether I2>I1 is satisfied is then determined (step S7705). If I2>I1 is not satisfied (step S7705: NO), the I2-th lattice of the lattice array Gp[ ] is set as the lattice G2 (step S7706), and whether the wiring path occupation flag Af2 for the lattice G2 satisfies Af2=1 is determined (step S7707).

If Af2=1 is not satisfied (step S7707: NO), whether the wiring path occupation flag Af2 for each of lattices surrounding the lattice G2 satisfies Af2=1 is determined (step S7708). If Af2=1 is not satisfied (step S7708: NO), the loop variable I2 is increased by 1 (step S7709), and the procedure returns to step S7705.

If the wiring path occupation flag Af2=1 is satisfied at step S7707 or step S7708 (step S7707/S7708: YES), an intersection of the lattice array Gp2[ ] and the lattice G2 is set newly as the lattice array Gp2[ ] (step S7710), and the procedure proceeds to step S7801 of FIG. 78. If I2>I1 is satisfied at step S7705 (step S7705: YES), the procedure proceeds to step S7801 of FIG. 78.

In FIG. 78, whether Gp2[ ]=φ (empty set) is satisfied is determined (step S7801). If Gp2[ ]=φ is satisfied (step S7801: YES), the procedure proceeds to step S7805.

If Gp2[ ]=φ is not satisfied (step S7801: NO), lattices that can be hatched in the lattice array Gp[ ], the lattices starting from an element of the lattice array Gp2[ ], are set as the lattice array Gp2[ ] (step S7802). Whether a lattice can be hatched is determined based on whether the lattice has an empty space wide enough to traverse a wiring path. Specifically, whether a lattice can be hatched is determined based on whether the following conditions (1) and (2) are met. (1) When the obstacle occupation flag Af1 is 1, the wiring pattern occupation rate is equal to or less than a given value (>0). (2) When the wiring path occupation flag Af2 is 1, the sum of the wiring pattern occupation rate of a lattice to be hatched and the same rate of any one of the lattices at the front/rear and to left/right of the lattice to be hatched is equal to or less than a given value (>0). Subsequently, an intersection of the lattice array Gp1[ ] and the lattice array Gp2[ ] is set newly as the lattice array Gp1[ ] (step S7803). The lattice array Gp2[ ] is then deleted from the lattice array Gp[ ], and the resulting lattice array Gp[ ] is set as a new lattice array Gp[ ] (step S7804).

Subsequently, whether the loop variable I1 exceeds the number of lattices of the lattice array Gp[ ] is determined (step S7805). If the loop variable I1 exceeds the number of lattices of the lattice array Gp[ ] (step S7805: YES), the procedure returns to step S7702 of FIG. 77. If the loop variable I1 does not exceed the number of lattices of the lattice array Gp[ ] (step S7805: NO), the lattice array detouring region acquiring process is ended.

The lattice array area calculating process will be described. The lattice array area calculating process is carried out at steps S6710 of FIG. 67 and S7015 of FIG. 70. The lattice array area calculating process is carried out as a function of calculating the area of the lattice array Gp[ ] given as an argument and returning a calculation result as the area Rs.

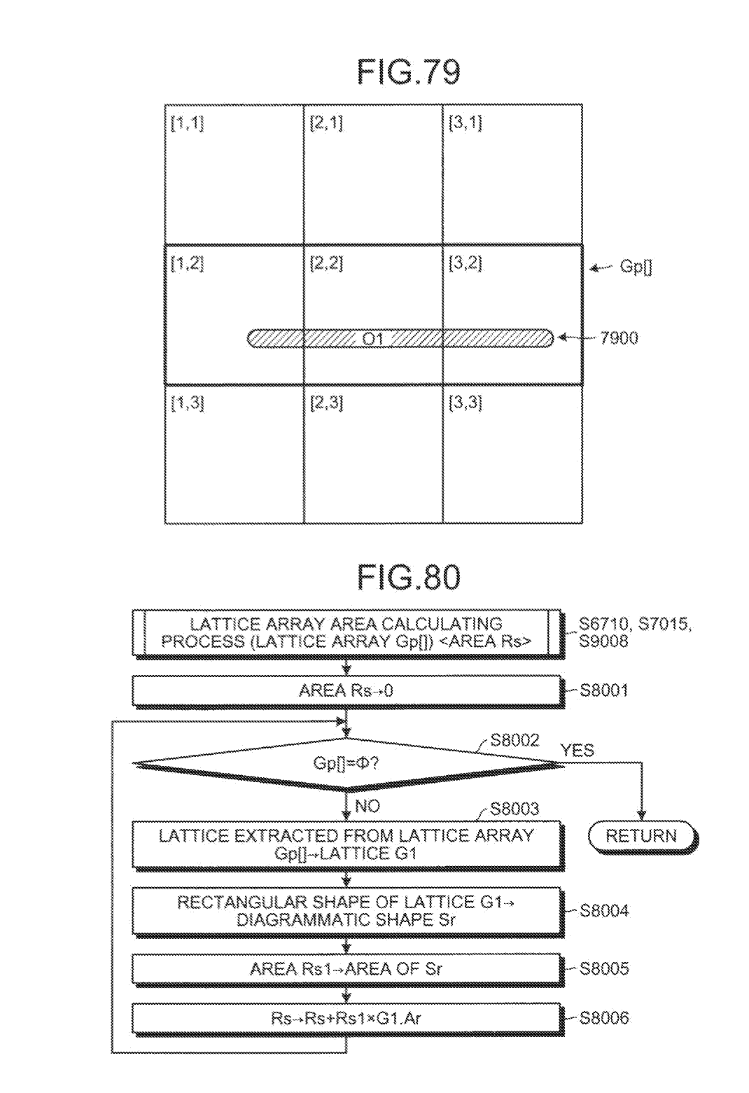

FIG. 79 is an explanatory diagram of a specific example of the lattice array area calculating process. In FIG. 79, the lattice array Gp[ ] consisting of lattices [1, 1] to [3, 3] is used as an example. The lattice array area calculating process is equivalent to a process of calculating the area of an empty space by subtracting the area of a space occupied by an obstacle or wiring path included in the lattices [1, 1] to [3, 3] from the sum of the areas of the lattices [1, 1] to [3, 3].

For example, for the lattice array Gp[ ]={[1, 2], [2, 2], [3, 2]}, subtracting the area of a wiring path (or obstacle) 7900 from the sum of the areas of the lattices [1, 2], [2, 2], and [3, 2] gives the area Rs.

FIG. 80 is a flowchart detailing a procedure of the lattice array area calculating process. The area Rs of the lattice array Gp[ ] is set to 0 (step S8001), and whether the lattice array Gp[ ]=φ is satisfied is determined (step S8002). If the lattice array Gp[ ]φ is not satisfied (step S8002: NO), a lattice extracted from the lattice array Gp[ ] is set as the lattice G1 (step S8003), and the rectangular shape of the lattice G1 is set as the diagrammatic shape Sr (step 8004).

The area of the diagrammatic shape Sr is set as the area Rs1 (step S8005), and a value obtained by multiplying the area Rs1 by the pattern occupation rate G1.Ar of the lattice G1 is added to the area Rs to update the area Rs (step S8006). The procedure then returns to step S8002. If Gp[ ]4 is satisfied at step S8002 (step S8002: YES), the lattice array area calculating process is ended.

The line length adjustment region detail determining process will be described. The line length adjustment region detail determining process is carried out at step S3305 of FIG. 33. The line length adjustment region detail determining process (step S3305) is carried out as a function that uses the lattice management table Ga and the wiring group Rg as arguments and that returns a diagrammatic shape Rc2 serving as a line length adjustment region and an area Rt2, as return values.

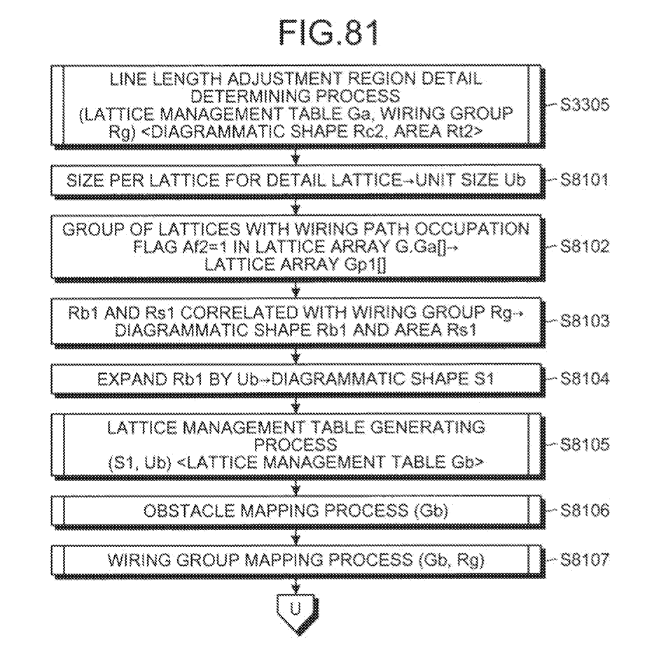

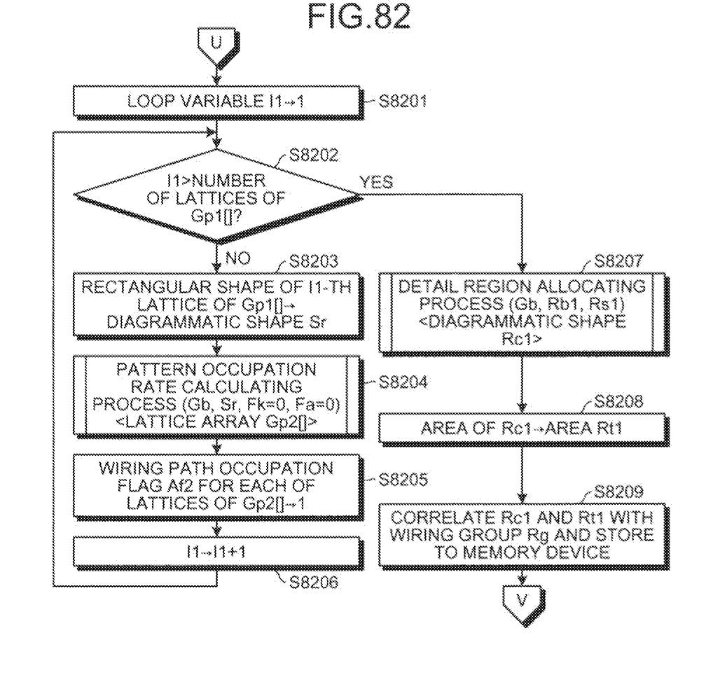

FIGS. 81 to 84 are flowcharts detailing a procedure of the line length adjustment region detail determining process (step S3305). In FIG. 81, the size per lattice for the detail lattice is set as the unit size Ub (step S8101), and a group of lattices with the wiring path occupation flag Af2=1 in the lattice array G.Ga[ ] are set as the lattice array Gp1[ ] (step S8102).

The diagrammatic shape Rb1 and the area Rs1 thereof, which are respectively correlated with the wiring group Rg (correlated at step S5607 in the procedure of the line length adjustment region schematic determining process (step S3304) of FIG. 56)), are then read out.

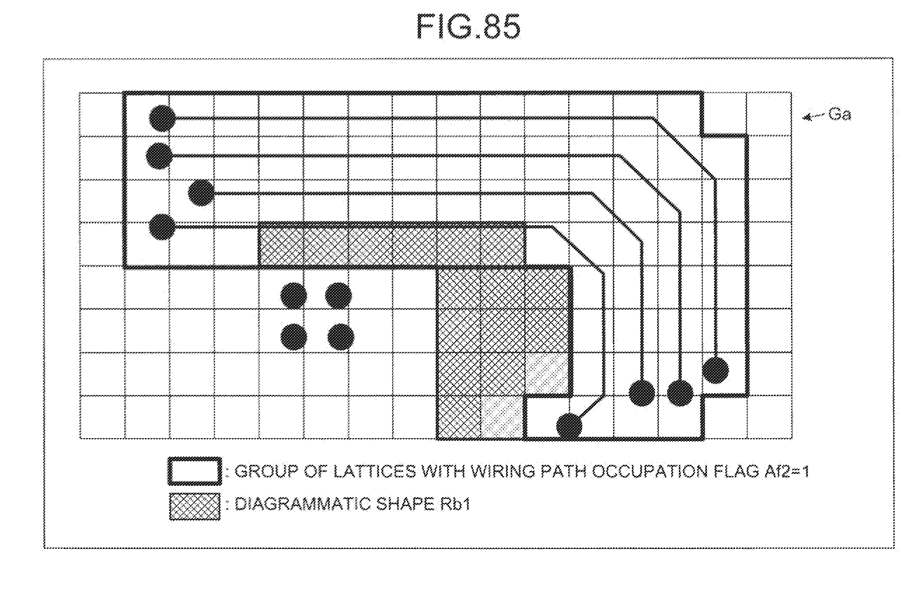

FIG. 85 is an explanatory diagram of a first specific example of the line length adjustment region detail determining process (step S3305). FIG. 85 depicts the lattice management table Ga given as the argument, the lattices with the wiring path occupation flag Af2=1, and the diagrammatic shape Rb1 acquired at the line length adjustment region schematic determining process (step S3304).

In FIG. 81, following step S8103, the diagrammatic shape Rb1 is expanded by the unit size Ub into the diagrammatic shape S1 (step S8104), which is followed by execution of the lattice management table generating process of FIG. 35 (step S8105).

In the lattice management table generating process (step S8105), the diagrammatic shape Rb1 is expanded by the unit size Ub into the diagrammatic shape S1 to use the diagrammatic shape S1 and the unit size Ub as arguments and the lattice management table Gb is returned as a return value.

Subsequently, the obstacle mapping process of FIG. 38 is carried out (step S8106). In the obstacle mapping process (step S8106), the lattice management table Gb acquired by the lattice management table generating process (step S8105) is used as an argument and the lattice management table Gb that results following obstacle mapping is returned as a return value.

The wiring group mapping process of FIG. 48 is then carried out (step S8107). In the wiring group mapping process (step S8107), the lattice management table Gb acquired by the obstacle mapping process (step S8106) is used as an argument and the lattice management table Gb that results following wiring group mapping is returned as a return value. Following the wiring group mapping process, the procedure proceeds to step S8201 of FIG. 82.

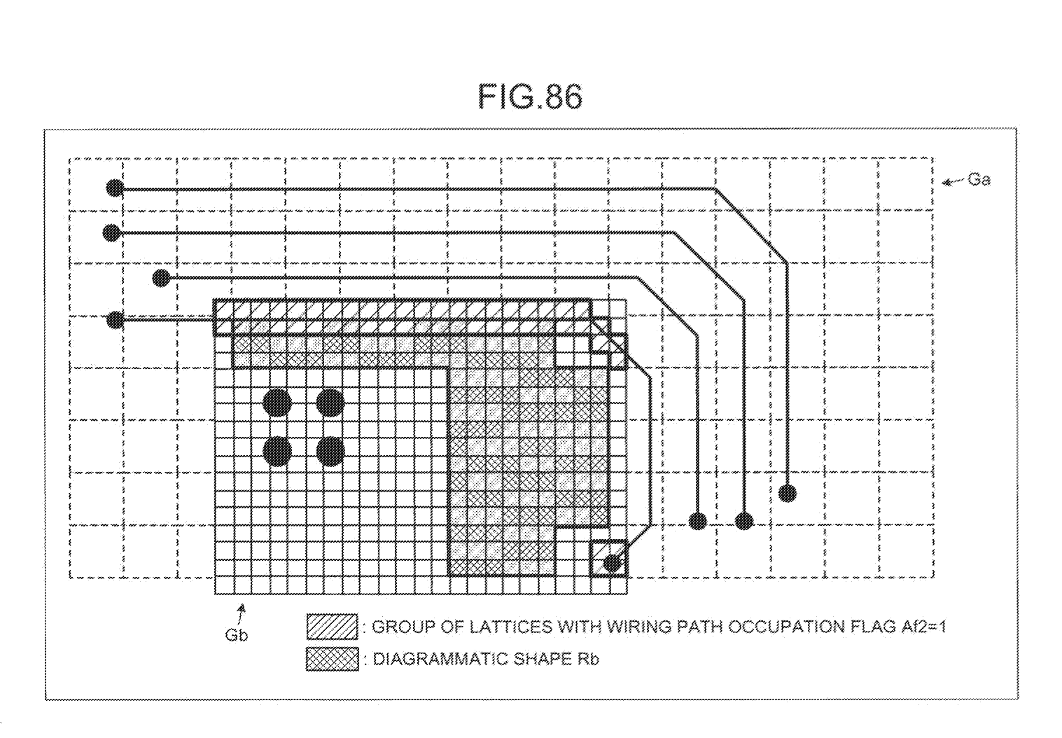

FIG. 86 is an explanatory diagram of a second specific example of the line length adjustment region detail determining process (step S3305). FIG. 86 depicts the lattice management table Gb.

In FIG. 82, following the wiring group mapping process (step S8107) of FIG. 81, the loop variable I1 is set to 1 (step S8201), and whether the loop variable I1 exceeds the number of lattices of the lattice array Gp1[ ] is determined (step S8202). If the value of the loop variable I1 does not exceed the number of lattices of the lattice array Gp1[ ] (step S8202: NO), the rectangular shape of the I1-th lattice of the lattice array Gp1[ ] is set as the diagrammatic shape Sr (step S8203), and the pattern occupation rate calculating process of FIG. 42 is carried out (step S8204).

In the pattern occupation rate calculating process (step S8204), the lattice management table G=Gb, the diagrammatic shape Sr, the figure type flag Fk=0, and the addition flag Fa=0 are set, and the process is carried out in accordance with the procedure of FIG. 42. Hence, in the pattern occupation rate calculating process (step S8204), the lattice array Gp2[ ] consisting of a group of lattices overlapping the diagrammatic shape Sr given as the argument is returned as a return value.

Subsequently, the wiring path occupation flag Af2 for each of lattices of the lattice array Gp2[ ] acquired as the return value is set to 1 (step S8205), and the loop variable I1 is increased by 1 (step S8206), after which the procedure returns to step S8202.

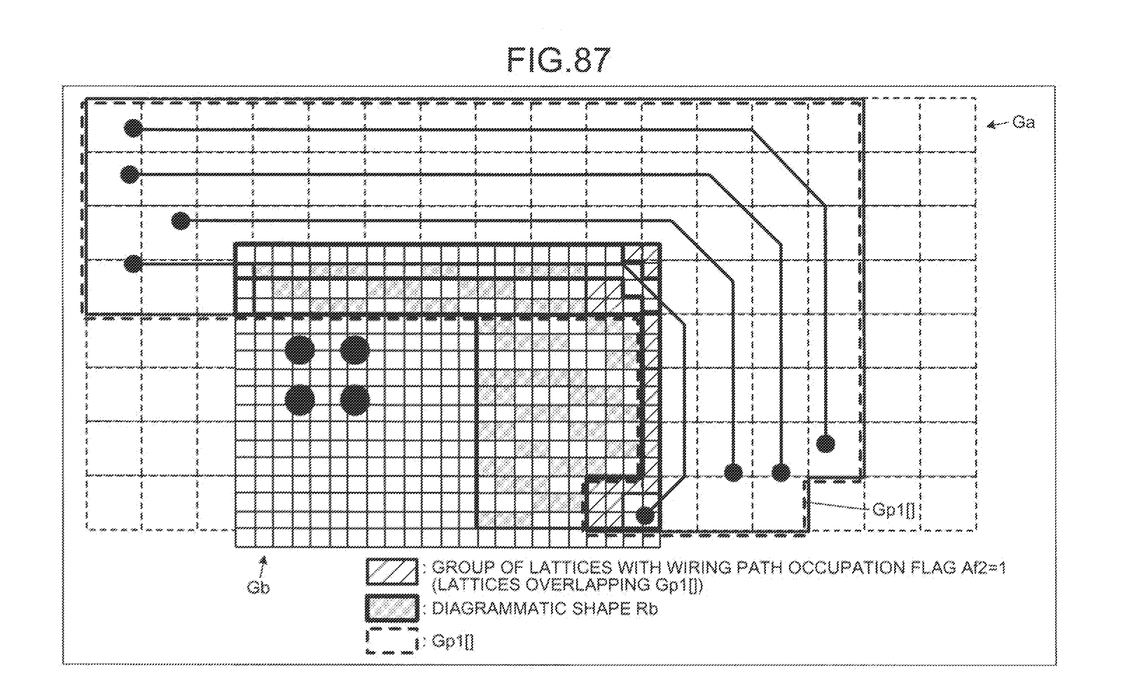

FIG. 87 is an explanatory diagram of a third specific example of the line length adjustment region detail determining process (step S3305). FIG. 87 depicts the lattice management tables Ga and Gb, the lattice array Gp1[ ], and lattices with the wiring path occupation flag Af2=1. Lattices overlapping the lattice array Gp1[ ] each have the wiring path occupation flag Af2=1.

In FIG. 82, if the loop variable I1 exceeds the number of lattices of the lattice array Gp1[ ] at step S8202 (step S8202: YES), the detail region allocating process is carried out (step S8207). The detail region allocating process (step S8207), which will be described in detail later, is carried out as a function that uses the lattice management table Gb, the diagrammatic shape Rb1, and the area Rs1 as arguments and that returns a diagrammatic shape Rc1 as a return value.

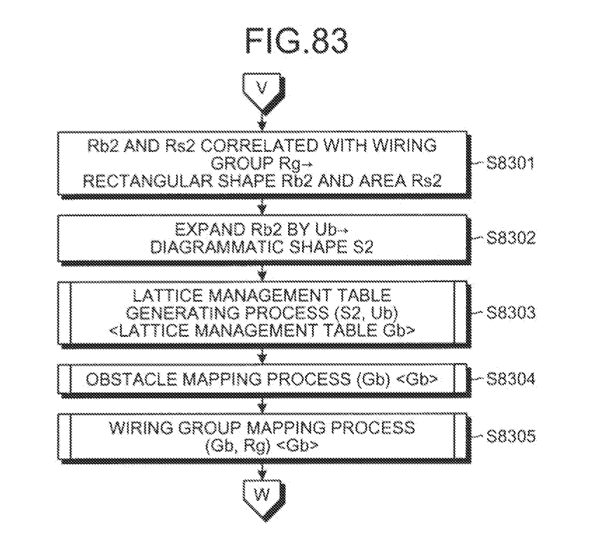

The area of the diagrammatic shape Rc1 acquired as the return value is set as an area Rt1 (step S8208), and the diagrammatic shape Rc1 and the area Rt1 are correlated with the wiring group Rg and stored to the memory device (step S8209). Specifically, in one record among new records added to the line length region table 2500 by the line length adjustment region schematic determining process (step S3304), in which one record the area Rs1 and the diagrammatic shape Rb1 are set in the area of insufficiency and the schematic shape information, respectively, the diagrammatic shape Rc1 is set in the detail shape information and the area Rt1 is set in the detail area. The procedure then proceeds to step S8301 of FIG. 83.

In FIG. 83, the diagrammatic shape Rb2 and the area Rs2 correlated with the wiring group Rg are read out (step S8301), and the diagrammatic shape Rb2 is expanded by the unit size Ub into the diagrammatic shape S2 (step S8302). Subsequently, the lattice management table generating process of FIG. 35 is carried out (step S8303).

In the lattice management table generating process (step S8303), the diagrammatic shape Rb2 is expanded by the unit size Ub into the diagrammatic shape S2 to use the diagrammatic shape S2 and the unit size Ub as arguments and return the lattice management table Gb as a return value.

Subsequently, the obstacle mapping process of FIG. 38 is carried out (step S8304). In the obstacle mapping process (step S8304), the lattice management table Gb acquired by the lattice management table generating process (step S8303) is used as an argument and the lattice management table Gb that results following obstacle mapping is returned as a return value.

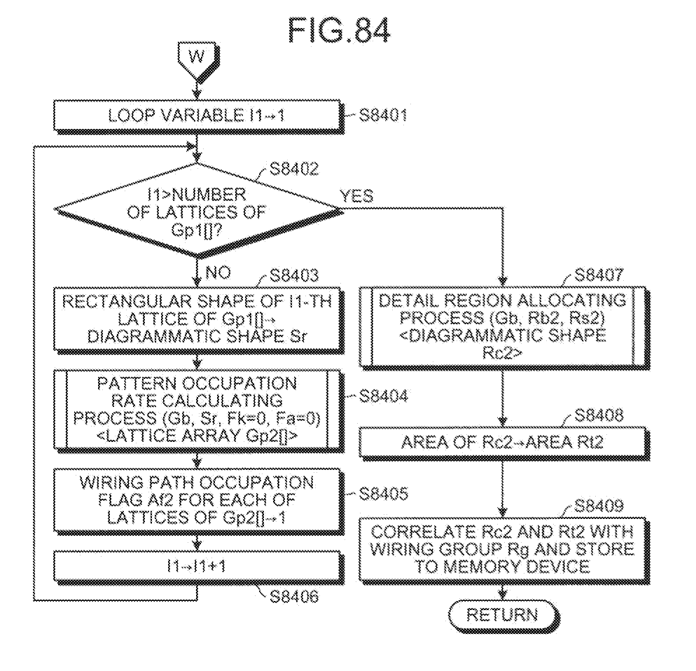

The wiring group mapping process of FIG. 48 is then carried out (step S8305). In the wiring group mapping process (step S8305), the lattice management table Gb acquired by the obstacle mapping process (step S8304) is used as an argument and the lattice management table Gb that results following wiring group mapping is returned as a return value. The procedure then proceeds to step S8401 of FIG. 84.

Subsequently, steps s8401 to S8409 of FIG. 84 are carried out. The process of FIG. 84 is the process of carrying the process of FIG. 82 also on the diagrammatic shape Rb2 and the area Rs2.

In FIG. 84, the loop variable I1 is set to 1 (step S8401), and whether the loop variable I1 exceeds the number of lattices of the lattice array Gp1[ ] is determined (step S8402). If the loop variable I1 does not exceed the number of lattices of the lattice array Gp1[ ] (step S8402: NO), the rectangular shape of the I1-th lattice of the lattice array Gp1[ ] is set as the diagrammatic shape Sr (step S8403), and the pattern occupation rate calculating process of FIG. 42 is carried out (step S8404).

In the pattern occupation rate calculating process (step S8404), the lattice management table G=Gb, the diagrammatic shape Sr, the figure type flag Fk=0, and the addition flag Fa=0 are set, and the process is carried out in accordance with the procedure of FIG. 42. Hence, in the pattern occupation rate calculating process (step S8404), the lattice array Gp2[ ] consisting of a group of lattices overlapping the diagrammatic shape Sr given as the argument is returned as a return value.

Subsequently, the wiring path occupation flag Af2 for each of lattices of the lattice array Gp2[ ] acquired as the return value is set to 1 (step S8405), and the loop variable I1 is increased by 1 (step S8406), after which the procedure returns to step S8402.

If the loop variable I1 exceeds the number of lattices of the lattice array Gp1[ ] at step S8402 (step S8402: YES), the detail region allocating process is carried out (step S8407). The detail region allocating process (step S8407), which will be described in detail later, is carried out as a function that uses the lattice management table Gb, the diagrammatic shape Rb2, and the area Rs2 as arguments and that returns a diagrammatic shape Rc2 as a return value.

The area of the diagrammatic shape Rc2 acquired as the return value is set as an area Rt2 (step S8408), and the diagrammatic shape Rc2 and the area Rt2 are correlated with the wiring group Rg and stored to the memory device (step S8409). Specifically, in one record among new records added to the line length region table 2500 by the line length adjustment region schematic determining process (step S3304), in which one record the area Rs2 and the diagrammatic shape Rb2 are set in the area of insufficiency and the schematic shape information, respectively, the diagrammatic shape Rc2 is set in the detail shape information and the area Rt2 is set in the detail area. Thus, the line length adjustment region detail determining process ends.

The detail region allocating process will be described. The detail region allocating process is carried out at steps S8207 of FIG. 82 and S8407 of FIG. 84. The detail region allocating process (step S8207/S8407) is carried out as a function that uses the lattice management table Gb, the diagrammatic shape Rb, and the area Rs as arguments and that returns a diagrammatic shape S serving as a detail region as a return value.

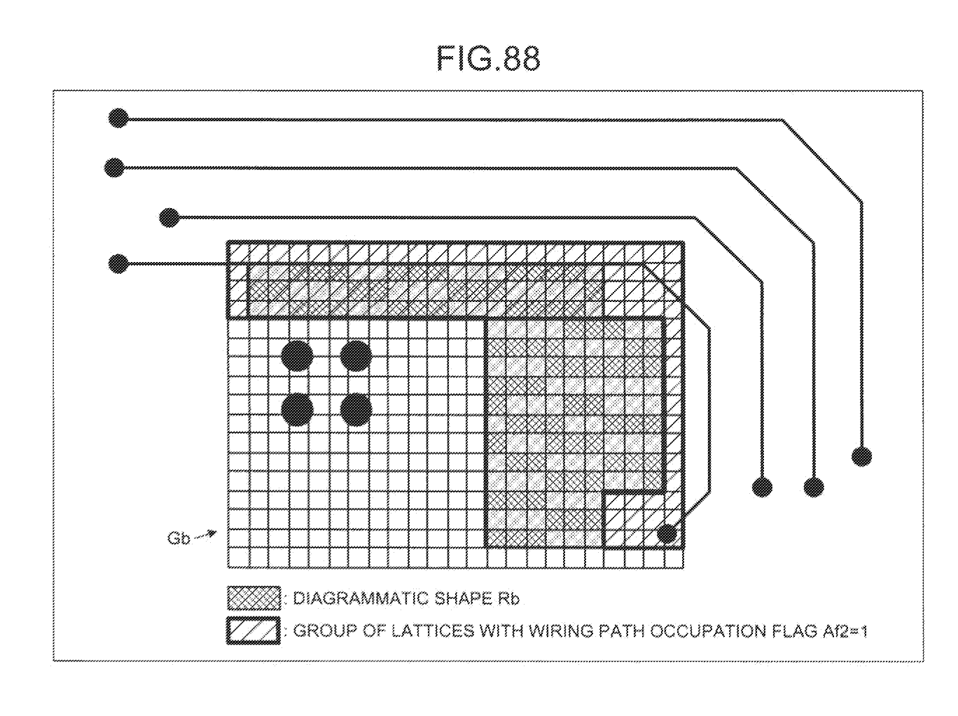

FIG. 88 is an explanatory diagram of a first specific example of the detail region allocating process. In FIG. 88, a region hatched with oblique lines represents a group of lattices with the wiring path occupation flag Af2=1, and a region hatched with dots represents the diagrammatic shape Rb used as the function argument. The detail region allocating process is a process of connecting open regions in four directions from a propagation starting position determined to be the group of lattices with the wiring path occupation flag Af2=1 to determine the detail region.

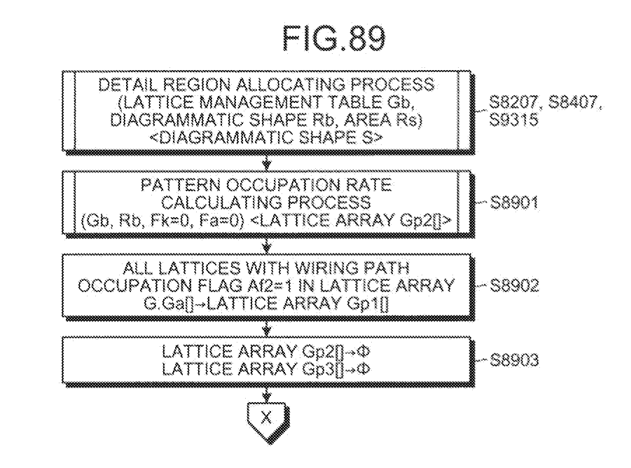

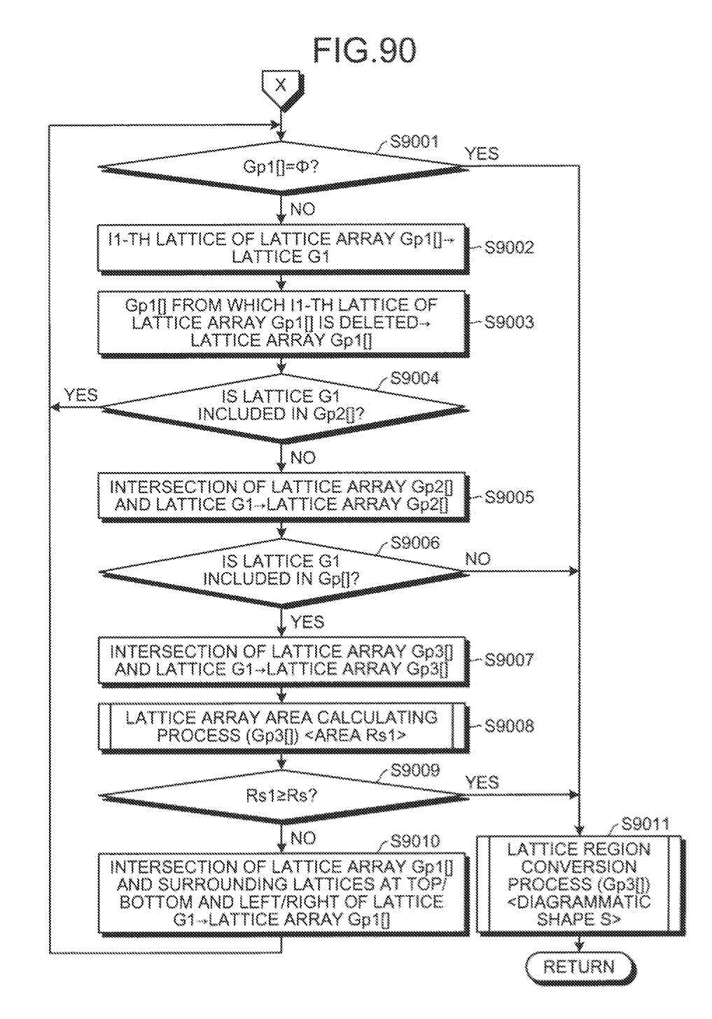

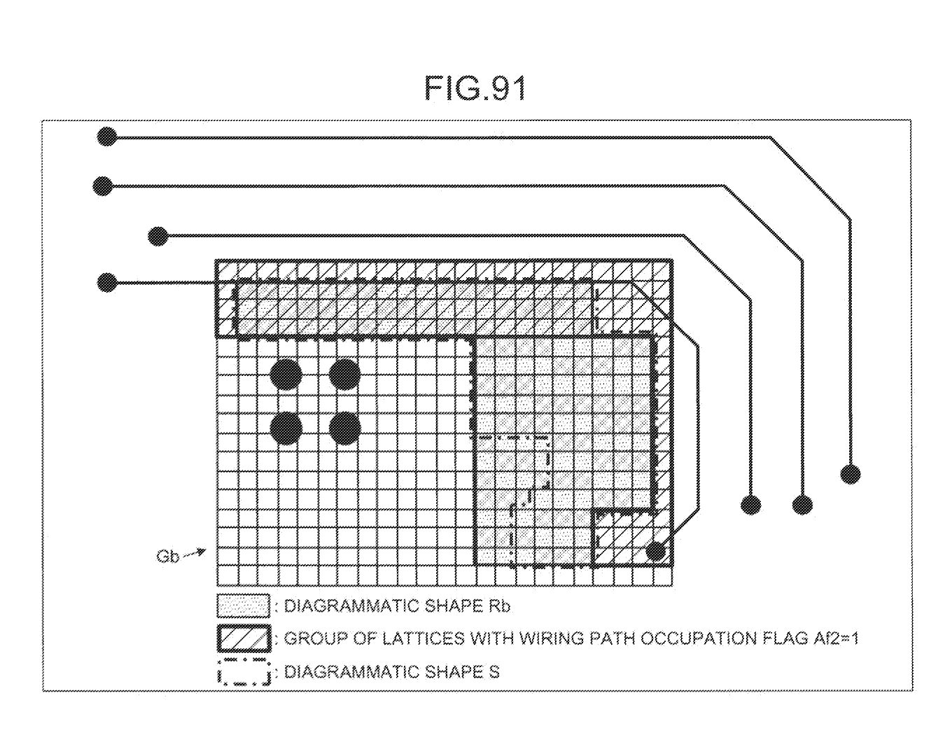

FIGS. 89 and 90 are flowcharts detailing a procedure of the detail region allocating process (step S8207/S8407). In the procedure of the detail region allocating process (step S8207/S8407) of FIG. 89, the pattern occupation rate calculating process of FIG. 42 is carried out (step S8901).

In the pattern occupation rate calculating process (step S8901), the lattice management table G=Gb, the diagrammatic shape Rb, the figure type flag Fk=0, and the addition flag Fa=0 are set, and the process is carried out in accordance with the procedure of FIG. 42. Hence, in the pattern occupation rate calculating process (step S8901), the lattice array Gp2[ ] consisting of a group of lattices overlapping the diagrammatic shape Rb given as the argument is returned as a return value.

A group of lattices with the wiring path occupation flag Af2=1 in the lattice array G.Ga[ ] are set as a lattice array Gp1[ ] (step S8902), and the lattice array Gp2[ ] and the lattice array Gp3[ ] are set as empty lattice arrays (step S8903). The procedure then proceeds to step S9001 of FIG. 90.

The initial value of the lattice array Gp1[ ] is the group of lattices with the wiring path occupation flag Af2=1 that are encompassed by a thick line in FIG. 88. The lattice array Gp2[ ] is the lattice array propagated from the lattice array Gp1[ ], and has an initial value set as an empty lattice array.

In FIG. 90, whether the lattice array Gp1[ ]=φ(empty set) is satisfied is determined (step S9001). If the lattice array Gp1[ ]=φ is not satisfied (step S9001: NO), the first (head) lattice of the lattice array Gp1[ ] is set as the lattice G1 (step S9002), and a lattice array obtained by deleting the lattice G1 from the lattice array Gp1[ ] is set as a new lattice array Gp1[ ] (step S9003).

Whether the lattice G1 is included in the lattice array Gp2[ ] is then determined (step S9004). If the lattice G1 is included (step S9004: YES), the procedure returns to step S9001. If the lattice G1 is not included (step S9004: NO), an intersection of the lattice array Gp2[ ] and the lattice G1 is set as a new lattice array Gp2[ ] (step S9005).

Whether the lattice G1 is included in the lattice array Gp[ ] is then determined (step S9006). The lattice array Gp[ ] is a set of lattices intersecting with the diagrammatic shape Rb that is the function argument. At step S9006, therefore, whether the lattice G1 is a lattice in the diagrammatic shape Rb as the function argument is determined. If the lattice G1 is a lattice in the diagrammatic shape Rb, the lattice G1 is added to the lattice array Gp3[ ] and surrounding lattices at the top/bottom and left/right of the lattice G1 are added to the lattice array Gp1[ ].

If the lattice G1 is not included in the lattice array Gp[ ] (step S9006: NO), the lattice region conversion process (step S9011) is carried out. If the lattice G1 is included in the lattice array Gp[ ] (step S9006: YES), an intersection of the lattice array Gp3[ ] and the lattice G1 is set as a new lattice array Gp3[ ] (step S9007), and the lattice array area calculating process of FIG. 81 is carried out (step S9008). In the lattice array area calculating process (step S9008), the lattice array Gp3[ ] is used as an argument and the area Rs1 is returned as a return value.

Whether the area Rs1 of the diagrammatic shape making up the lattice array Gp3[ ] satisfies Rs1≧Rs is determined (step S9009). If Rs1≧Rs is satisfied (step S9009: YES), the lattice region conversion process (step S9011) is carried out. If Rs1≧Rs is not satisfied (step S9009: NO), an intersection of the lattice array Gp1[ ] and surrounding lattices at the top/bottom and left/right of the lattice G1 is set as a new lattice array Gp1[ ] (step S9010), after which the procedure returns to step S9001.

If the lattice array Gp1[ ]=φ is satisfied (step S9001: YES), the lattice region conversion process (step S9011) is carried out. In the lattice region conversion process (step S9011), the lattice array Gp3[ ] is used as an argument and the diagrammatic shape S serving as a detail region is returned as a return value.

FIG. 91 is an explanatory diagram of a second specific example of the detail region allocating process. In FIG. 91, a region encompassed by a thick single-dot chain line is the diagrammatic shape S.

The line length adjustment region mapping process will be described. The line length adjustment region mapping process is the process of reflecting a line length adjustment region as an obstacle.

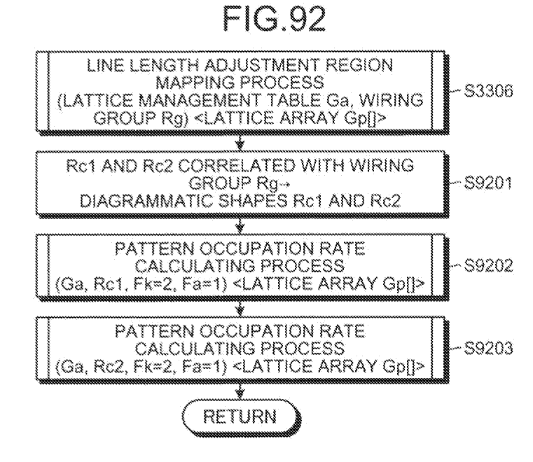

FIG. 92 is a flowchart detailing a procedure of the line length adjustment region mapping process (step S3306) of FIG. 33. The diagrammatic shapes Rc1 and Rc2 correlated with the wiring group Rg are set as the diagrammatic shapes Rc1 and Rc2 (step S9201), and the pattern occupation rate calculating process (steps S9202 and S9203) of FIG. 42 is carried out.

In the pattern occupation rate calculating process (step S9202), the lattice management table G=Ga, the diagrammatic shape Rc1, the figure type flag Fk=2, and the addition flag Fa=1 are set, and the process is carried out in accordance with the procedure of FIG. 42. Hence, in the pattern occupation rate calculating process (step S9202), the rate of inclusion of lattices within the lattice management table Ga in the wiring path diagrammatic shape Rc1 given as the argument is calculated to return the lattice array Gp[ ] included in the wiring path diagrammatic shape Rc1 as a return value.

In the pattern occupation rate calculating process (step S9203), the lattice management table G=Ga, the diagrammatic shape Rc2, the figure type flag Fk=2, and the addition flag Fa=1 are set, and the process is carried out in accordance with the procedure of FIG. 42. Hence, in the pattern occupation rate calculating process (step S9203), the rate of inclusion of lattices within the lattice management table Ga in the wiring path diagrammatic shape Rc2 given as the argument is calculated to return the lattice array Gp[ ] included in the wiring path diagrammatic shape Rc2 as a return value.

As a result, by the line length adjustment region mapping process (step S3306), the lattice arrays Gp[ ]included in the diagrammatic shapes Rc1 and Rc2 can be mapped as the line length adjustment region to be drawn.

The line length adjustment region substitution layer allocating process will be described. The line length adjustment region substitution layer allocating process is the process of allocating a portion of shortage of a line length adjustment region to a substitution layer, and is carried out, specifically, as a function that uses the wiring group Rg as an argument and that retunes diagrammatic shapes Rb3 and Rc3 and areas Rs3 and Rt3 as return values.

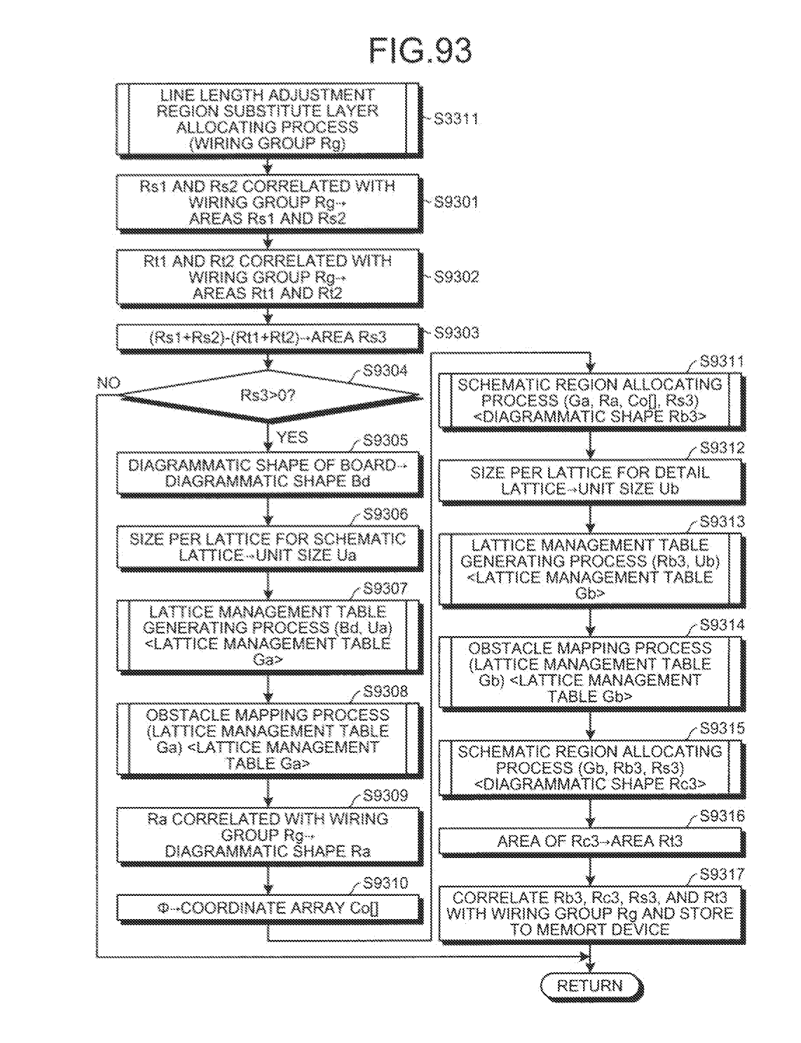

FIG. 93 is a flowchart detailing a procedure of the line length adjustment region substitution layer allocating process (step S3311) of FIG. 33. The areas Rs1 and Rs2 correlated with the wiring group Rg are set as the areas Rs1 and Rs2 (step S9301), and the areas Rt1 and Rt2 correlated with the wiring group Rg are set as the areas Rt1 and Rt2 (step S9302).

The areas Rs1 and Rs2 are the areas of the diagrammatic shapes Rb1 and Rb2 that are correlated with the wiring group Rg in the line length adjustment region schematic determining process (step S3304). The areas Rt1 and Rt2 are the areas of the diagrammatic shapes Rc1 and Rc2 that are correlated with the wiring group Rg in the line length adjustment region detail determining process (step S3305).

The area Rs3 is then calculated (step S9303). The area Rs3 is calculated by the equation: Rs3=(Rs1+Rs2)−(Rt1+Rt2). Whether Rs3>0 is satisfied is then determined (step S9304). Based on the result of this determination, whether the line length adjustment region is in short is determined. If Rs3>0 is not satisfied (step S9304: NO), the procedure is ended without allocating a portion of shortage of the line length adjustment region to the substitution layer.

If Rs3>0 is satisfied (step S9304: YES), the line length adjustment region is insufficient, so the line length region is allocated within the range of the shape of the wiring group Rg. Specifically, the diagrammatic shape of the substrate is set as the diagrammatic shape Bd (step S9305), the size per lattice for the schematic lattice is set as the unit size Ua (step S9306), and lattice management table generating process of FIG. 35 is carried out (step S9307).

In the lattice management table generating process (step S9307), the diagrammatic shape S=Bd and the unit size U=Ua are used as arguments and the lattice management table Ga is returned as a return value. The obstacle mapping process of FIGS. 38 to 40 is then carried out (step S9308). In the obstacle mapping process (step S9308), the lattice management table Ga generated by the lattice management table generating process (step S9307) is used as an argument and the lattice management table Ga that results following obstacle mapping is returned as a return value.

The diagrammatic shape Ra correlated with the wiring group Rg is set as the diagrammatic shape Ra (step S9309), and the coordinate array Co[ ]φ (empty set) is set (step S9310). The schematic region allocating process of FIGS. 65 to 70 is then carried out (step S9311).

In the schematic region allocating process (step S9311), the lattice management table Ga, the diagrammatic shape Ra, the coordinate array Co[ ], and the area Rs3 are used as arguments and the diagrammatic shape Rb3 is returned as a return value. Subsequently, the size per lattice for the detail lattice is set as the unit size Ub (step S9312), and lattice management table generating process of FIG. 35 is carried out (step S9313).

In the lattice management table generating process (step S9313), the diagrammatic shape S=Rb3 and the unit size U=Ub are used as arguments and the lattice management table Gb is returned as a return value. The obstacle mapping process of FIGS. 38 to 40 is then carried out (step S9314). In the obstacle mapping process (step S9314), the lattice management table Gb made by the lattice management table generating process (step S9313) is used as an argument and the lattice management table Gb that results following obstacle mapping is returned as a return value.

The detail region allocating process of FIGS. 89 and 90 is then carried out (step S9315). In the detail region allocating process (step S9315), the lattice management table Gb, the diagrammatic shape S=Rb3, and the area Rs3 are used as arguments and the diagrammatic shape Rc3 is returned as a return value.

The area of the diagrammatic shape S=Rb3 is set as the area Rt3 (step S9316), and the diagrammatic shapes Rb3 and Rc3 and the areas Rs3 and Rt3 are correlated with the wiring group Rg and are stored in the memory device (step S9317).

Specifically, a new record is added to the schematic region table 2400, and the diagrammatic shape Rb3 is set in the schematic shape information in the newly added record. A layer number is set to a number different from a layer number set in the record containing the schematic region number corresponding to the wiring group Rg. In this case, although any layer may be set as long as the diagrammatic shape Rb3 can be disposed on the set layer, setting a layer with a layer number close to the layer number set in the record containing the schematic region number corresponding to the wiring group Rg is preferable. The dividing line is left undefined.

A new record is added to the line length region table 2500, and the wiring path number of a wiring path making up the corresponding wiring group Rg is set in the wiring path list in the newly added record. The area of insufficiency is left undefined, and the diagrammatic shape Rb3 is set in the schematic shape information. The diagrammatic shape Rc3 is set in the detail shape information, and the area Rt3 is set in the detail area. The line length adjustment number of the new record set in this manner is then added to the line length number list in the new record that is added to the schematic region table 2400. Hence, the liner length adjustment region substitution layer allocating process is ended.

The line length adjustment region displaying process will be described. The line length adjustment region displaying process is the process of displaying a line length adjustment region by drawing the line length adjustment region on the display screen. The end of the line length adjustment region displaying process means the end of all processes.

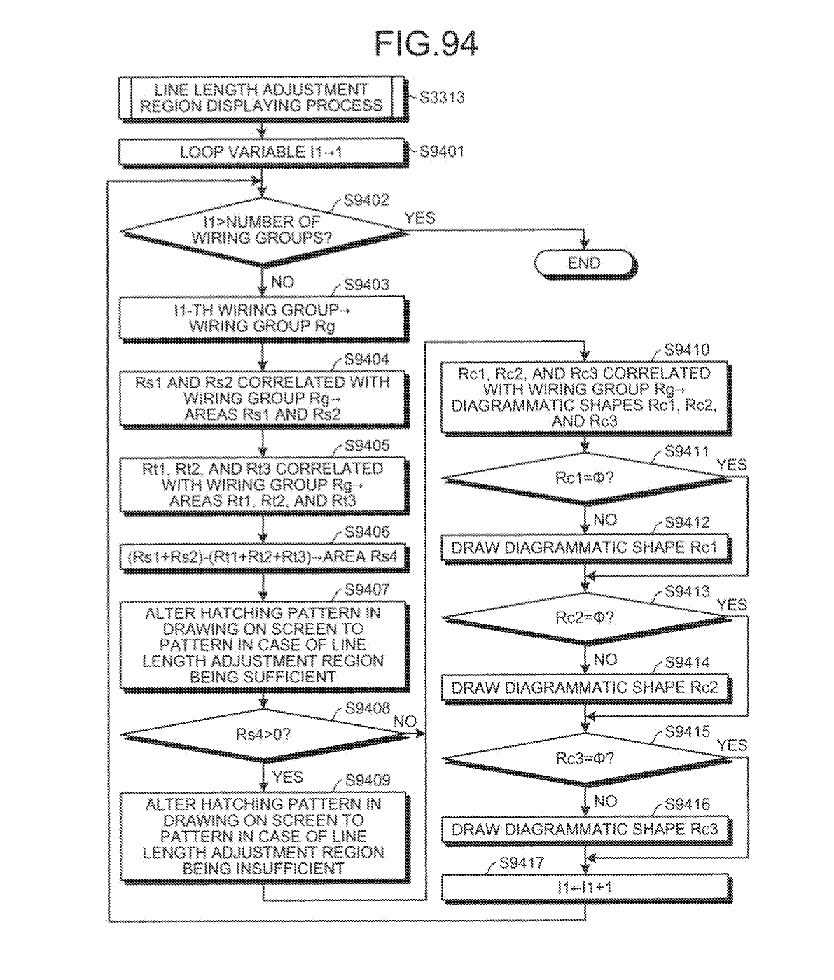

FIG. 94 is a flowchart detailing a procedure of the line length adjustment region displaying process (step S3313) of FIG. 33. The loop variable I1 is set to 1 (step S9401), and whether the loop variable I1 is more than the number of wiring groups is determined (step S9402). If the loop variable I1 is equal to or less than the number of wiring groups (step S9402: NO), the I1-th wiring group is set as the wiring group Rg (step S9403), and the areas Rs1 and Rs2 correlated with the wiring group Rg are set as the areas Rs1 and Rs2 (step S9404). The areas Rt1, Rt2, and Rt3 correlated with the wiring group Rg are set as the areas Rt1, Rt2, and Rt3 (step S9405).

An area Rs4 is then calculated (step S9406). The area Rs4 is calculated by the equation: Rs4=(Rs1+Rs2)−(Rt1+Rt2+Rt3). A hatching pattern in drawing on the screen is then altered to a pattern in the case of a line length adjustment region being sufficient (step S9407), and whether Rs4>0 is satisfied is determined (step S9408).

When Rs4>0 is not satisfied (step S9408: NO), the procedure proceeds to step S9410. If Rs4>0 is satisfied (step S9408: YES), the hatching pattern in drawing on the screen is then altered to a pattern in the case of the line length adjustment region being insufficient (step S9409), after which the procedure proceeds to step S9410.

At step S9410, the diagrammatic shapes Rc1, Rc2, and Rc3 correlated with the wiring group are set as the diagrammatic shapes Rc1, Rc2, and Rc3 (step S9410), and whether Rc1=φ (empty set) is satisfied is determined (step S9411). When Rc1=φ is satisfied (step S9411: YES), the procedure proceeds to step S9413. If Rc1=φ is not satisfied (step S9411: NO), the diagrammatic shape Rc1 is drawn (step S9412), and the procedure proceeds step S9413.

At step S9413, whether Rc2=φ (empty set) is satisfied is determined (step S9413). If Rc2=φφis satisfied (step S9413: YES), the procedure proceeds to step S9415. If Rc2=φis not satisfied (step S9413: NO), the diagrammatic shape Rc2 is drawn (step S9414), and the procedure proceeds step S9415.

At step S9415, whether Rc3=φ (empty set) is satisfied is determined (step S945). If Rc3=φ is satisfied (step S9415: YES), the procedure proceeds to step S9417. If Rc3=φ is not satisfied (step S9415: NO), the diagrammatic shape Rc3 is drawn (step S9416), and the procedure proceeds step S9417.

At step S9417, the loop variable I1 is increased by 1 (step S9417), and the procedure returns to step S9402. If the loop variable I1 is larger than the number of wiring group (step S9402: YES), the line length adjustment region displaying process is ended.

As described above, according to this embodiment, a wiring path not compliant with a line length constraint condition is detected automatically. Based on the noncompliant line length of the wiring path, a wiring region necessary for adjusting the line length of the wiring path is displayed in the vicinity of a wiring group to which the wiring path belongs.

As a result, the presence/absence of a noncompliant wiring group and a wiring region necessary for line length adjustment are displayed all together to the designer. At the stage before wiring path connection, therefore, the designer is allowed to make use of the line length adjustment region, which is used by each wiring group based on wiring connection relations, for considering a wiring route while displaying the line length adjustment region. In wiring path connection work, in addition, the designer is allowed to carry out wiring path connection while leaving a line length adjustment region for an already connected wiring group unused. In this manner, the designer is able to carry out wiring work while considering line length adjustment to be made later and thus is able to efficiently carry out wiring design without any setback.

Based on the proportional relation between insufficient line lengths in a wiring group, the wiring group is divided. This allows a line length adjustment region to be allocated to wiring paths requiring line length adjustment other than a reference wiring path, thus facilitating line length adjustment work to follow.

When the proportional relation does not exist, the wiring paths of the wiring group is divided with respect to the wiring path in the middle thereof. As a result, line length adjustment regions are allocated equally to both sides of the wiring group, which facilitates line length adjustment work to follow.

When the wiring group is divided, a detouring region is acquired along the shortest route, and the line length adjustment region is expanded stepwise from a vicinity of the wiring group. The line length adjustment region is thus expanded to a size equivalent to the size of an area of insufficiency while kept located in the vicinity of the wiring group.

The line length adjustment region is allocated so as not to overlap an obstacle. This prevents setbacks in designing. The line length adjustment region is allocated in a range specified by the designer. This allows the designer to carry out intended line length adjustment. The size and position of the line length adjustment region can be estimated even if wiring paths are unconnected. This allows the designer to consider line length adjustment in advance before or during wiring path connection.

An area of insufficiency is displayed in a different manner. This allows the designer to know in advance the shortage of the line length adjustment region, an area of insufficiency, and the location of a region equivalent to the area of insufficiency, thus reducing setbacks in wiring design.

The design support method described in the present embodiment may be implemented by executing a prepared program on a computer such as a personal computer and a workstation. The program is stored on a non-transitory computer-readable recording medium such as a hard disk, a flexible disk, a CD-ROM, an MO, and a DVD, read out from the recording medium, and executed by the computer. The program may be a transmission medium that can be distributed through a network such as the Internet.

The embodiments of the present invention offer an effect of intuitively expressing the optimum size and position of a region for line length adjustment to improve the convenience for a designer.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory, computer-readable recording medium storing therein a design support program that causes a computer to execute:
selecting a wiring path whose line length is greatest among a plurality of wiring paths making up a wiring group leading from a transmission origin to a transmission destination;
detecting insufficient line lengths of the wiring paths not selected, insufficiency being determined with respect to the line length of the selected wiring path;
calculating the area of insufficiency according to a sum of the detected insufficient line lengths;
allocating to a vicinity of the wiring group, a line length adjustment region corresponding to a sum of the areas of insufficiency calculated at calculating; and
controlling a display screen to display the wiring group and the allocated line length adjustment region.

2. The non-transitory, computer-readable recording medium according to claim 1 and storing therein the design support program causing the computer to further execute:
detecting the order in which the wiring paths are arranged;
determining whether a proportional relation exists between insufficient line length and the detected order of arrangement; and
dividing the wiring group by a boundary line to include the selected wiring path in a sub-wiring group, based on a determination result obtained at the determining of existence of a proportional relation, wherein
that calculating includes calculating, for each sub-wiring group obtained at the dividing, the area of insufficiency according to the sum of the detected insufficient line lengths, and
the allocating includes respectively allocating to vicinities of the sub-wiring groups, line length adjustment regions corresponding to the calculated areas of insufficiency.

3. The non-transitory, computer-readable recording medium according to claim 2 and storing therein the design support program causing the computer to further execute newly selecting, as the selected wiring path, a wiring path arranged in middle of the wiring paths, if nonexistence of a proportional relation is determined at the determining, wherein
the dividing includes dividing the wiring group by a boundary line to include the newly selected wiring path in a sub-wiring group.

4. The non-transitory, computer-readable recording medium according to claim 2 and storing therein the design support program causing the computer to further execute:
retrieving, for each sub-wiring group obtained at the dividing, the shortest route between ends of the boundary line and detouring the sub-wiring group;
acquiring, for each sub-wiring group and from a figure encompassed by the boundary line and a shortest route retrieved at the retrieving, a detouring region detouring the sub-wiring group and enabling wiring; and
setting a line length adjustment region for each sub-wiring group, by adjusting the area of an acquired detouring region to make the area equal to or less than the area of insufficiency, wherein
the allocating includes allocating the line length adjustment regions set at the setting to a vicinity of the wiring group.

5. The non-transitory, computer-readable recording medium according to claim 4 and storing therein the design support program causing the computer to further execute determining, for each sub-wiring group, whether the area of the detouring region is at most the area of insufficiency, wherein
the retrieving includes newly retrieving the shortest route detouring the sub-wiring group the most, if at the determining, the area of the detouring region is determined to be equal to or less than the area of insufficiency, and
the acquiring includes acquiring, from a figure encompassed by the boundary and the shortest route newly retrieved at the retrieving, a detouring region detouring the sub-wiring group.

6. The non-transitory, computer-readable recording medium according to claim 5 and storing therein the design support program causing the computer to further execute generating a figure by expanding the figure encompassed by the boundary and the newly retrieved shortest route by a given extent, if at the determining, the area of the detouring region is determined to be equal to or less than the area of insufficiency, wherein
the acquiring unit acquires a detouring region detouring the sub-wiring group from the generated figure.

7. The non-transitory, computer-readable recording medium according to claim 1, wherein
the allocating includes allocating the line length adjustment region to a vicinity of the wiring group having no obstacle.

8. The non-transitory, computer-readable recording medium according to claim 1, wherein
the allocating includes the line length adjustment region to a region of a specified range, among regions in a vicinity of the wiring group.

9. The non-transitory, computer-readable recording medium according to claim 1 and storing therein the design support program causing the computer to further execute calculating a temporary line length of an unconnected wiring path in the wiring group, wherein
the selecting includes selecting a wiring path from the wiring paths making up the wiring group, by using the calculated temporary line length,
the detecting includes detecting the insufficient line lengths with respect to the line length of the selected wiring path, by using the calculated temporary line length, and
the calculating includes calculating the area of insufficiency according to the sum of the detected insufficient line lengths, by using the calculated temporary line length.

10. The non-transitory, computer-readable recording medium according to claim 1, wherein
the allocating includes allocating a line length adjustment region such that the line length adjustment region does not overlap another line length adjustment region.

11. The non-transitory, computer-readable recording medium according to claim 1, wherein
the determining includes determining whether the area of the line length adjustment region is sufficient, based on the area of insufficiency, and
the allocating includes allocating to another layer, a region equivalent to a portion of the area of insufficiency, if at the determining, the area of the line length adjustment region is determined to be insufficient.

12. The non-transitory, computer-readable recording medium according to claim 1, wherein
the determining includes determining whether the area of the line length adjustment region is sufficient, based on the area of insufficiency, and
the controlling includes controlling the display screen to display the line length adjustment region in a manner different from a manner of display when the line length adjustment region is sufficient, if at the determining, the area of the line length adjustment region is determined to be insufficient.

13. A design support apparatus comprising:
a selecting unit that selects a wiring path whose line length is greatest among a plurality of wiring paths making up a wiring group leading from a transmission origin to a transmission destination;
an insufficient-line-length detecting unit that detects insufficient line lengths of the wiring paths not selected, insufficiency being determined with respect to the line length of the selected wiring path;
an area of insufficiency calculating unit that calculates the area of insufficiency according to a sum of the detected insufficient line lengths;
an allocating unit that allocates to a vicinity of the wiring group, a line length adjustment region corresponding to a sum of the areas of insufficiency calculated by the area of insufficiency calculating unit; and
a display control unit that controls a display screen to display the wiring group and the allocated line length adjustment region.

14. A design support method comprising:
selecting a wiring path whose line length is greatest among a plurality of wiring paths making up a wiring group leading from a transmission origin to a transmission destination;
detecting insufficient line lengths of the wiring paths not selected, insufficiency being determined with respect to the line length of the selected wiring path;
calculating the area of insufficiency according to a sum of the detected insufficient line lengths;
allocating to a vicinity of the wiring group, a line length adjustment region corresponding to a sum of the areas of insufficiency calculated at calculating; and
controlling a display screen to display the wiring group and the allocated line length adjustment region.
